(19) United States
(12) Patent Application Publication
(10) Pub. No.: US 2022/0318906 A1
(43) Pub. Date: Oct. 6, 2022

(54) Interactive Grid-based Graphical Trading System with Smart Order Action

(71) Applicant: Pranil Ram, Makati City (PH)

(72) Inventors: Pranil Ram, MAKATI CITY (PH); Bryan Lising, RODRIGUEZ (PH)

(21) Appl. No.: 17/714,132

(22) Filed: Apr. 5, 2022

Related U.S. Application Data
(60) Provisional application No. 63/170,599, filed on Apr. 5, 2021.

(51) Int. Cl. G06Q 40/04

(52) U.S. Cl. CPC G06Q 40/04; G06F 3/0486

(57) ABSTRACT

An interactive grid based graphical trading system for use in securities trading provides a dynamic, visual display of trading objects such as orders, quotes, fills, indicators, studies, session ranges, and other trading related objects such as alerts, algos, notes, and other objects. The quotes, orders, and other objects are mapped into cells that are associated with a price or a range of prices. The cells are then arranged efficiently into rows and columns which provide the user a better visibility of the market whether there is low or very high volatility. The “Smart Order Action” provide a highly intuitive, precise, and customizable method of placing and managing buy and sell orders on a common grid or otherwise.

### BACKGROUND OF THE INVENTION

Volatile markets result in fast moving or quick changing screens making market awareness hard to maintain because trading interfaces lack the ability to display this volatility in one screen or area. Knowing how fast the market has moved poses a challenge since the trader loses reference in each new screen as a result of the display focusing on the trading activity.

Once the market display requires scrolling so the trading activity is still viewable, an entirely new view where the user's orders disappear from view may be displayed to the user. In cases of high volatility, the display might require to jump several screens and display price ranges that are far from the previously viewable price ranges. This type of display behaviour may make the user of such trading interfaces misjudge the speed at which the market moved since the there are only two sets price ranges that shown to the user between the out of view display and the display here the trading activity is. This is especially exacerbated on trading interfaces which imposes a delay before the trading activity is made viewable to the user since during that delay, the market could move drastically.

Placing orders on the grid becomes difficult or near impossible if the screen keeps changing in quick succession.

A lot of screen space in the prior art trading interfaces is underutilized and only contain blank cells. Sometimes a big portion of cells result in the same output order when each cell can give more functionality by utilizing the cell's associated price and which user action was detected. There are also some trading interfaces which use one column for an entire order which is a big waste of space. In addition, some trading interfaces doesn't have the capability of switching between display modes in a way where the user doesn't lose his order data and other trading data. (Booktrader's one column per order mode and normal Booktrader)

Ordinarily, securities products such as stocks and futures, currencies that are traded on an exchange or stock market have a practical Tick increment. In recent years, with the introduction of crypto currencies and micro payments, the underlying asset such as Bitcoin or Ether can have a minimum Tick or precision which is so small that it is not practical to create a Grid or a cell which can represent a single Tick. So, a solution is needed to allow the daily price moves of such crypto currencies and related micro payment schemes, digital currencies to be traded in a practical default increment even when a higher precision is available.

Prior art trading interfaces only display order data and quote information when a lot more can be mapped into cells and when combined with different user input actions, a much richer feature set can be achieved. These trading interface also lack customization on what the user can display on the cells when no order or market data displayed in them.

In addition, for a particular tool or display mode, the user has no option but to change elements individually if they want the tool to be to fit a particular purpose, security type, or user preferences. There is no way to quickly switch quickly between a particular set of arrangement of the elements of the tool or display mode as the user is only provided with one set to work with. Some elements are also fixed in position and the user lacks the ability to customize those.

Display and ability to trade within a trading session's range is also problematic since rarely would displaying a session range or its High and Low fit into the viewable area of a trading interface as these trading interfaces only display a limited number of price levels viewable at a time.

Some of these trading interfaces also charge fees at fixed rates which may be detrimental to both the user and provider/broker. These trading interfaces are also sometimes inaccessible due to high fees or high initial funding. Lack of a new user base is usually detrimental to the health of a company. Some of these trading interfaces may be packed with features but become underutilized due to various factors.

Algos are one of the things that are difficult to visualize, manage, and monitor. They usually just run in the background and fills are just reported to the user. Knowing when an algo is near an imminent fill is rarely shown and thus user intervention is very difficult.

Indicators such as DMAs and other calculations are almost never displayed on trading interfaces except for charts or on dedicated toolbars or display areas and are usually away from the interactive elements. The values are usually detached from where the user places orders. These values can be very hard to see and reference to when a user is trying to place an order in a trading interface.

Alerts, notifications, and other user created events can also be a challenge to create, monitor, and manage while the user focused in monitoring the markets. The interfaces for these are usually unintuitive, require manual keyboard input, and only appear as text. These don't appear on other tools.

The trading interfaces also lack the ability to customize where the bid or buy cells and where the ask area or sell cells start. The trading interfaces usually just use the bid or ask value without giving the user control on how to define these functionalities.

### SUMMARY OF THE INVENTION

The present invention provides solutions to the challenges of the prior art trading systems.

In one aspect of the present invention, it is shown how to display market data, order data, and other types of data in a grid with one or more columns and one or more rows so the trader is able to see a wider range of prices. As a result of the wider range of prices visible to the trader, the trader can better see the trading activity as it moves up or down on his display.

The wider range of prices reduces the need to scroll the display and allows the user to better track how the market moves. The wider range of visible prices is very helpful specially on very volatile situations where the price of a security change by a large amount in a short amount of time.

The wider range of visible prices also help when planning and placing orders far from the market while keeping the trading activity still visible. Another embodiment of the present invention also shows how to display a range of prices in a single cell and how the user can place orders in these cells accurately.

In another embodiment of the present invention, the inventors show how to combine and display bid and ask seamlessly and provide better use of empty cells. The “Smart Order Action” method provides a method of how to place buy orders, sell orders, and other types of orders and actions on the trading grid.

The present invention also allows a much richer user interaction and functionality compared to existing trading systems. In addition to just displaying market data and order data, the system also shows how other objects such as algo data, alerts, indicators, session ranges, notes, and other data can be displayed and created in the cells. The formatting, behaviour, and priority of how data is displayed is also shown to be highly customizable to fit the trader's need.

As a complement of the highly customizable nature of the present invention, methods on how to save and load customized settings to quickly adapt the trading interface to ever changing market situations. The user can quickly change between settings that allow the user to better trade during high volatility situations and seamlessly switch to their previous setting when the market becomes less volatile.

With the present invention's ability to show multiple price ranges in a single cell, efficient use of screen space, rich user interaction, and intuitive functions, the present invention illustrate how it is possible to display an entire session's trading range and still have the ability to place, delete, and manage orders and other objects using the same grid.

One embodiment of the present invention also shows how to monetize, maintain, develop, and promote features using techniques such as analytics and machine learning.

The novel features which are believed to be the characteristic of the present invention, as to its structure, organization, use and method of operation, together with further objectives and advantages thereof, are described in great detail to equip the trader with great advantage to view a wide range of prices and manage many aspects of trading conveniently. It is expressly understood however, that the drawings and detailed descriptions are for the purpose of illustration and are not intended as defining the limits of the invention. Those skilled in the art may provide changes and modifications without departing from the spirit and scope of the present invention.

### BRIEF DESCRIPTION OF THE DRAWINGS

FIG. 1 shows a typical prior art BookTrader window.

FIG. 2 shows an alternate BookTrader window showing each order as a column.

FIG. 3 shows an OHLC chart showing an example of a sudden price move.

FIG. 4 shows a schematic representation of a system employed particularly by stock brokers for trading purposes by remotely located traders.

FIG. 5 shows another schematic representation of a different, browser-based front end or cross platform front end system currently employed by brokers for remotely located traders.

FIG. 6 shows an advantageous embodiment where the orders are mirrored on the other side of the price column.

FIG. 7 shows one embodiment of the present invention where the trading grid have two columns present on each side of the price column.

FIG. 8 shows an advantageous embodiment of FIG. 7 where three columns are present on each side of the price column.

FIG. 9 shows an alternative display of FIG. 8 where the price column is hidden and instead the associated price labels are displayed inside the cells

FIG. 10 shows an embodiment of the present invention where the trading grid have five bid columns and five ask columns with a price label inside the cells instead of a price column.

FIG. 11 shows a trading grid with 10 bid columns and a price column on the left side.

FIG. 12 shows a trading grid with 10 ask columns and a price column on the left side.

FIG. 13 shows an embodiment of the present invention where 10 bid columns, 10 ask columns, and a price column is present on the trading grid.

FIG. 14 shows an embodiment of the present invention where trading grid where bid cells and ask cells are combined on a 10 column trading grid.

FIG. 15 shows cells where the Session High and Session Low can be displayed on the trading grid's cells and price column.

FIG. 16 shows an alternate display of FIG. 15 where the Session High and Session Low is displayed on the Merged Bid+Ask trading grid.

FIG. 17 shows a flowchart on how the trading grid responds to user interactions on the trading grid when set to order mode or display mode.

FIG. 18 shows a block diagram of the architecture of the algo management feature.

FIG. 19 shows a flowchart of the Smart order feature where the order type is decided by the present invention based on the properties of the cell the user interacted with.

FIG. 20 shows a block diagram of an analytics architecture in keeping with the present invention.

FIG. 21 shows a basic Smart order action dialog box.

FIG. 22 shows an alternate view of FIG. 21 with controls for changing the order type and order quantity.

FIG. 23 shows an alternate view of FIG. 22 with calculated distances from the best bid and best ask in addition to controls for changing more order parameters.

FIG. 24 shows a Smart order action dialog box with Stop order controls.

FIG. 25 shows an alternate view of FIG. 24 where the Limit order controls are also shown.

FIG. 26 shows a Smart order action on a cell with existing orders with a button that can cancel said order and controls to change order submit parameters.

FIG. 27 shows a settings panel for Auto centering, Alerts, and Smart order action.

FIG. 28 shows algo objects displayed on the trading grid and the algo toolbar.

FIG. 29 shows orders that are associated with algos displayed on the trading grid.

FIG. 30 shows trades that are associate with algos displayed on the trading grid.

FIG. 31 shows a cell details toolbar/status bar when cell is selected/highlighted on the trading grid.

FIG. 32 shows a cell data table of a selected/highlighted cell on the trading grid.

FIG. 33 shows sell orders echoed on a bid side trading grid with the price column on the right and the bid columns arranged descending order from left to right.

FIG. 34 shows buy orders echoed on a sell side trading grid with the price column on the left and the ask columns arranged in ascending order from left to right

FIG. 35 shows a price axis column and grid cell config panel.

FIG. 36 shows a config panel for placing orders and cell interval settings.

FIG. 37 shows a change in the selected/highlighted cell and its effect on the cell details table.

FIG. 38 shows a right-click operation on a price column cell and various types of alert icons.

FIG. 39 and FIG. 40 show schematic views of some of the combinations of arrangement between price columns, ask side column(s), and bid side column(s).

FIG. 41 shows a trading grid with only the cells containing size that are coloured and various types of order representations inside a cell.

FIG. 42 shows the context sensitive nature mouse-over tooltips based on what type of cell the cursor is hovering over.

FIG. 43 shows a block diagram of the internal architecture of the front-end in keeping with the present invention.

FIG. 44 shows cell border highlights on mouse-over.

FIG. 45 shows the cell details table that provide a more detailed view of the data in a cell.

FIG. 46 shows a 3 column grid with mixed price and size cell labels.

FIG. 47 shows a settings window for the Smart Order Action, Bid Side, Ask Side Offset method.

FIG. 48 shows a settings window for the Smart Order Action, Explicit Order Action.

FIGS. 49 to 52 show various Smart Order Action, Explicit Order Action spread settings.

FIGS. 53 to 54 show Bid only and Ask only reference of the Smart Order Action, Explicit Order Action.

FIG. 55 shows a settings window for the Cell price intervals, custom settings.

FIG. 56 shows a settings window for the Grid Config.

FIGS. 57 to 59 show various settings windows for the Cell Order Tick Config.

FIG. 60 shows a settings window for the Cell Order Tick Config.

FIG. 61 shows a Cell Detail Table with a sub-cell grid.

FIG. 62 shows a Cell Detail Table with a Sub-grid tab.

FIG. 63 shows a table illustrating some of the Offset Reference types and the effect on the Offset input and the Reference price it resolves to.

FIG. 64 shows a settings window for the User Input and offset config.

FIG. 65 shows a table illustrating some combinations of Offset Reference, Offset Input, and Mouse action and whether the resulting Order action will create a conflict.

FIG. 66 shows a schematic of the plug-in system.

FIG. 67 shows a Price Axis settings window showing Manual Centering and Automatic centering.

FIG. 68 shows a Relative Price axis settings window.

FIG. 69 shows a Price Axis settings window which show more settings related to Manual and Automatic centering.

### DETAILED DESCRIPTION OF THE INVENTION

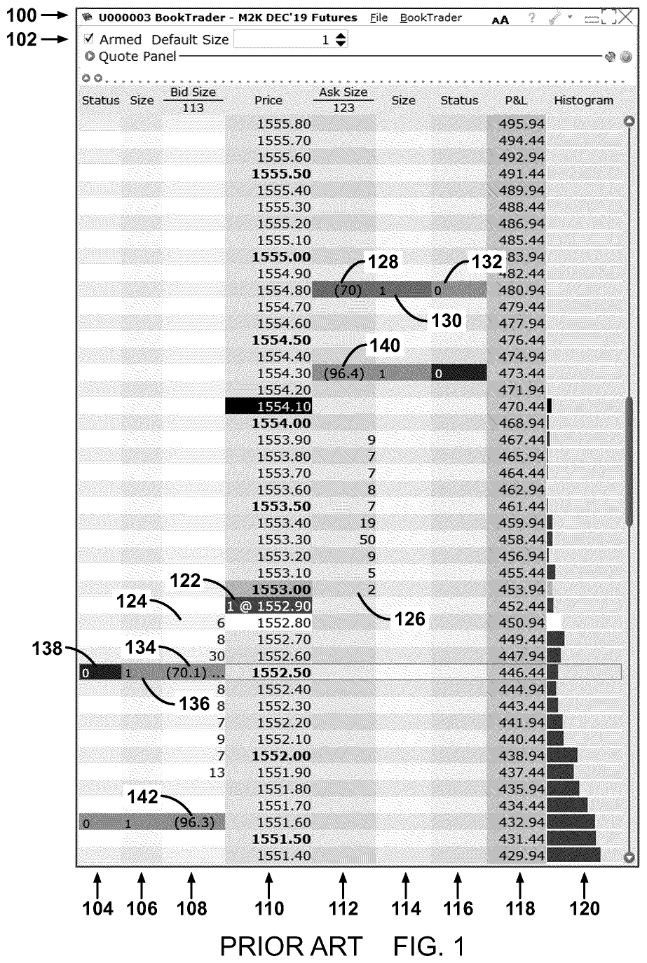

FIG. 1 shows prior art Booktrader window. The title bar 100 shows the account trading and security displayed on the Booktrader window. Order toolbar 102 show order related controls such as whether placing an order is enabled and the default quantity of orders placed thru the Booktrader window.

BookTrader is composed of several columns that enable the user to see the status of pending orders. Buy order status column 104 show the status of a buy order and its fills. Buy order size column 106 shows the quantity of a buy order. Bid size column 108 show a combination of the bid size and order key when a buy order is present on a row. Ask size column 112 show a combination of the ask size and order key when a buy order is present on a row. Sell order size column 114 shows the quantity of a sell order. Sell order status column 116 show the status of a sell order and its fills. P&L column 118 show the P&L of a position if it's closed at a row's price. Histogram column 120 show a histogram of the trades. Price column 110 show the price associated with each row. Price column cell with last trade 122 show which price the last trade occurred and the trade quantity.

Bid cell 124 show the best bid of the market depth. Closest to the last price column cell with last trade 122. Ask cell 126 show the best ask of the market depth. Closest to the last price column cell with last trade 122. A parent sell order 128 is shown on the right side of the price column 110. The order's key ‘(70)’ is shown on inside the cell. The order's quantity is shown on sell order size 130 while the status is shown on sell order status 132.

Child buy order 134 can be seen as a child of a parent sell order 128 as indicated by it's label ‘(70.1)’. Its order quantity is shown on buy order size 136 and the amount filled shown on buy order status 138. Another example of a parent and child order is shown by child sell order 140 and parent buy order 142 as indicated by their order ids (96.3) and (96.4).

The Booktrader GUI uses click and right-click on a cell to place orders. The type of order depends on which side of the Price column 110 is clicked. A buy order can be placed by clicking on the left side of the price column 110 and a sell order can be placed by clicking on the right side of the price column 110. There are certain dangers and inefficiencies with this method. An unintentional click on a price row above the Best Bid row results in almost an instant buy fill like a market order while an accidental click on a price row lower than the Best Ask row will result in a sell fill. The present invention presents a safer, intuitive, and more functional way of placing orders on a grid.

BookTrader only shows one price per row. It can also be seen that there a lot of empty cells on the Booktrader wasting precious screen space. On a very volatile market, the trading activity will quickly go out of the display and could impede the ability of the trader to keep track of the market.

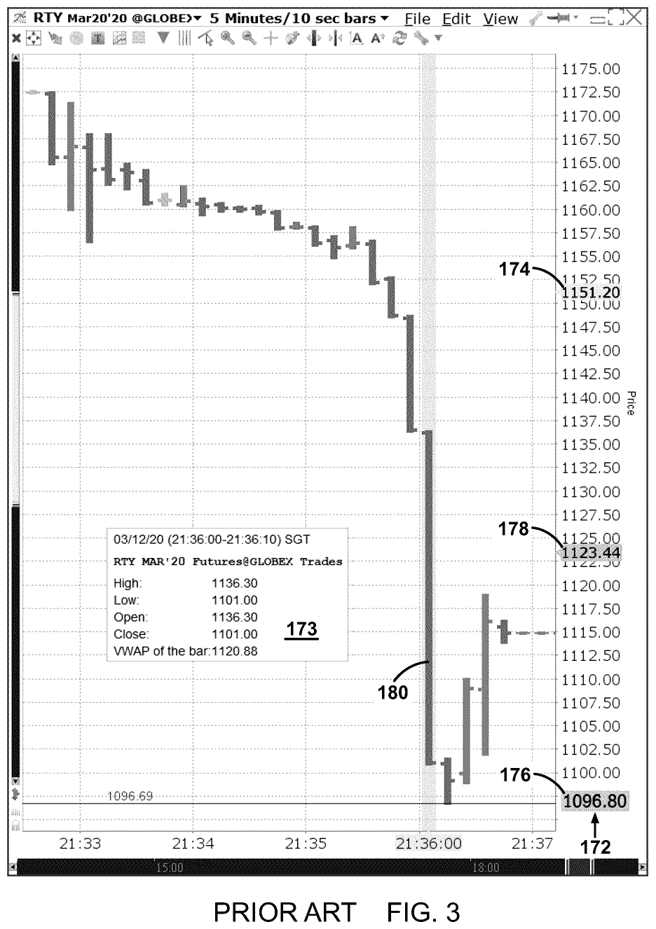

Also, on FIG. 1, BookTrader can only show the prices from 1551.40 to 1555.80 with a 0.10 pt increment, which is a range of only 4.4 pts. As will be shown in FIG. 3, it's possible to have a range of 35.2 pts over a 10 second period. A range of 35.2 will result in the BookTrader to scroll through 8 pages of rows just to keep the trading activity visible to the user. The user would have to weigh between not seeing their possibly orders or missing out on the trading activity.

Since the range of prices that the BookTrader window can show is very few, placing and managing orders also becomes a problem since the user is unable to see the entire trading range. The current invention will show various ways on how to use the screen space more efficiently so the trader can see a wider range of prices and still trade by the use of ‘Smart Order Action”

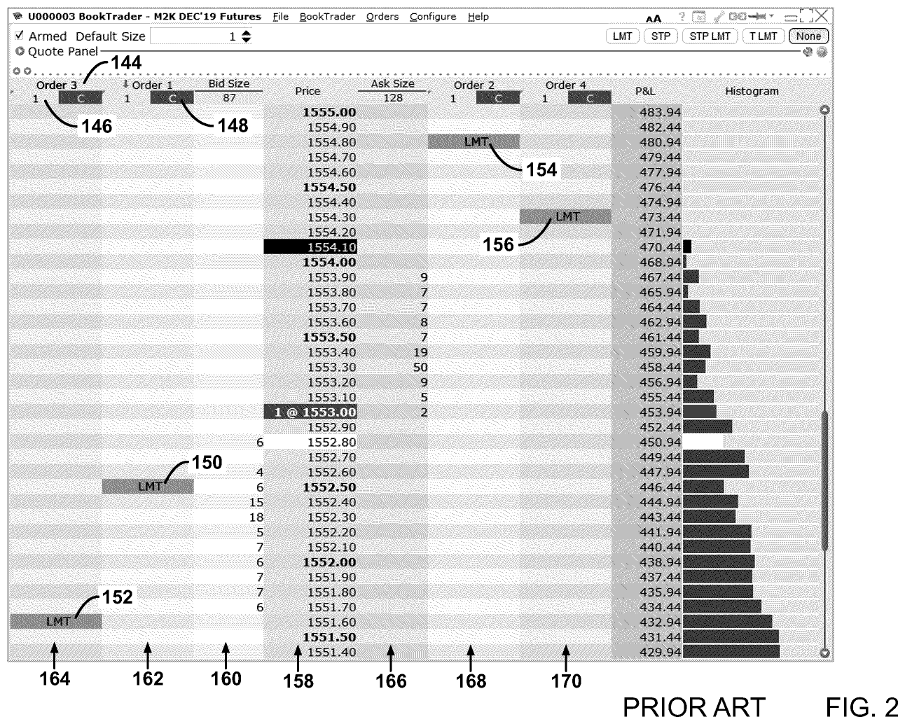

FIG. 2 shows a variation of a Booktrader window where each order is assigned one column. The columns Order 1 column 162, Order 3 column 164, Order 2 column 168, and Order 4 column 170 have one orders each of which the price and type are shown by limit buy order cell 150, limit buy order cell 152, limit sell order cell 154, and limit sell order cell 156. In this view, there are a lot more empty cells and hence a lot of wasted screen space.

Market depth have their dedicated columns as shown in bid column 160 which have cell labels as bid sizes and in ask column 166 where ask sizes are shown. Order name column header 144 shows the order name, under it are two cells. The order quantity 146 shows the quantity of the order.

The cancel order button 148 can be pressed by the user to cancel the order in that column. The price of the order can be determined by referencing the limit buy order cell 152 to the price column 158.

FIG. 3 shows an OHLC chart of a very volatile event during the Covid-19 pandemic. Of particular interest is very high Range 10 second OHLC bar 180. In the OHLC bar details 173 it can be seen that the High and Low is 1136.30 and 1101.10 which produces a Range of 26.2 pts. A Range of 26.2 pts is around 2.3% of the Last trade price 178 and that is only for a 10 second period. To fit 26.2 pts in FIG. 1 that could only display 4.2 pts or 42 rows would mean stacking more than six of FIG. 1's BookTrader or 262 rows. Trying to display 262 rows in a 1080p monitor would result in only 4.1 pixel per row which would have limited utility, if any at all. Accurately placing an order on a specific price would very hard since each row would only be given less than 5 pixels and text with a height of 5 pixels would be near impossible to read. The trader will not be able to read the price row label.

On another note, the expanded view that allow the user to trade in a wider range of prices is also suitable for Takeover and Acquisition news such as when Morgan Stanley acquired E*Trade in a $13 Billion Stock deal on February 20R20. E*Trade Stock jumped from $45.34 to $55.74 in 30 seconds as news of the deal was announced. This is a 1,040 cell move if each cell is in 1 cent increments. So, using the conventional Price ladder display of FIG. 1 would show a move of 7 price ranges based on 150 visible rows of 1 cent each. Over 15-30 seconds, such a move would appear chaotic as bid, ask quotes from Algo programs would try to adjust to the news. In our expanded cell groups, which show a greater price range over an extra 5, 10 columns, the entire move can be seen in just 1-2 views and thus be less confused about what is happening. The trader can see better where to place a new round of Buy, Sell orders.

The novel features which are believed to be characteristic of the present invention, as to its structure, organization, use and method of operation, together with further objectives and structure, organization, use and method of operation, together with further objectives and advantages thereof, will be better understood from the following discussion.

Trading, especially during an event such as shown in Prior Art FIG. 3, can be made safer by incorporating the present invention's Smart Order Action Offset feature. Interactions with the BookTrader grid can be made safer by implementing the Smart Order Action Offsets to the order placement process of BookTrader to prevent accidental fills specially just after an auto-centering. When an auto-centering action is performed and the user immediately clicks on a cell, the intended action of the trader may be different from what he intended due to the abrupt change in the mapping of the cells. A popup dialog can be shown to the user to keep or edit the output or order generated by the click or discard it.

The Buy Column Offset input and Sell Column Offset can be put in place to determine the type of order the user wants based on the distance of the clicked cell and the Bid Cell or Ask Cell. A “0” offset on the Buy Column would represent the Bid and a “0” offset on the Sell column would represent the Ask. The user can then input any number to constrain or limit the order actions to prevent accidental fills. For example, a Buy Column Offset value of “0” will only allow clicks on the Bid cell or lower to create Buy Orders and any clicks above the Bid cell is ignored and no accidental fill will occur. Similarly, a Sell Column Offset value of “0” will only allow clicks on the Ask cell or higher to create Sell Orders and any clicks below the Ask cell is ignored.

Another feature of the Smart Order Action Offset is to allow some flexibility to place Buy Orders on the Sell Columns and Sell orders on the Sell Column. For example, “+1” Offset input for the Bid side column can mean a click 1 cell above the Ask Cell would be treated as a Buy Order Click. A left-click two cells above the Ask Cell would do nothing, so no accidental fill. An alternative would be to show a pop-up dialog when clicks happen beyond the offset values where the dialog explains the Offset Safety feature is enabled. The dialog can then allow the user to configure it in the pop-up for to change the Offset Safety feature setting or even allow machine learning to predict what the user may have intended and allow the user to select from a set of choices.

Similarly, the STP Buy Offset input would be “+1” input, which means a Right-click in the Buy Column would have to be 1 cell above the Bid Cell to result in a STP Buy Order placement. Below this cell, at the Bid cell or lower, a Right click would not result in a STP Buy Order unless the user inputs a “0” or “−1” input, etc. On the other hand, a STP Sell offset of “−1” would mean a Right-click in the Sell Column would have to happen below the Ask Cell to produce a STP Sell order.

Alternatively, the trader can also use the Smart Order Action offset feature to create a MKT Buy offset by using offset values “+1” or greater which represent cells above the Bid cell and ignore clicks beyond the offset value which would create LMT Buy orders that will get instantly filled. The additional functionality of placing MKT orders using the same input greatly increases the ability of the trader to respond to market movements. For example, a MKT Buy offset of “+3” would mean a MKT Buy Order would be created when any cell immediately above or up to 3 cells above the Bid cell is clicked will result in a MKT Buy order. Clicking on the Bid Cell or below will have the same behaviour where LMT Buy orders are created at that cell's representative price. Similarly, the user can use a MKT Sell offset of “−2” on the Sell column to place MKT Sell Orders when any of the two cells below the Ask Cell is clicked and any clicks 3 cells below or lower are ignored to prevent accidental fills. A dialog can be

The Smart Order Action Offset can also be used to constrain the inputs of the user near the Bid cell and/or Ask Cell to prevent accidental fills. For example, using an offset of “−10” and “+10” can limit where the trader is allowed to place their orders to 10 cells above the Bid cell or Ask cell and 10 cells below the Bid cell or Ask cell. Any clicks outside of the range of allowed cells are ignored to prevent accidental fills.

Instead of ignoring clicks or any inputs beyond the offset values, a dialog shown to the user can be used to resolve clicking or other inputs outside the range of allowed cells. The dialog box can be used to confirm the order parameters while clicks inside the allowed range of cells can create orders for the user with no additional dialog boxes or forms. Clicks outside of the offset range can mean the order are unlikely to be filled immediately and the user may have more time to check the and confirm the parameters of the order.

It should be noted that Clicks, left-click can mean the same action on a mouse button depending on the settings. Similarly, a tap, swipe left, right swipe, up swipe, down swipe etc. can also mean the same action or mean the same action.

Smart Order Action can also result in Orders being placed on the Chart, like IB's Chart Trader. Below the Market, it's a Bid or Buy Order, and above the Market, it's an Ask or Sell Order, etc. So, the Buttons the user chooses are Buy, Sell or STP Buy, STP Sell. There can also be safety in Chart Trader so a Buy Order is not instantly filled if placed above the Ask, a Sell Order is not instantly Filled if placed below the Bid.

The use of the terms Bid size column, Bid side, Buy side, refer to the same Buy Order related column, Grid, or an area of the grid, column(s) or row(s) for placing, modifying a Buy Order, STP Buy Order, and Orders typically associated with the Buy, Open Side of a Long Order or Close side of a Short Order.

The use of the terms Ask size column, Ask side, Sell side, refer to the same Sell Order related column, Grid, an area of the grid, column(s) or row(s) for placing, modifying a Sell Order, STP Sell Order, and Orders typically associated with the Sell, Close Side of a Long Order or Open side of a Short Order.

In a common Grid with both Buy and Sell areas and Orders, Order actions, Order types, the Buy side is the side near, at, or below the Bid Cell in terms of Price and cell location. Similarly, the Sell side on a common Grid, is the side near, at, or above the Ask Cell in terms of Price and cell location.

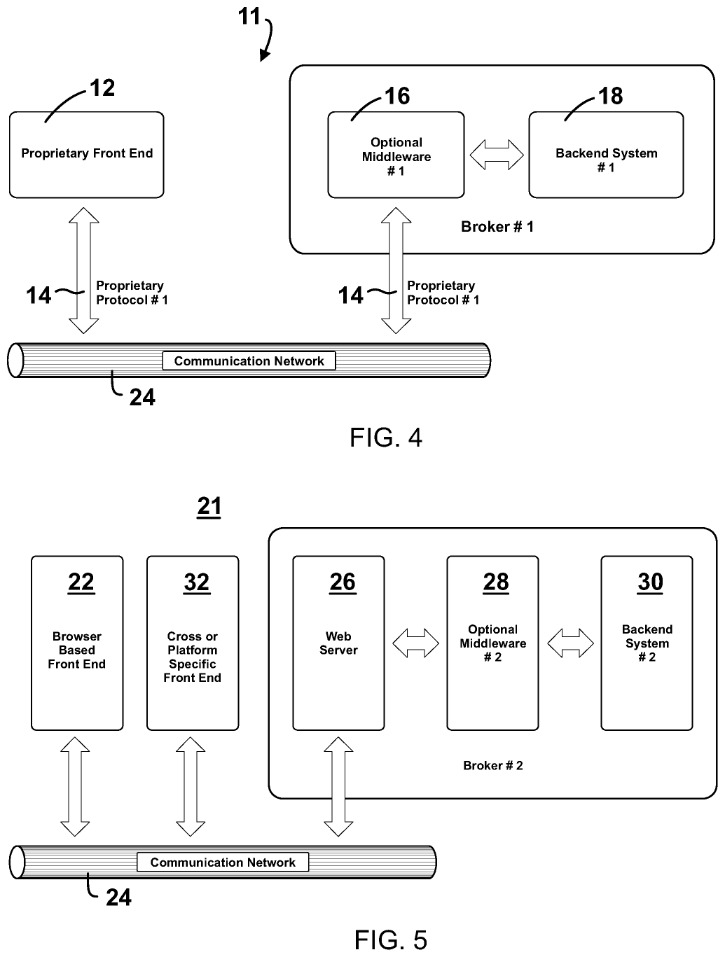

Turning to FIGS. 4 and 5, two prior art systems are shown which employ different front ends. In the prior art system of FIG. 4, showing a system architecture which is in place and which is operated by Broker #1, the system 11 comprises a proprietary front end 12, a proprietary protocol 14, an optional middleware 16, and the backend system 18. The optional middleware 16 and the backend system 18 are located on the premises of Broker #1 who communicates through a proprietary protocol 14 to the proprietary front end 12. Alternate locations of the backend system 18 are on the cloud, leased server space, or co-located at an exchange.

In the system of FIG. 5, the system 21 includes a web-based application, which presents a browser-based front end. A Cross or Platform Specific Front End 32 may also be present

In this specification: the terms “frontend”, “front-end”, and “front end” are used interchangeably; the terms “backend”, “back-end”, and “back end are used interchangeably; and the terms “right click” and “right-click” are used interchangeably. Communication is carried out through the Internet, as shown at 24. On Broker #2's web server 26, there may be optional middleware 28, and there is a backend system 30. Either proprietary front end 12, browser based front end 22, Cross or Platform Specific Front End 32 is what a trader will see on his computer, mobile device, smart TV, implant, or wearable, and it is the tool that the trader uses to get quotes, manage his account with the respective brokerage firm, buy and sell shares or securities in general, and to track his transactions.

Front ends tend to be implemented as web applications, as indicated in FIG. 5; however, any proprietary front end may also be employed. Proprietary front ends are generally text based and not helpful when it comes to visualizing market information. If a proprietary front end is used, that system involves the installation of application software at the local computer employed by the trader. A proprietary front end may also be accessible thru a web browser which may not require installation but may or may not have the full features as the one that requires installation.

If either backend system 18 or 30 exists in conjunction with any embodiment of the present invention, it is because they are the backend systems that are operated by respective brokers, electronic communication networks (ECNs), or even stock exchanges, and the like. Any such backend system may likely reside in a UNIX machine, cloud, or a leased server spaced. Any backend system will generally have the responsibility for handling a number of tasks. They include account management. This is the responsibility for managing and keeping all data up to date for each account—each customer or various accounts run by a customer—that is handled by that market participant. As noted, a market participant might be a broker, it might be an approved electronic communication network, or it might be a stock exchange, commodity exchange, futures exchange, bourse, or auction system.

Another task charged to the backend systems which function in the prior art, and which function in association with the present invention, is that of processing buy orders and sell orders for each buy transaction and for each sell transaction which that market participant undertakes to perform.

Still further, the backend system is responsible for order execution, whereby each buy transaction and each sell transaction which the market participant undertakes to perform will be executed.

The backend system is also responsible for data feed handling, whereby streaming data concerning any orders or quotes for any selected security is disseminated on request to any trader, as discussed hereafter.

Finally, any backend system described herein will also be responsible for system management, for purposes of maintaining security and operation of the respective backend system of that market participant.

A communication protocol is required in prior art systems, as well as in the present system. In the prior art systems, the communication protocol for proprietary front end 12 is one which is used to securely transmit data from a proprietary front end 12 to the backend system 18, and in the reverse direction. Usually, such proprietary protocol is built on top of TCP/IP sockets, most likely using some form of data encryption.

For the systems of the sort shown in FIG. 5, where Internet communication is employed in association with web-based front end, a typical communication protocol is HTTP or HTTPS.

A middleware component is employed, as shown at 16 and 28 in FIGS. 4 and 5.

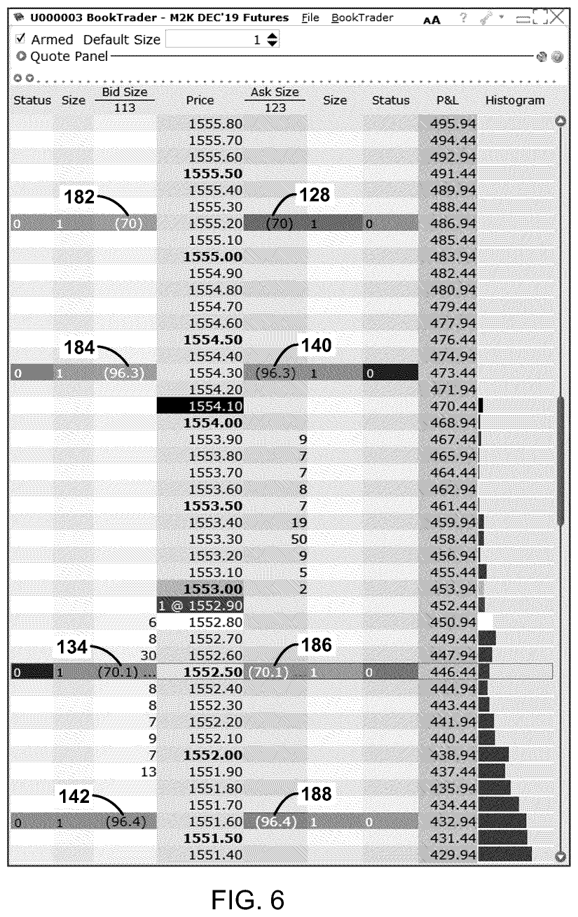

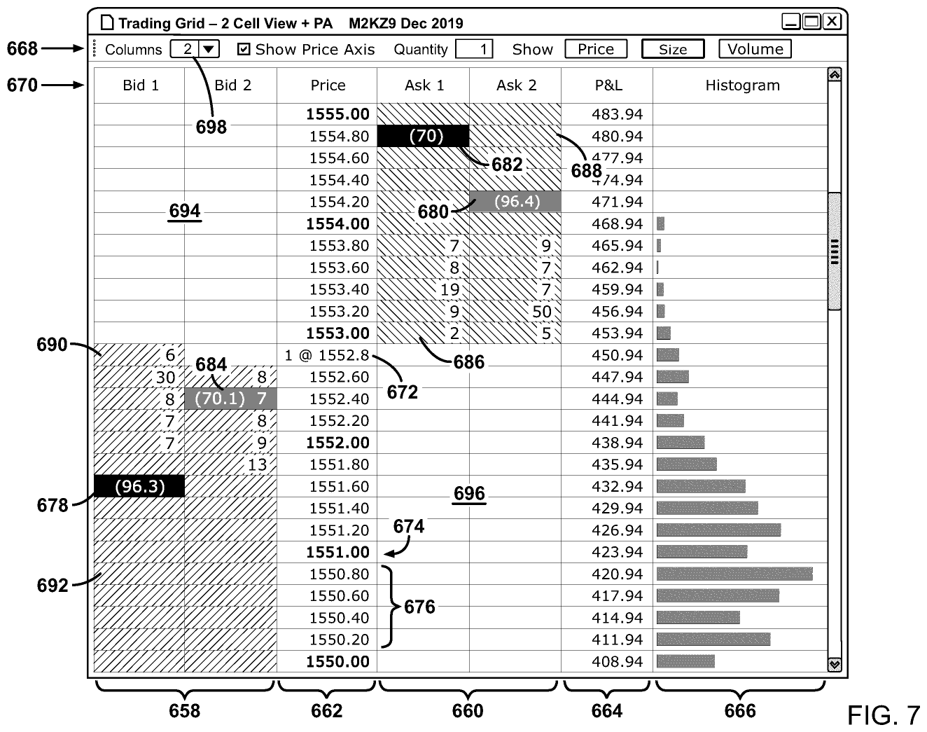

FIG. 6 shows a variation of FIG. 1 where the orders from the bid columns are mirrored on the ask columns and the orders from the ask columns are reflected on the bid side columns. FIG. 6 allow the user to better gauge the distance between orders.

Parent sell order 128 and child sell order 140 from the ask side columns are shown on the bid side columns by mirrored parent sell order 182 and mirrored child sell order 184. Parent buy order 134 and child buy order 142 from the bid side columns are shown on the ask side columns by mirrored parent buy order 186 and mirrored child buy order 188. The mirrored orders have slightly different color schemes to prevent confusion from the source orders.

Icons, mouse-over tooltips, border highlights, letters, prefixes, suffixes, may also be used accentuate the orders. For example, instead of ‘(70)’ the mirrored order can be labelled ‘Mirrored (70)’ and have the status and sized removed to provide space for the word ‘Mirrored’ to differentiate from the real order.

The user has several choices on how the Mirrored order reacts to user interaction. 1) The Mirrored order can function as display only and not interact with user inputs to prevent errors. 2) The Mirrored order can also respond to user interaction the same way as the source order responds to user interaction. In this case, whatever is done to the mirrored order will also apply to the source order. For example, drag and dropping a mirrored order to a new price will also move the source order to a new price.

FIGS. 7 to 16 show how the present invention efficiently utilize the display area so the user can trade on a wider range of prices.

FIG. 7 shows a grid with two Bid columns and two Ask Columns. When column count drop-down 698 on the toolbar 668 is changed to 2, the resulting column grid arrangement is shown on FIG. 7. Instead of one bid and one ask column, there are now two bid columns 658 and two ask columns 660.

As a result of changing the number of bid and ask columns, the elements aren't buy order 678, child sell order 680, parent sell order 682, child buy order 684, ask cell with size 686, ask cell 688, bid cell with size 690, and bid cell 692 have changed location compare to the single column view. Note that only their positions on the screen changed but the price each element is associated remain the same.

Representation of cells that have no market depth information are shown by bid side outside market 694 and ask side outside market 696.

The price axis column 662 is be found in between the two bid columns 658 and two ask columns 660 now have a different price labels to reflect the change in arrangement of the bid and ask cells. The labels shown on the price axis column 662 are now in increments of 0.2 instead of 0.1. As a result, the last trade is now highlighted on the price axis last trade cell 672 with a price label 1552.8 instead of 1552.9.

The price axis last trade cell 672 may also be configured to show the last trade price of 1552.9 instead of the price axis cell label. The price axis label would go back to 1552.8 in the event of a last trade at that price or when the last trade price is neither 1552.8, nor 1552.9.

The price axis major tick cell 674 are now spaced 1.0 pts apart in response to the change in setting. Similarly, the price axis minor tick cells 676 are now in increments of 0.2.

Above is the default major tick setting but the user can change the interval between major ticks, e.g., 2.0 pts, 5.0 pts, 10.0 pts

It should be noted that status and size columns have been hidden in the column header row 670 and instead, an additional bid and ask columns are shown. The P&L column 664 and histogram column 666 are still shown on the grid. The user may also configure the grid to keep showing the status and size columns resulting in a wider window. In addition, the user may also configure the grid to hide other columns when the column count drop down 698 is set to more than one. e.g., hide the P&L column 664 and histogram column 666 when the columns when the column count drop down.

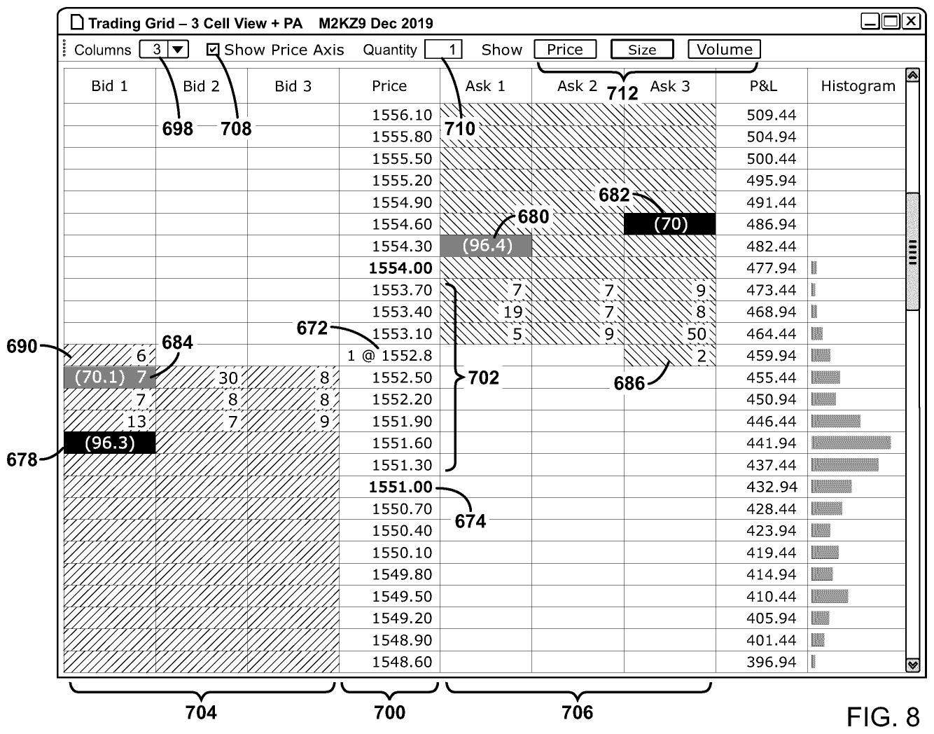

FIG. 8 shows three bid columns 704 and three ask columns 706. To switch to three column mode, go to column count drop down 698 and change the number to three by either typing in the number or clicking on the dropdown button and selecting the number ‘3’. As a result, the positions of parent buy order 678, child sell order 680, parent sell order 682. child buy order 684, and bid cell with size 690 have changed been remapped to conform with the three column mode. Only the positions of the cells on the grid have changed but their attributes such as price, size, quantity, etc. remains the same.

As an effect of changing the bid/ask column count to three, there are 9 price axis minor tick cell 702 for every price axis major tick cell 674. Also, the cells of price axis column 700 is in increments of 0.3. The cells that are divisible by 1.0 points are set to be highlighted as major tick cells. If the user wants more major tick highlights, cells divisible by 0.5 pts can also be highlighted. Other modes of major tick highlight may be employed. e.g., highlight every 5th cell, every 10th cell. The last trade is shown on the price axis column 700 in price axis last trade cell 672. The price axis last trade cell 672 have a label of 1552.8 and since it is associated with the prices 1552.8, 1552.9, 1553.0, it gets the ‘1 @’ symbol to represent last trade price. The Show Price Axis checkbox 708 can be used to show/hide the price axis column 700 by checking/unchecking.

Mouse-over or right-click on the cell may show details on the trade such as actual price and volume on a pop-up. Another way of showing additional data to the user is by flashing the relevant data on the cell on mouse-over while temporarily hiding the default cell display. Once the user leaves the cell, the default cell display is returned.

An order can be placed on the grid by a click or right-clicking bid/ask cell. The order quantity text box 710 sets the quantity of the order when interacting with the cells of the grid.

The order type and order action are determined depending on whether the target cell is a bid cell or an ask cell and the position of the target cell relative to a reference price, e.g., as Last, Best Bid, Best Ask. In addition, more order action, order types, macros, plug-in function can be added depending on the input method such as mouse buttons, screen tap, keyboard, voice commands, and others.

By default, clicking on a bid cell with an associated price under the Best Bid will result in a Limit Buy Order. Clicking on an Ask cell will result in a Limit Sell Order. Right-click above the Best Bid will result in a Buy Stop Order while right-click above the Best Ask will result in a Sell Stop Order. Drag and drop of the quantity text box 710 on a Bid cell or Ask cell can also be done to place an order. The order price is determined by the price associated with the target cell.

Other securities can be used to trigger a buy, sell, or any order for another security. For example, if a non-tradeable security or indicator is what is displayed on the grid, a user may be prompted to select a tradeable security when the user clicks on a cell. The buy or sell action is determined whether the user clicked on a cell below or above a reference value (current value, average, midpoint, etc.). The security and quantity may be preselected such that the user can seamlessly trade one security using another security, index, studies, or measure. E.g. user displays RUT index on the grid, and the futures M2K forward contract with a quantity of 1 is preselected so when a user clicks on a cell of the RUT grid, an M2K BUY 1 or SELL 1 will be placed on that cell.

Other order parameters that are rarely changed like exchange, TIF, etc., are usually preset before an order is placed thru configuration via toolbars and configuration windows.

If there's a conflict in determining the order type and order action, a dialog box maybe shown to the user to resolve the conflict.

There are several data that can be shown on each cell and the toolbars help the user to quickly switch between them. Show on cell toggle buttons 712 sets what labels or data are displayed on the grid cells. Size is toggled on so bid sizes are shown on cells such as the bid cell with size 690, and child buy order 684. Show on cell toggle buttons 712 can be toggled all on, all off, or a combination of buttons that have mixed states of on and off. The grid will try to fit the data on the cell which may sometimes not be possible. Some ways to show hidden data to the user is a marquee text, cycling text, cycle text on mouse-over, cycle text on update of data, balloon dialogs shown on an empty area. The more advanced and complicated configuration such as formatting and animations can be accessed thru configuration windows.

The price grid or cell grid can be also be used to select a price for an input box by clicking on a cell or selecting a range of cells if the input required is a range. Whenever an input box requires a value a Price Selector can be used which is similar to the multi-column nature of the grid of present invention which allows the user to select from a wider range of values.

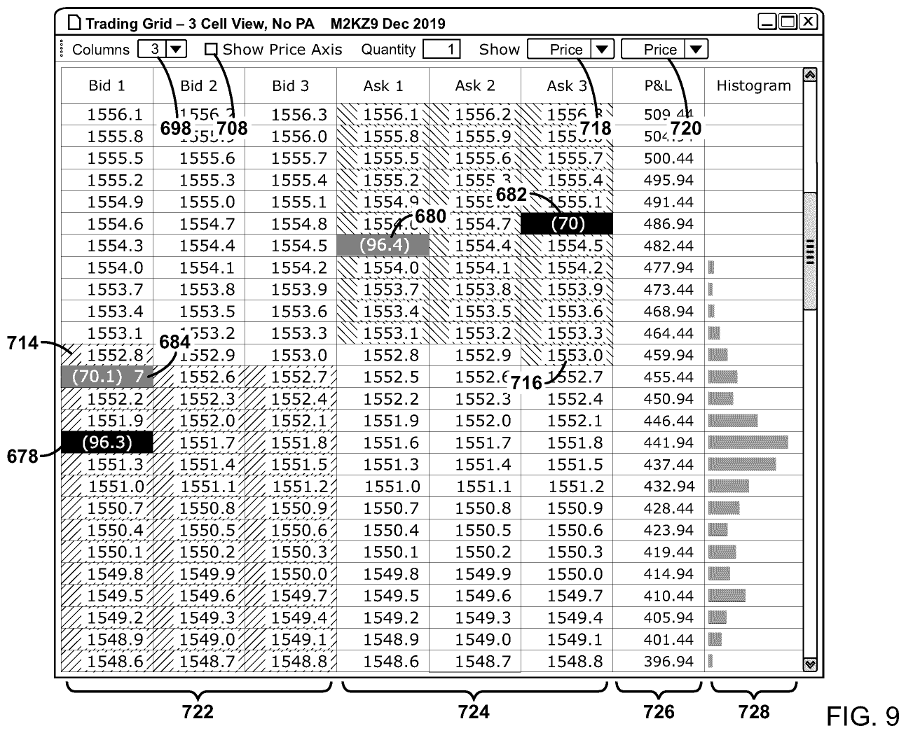

FIG. 9 is a variation of FIG. 8 where the show price axis checkbox 708 is unchecked and price is shown on cell labels instead of sizes. The column count drop down 698 still remains at three. By hiding the prices axis and showing price labels on the cells, FIG. 9 is able to hide the price axis to and still be able to communicate to the trader the price of each cell.

Order labels are shown instead of cell price when there's an order as shown by parent buy order 678, child sell order 680, and parent sell order 682. If there's enough display area, the cell will try to display more information such as the size of the bids on cell where child buy order 684. The cell of child buy order 684 has a label that is a combination of order ID and size. Bid cell with price 714 and ask cell with price 716 now show price instead of size. P&L column 726 remains the same width while histogram column 728 reduced in width to account for the additional columns.

Both show on cell drop down for bid side 718 and show on cell drop down for ask side 720 have Price selected as option, therefore bid and ask cells show prices as labels. Similar to show on cell toggle buttons 712 on FIG. 8 except the options are on a drop down menu and bid columns 722 can be configured independently from the ask columns 724.

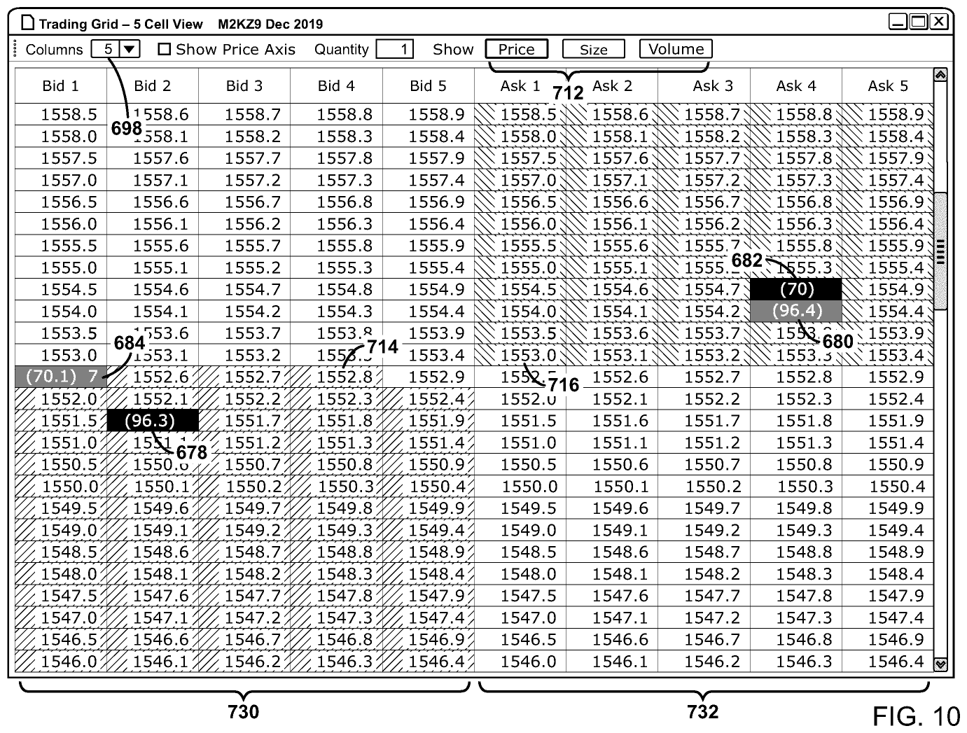

FIG. 10 shows a variation of FIG. 9 with 5 bid columns and 5 ask columns and is able to show even a wider range of prides by hiding some of the columns. The P&L and Histogram columns are also removed and only the bid columns 730 and ask columns 732 remain.

To switch to 5 column mode, go to column count drop down 698 and change the number to three by either typing in the number or clicking on the dropdown button and selecting the number ‘5’. As a result of the change in the number of bid columns and ask columns, the parent buy order 678, child sell order 680, parent sell order 682, child buy order 684, bid cell with price 714, ask cell with price 716 have been remapped to their new locations.

Show on cell toggle buttons 712 which affects both bid columns 730 and ask columns 732 which have the same effect as FIG. 7's show on cell drop down for bid side 718 and show on cell drop down for ask side 720 when both are set to show Price. These buttons can be used to quickly switch between the shown data on the cells.

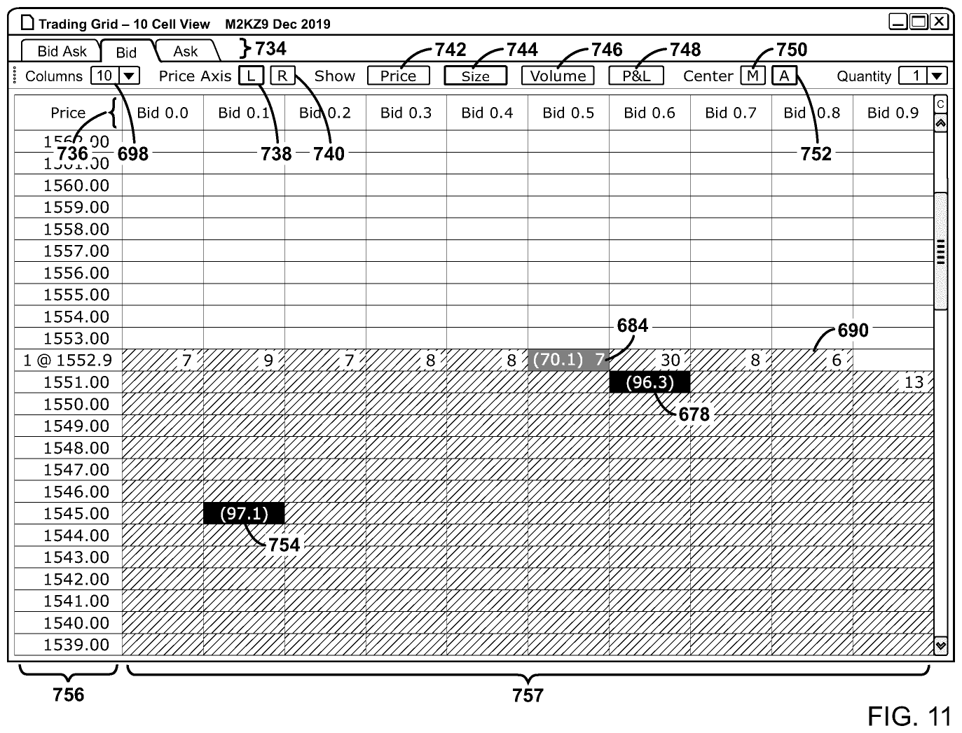

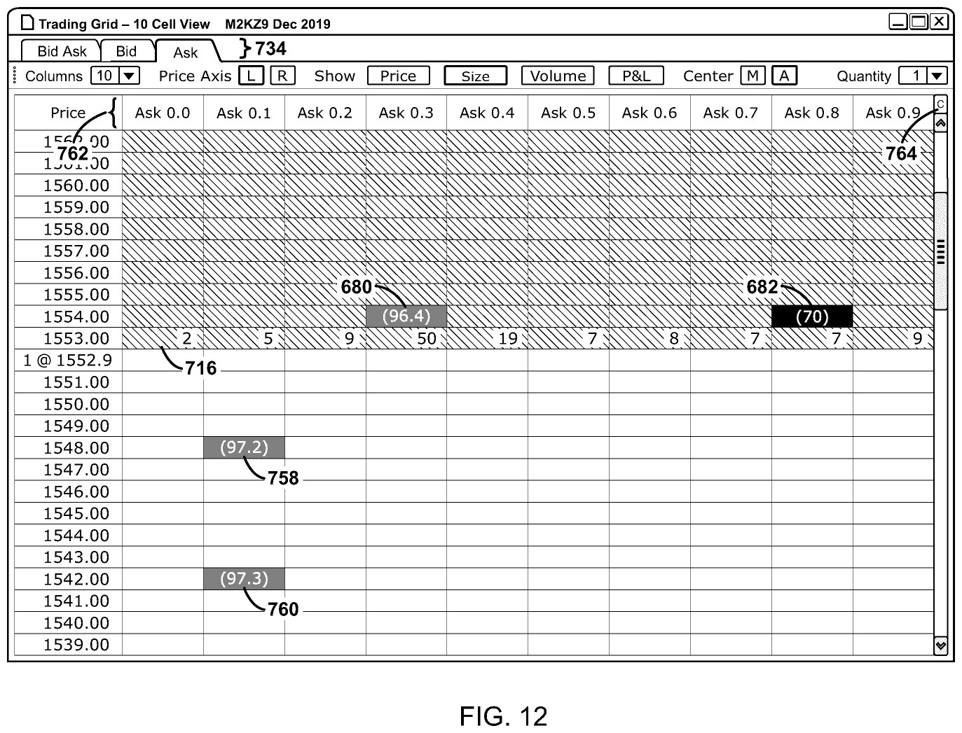

FIGS. 11 and 12 show tabs where only Bid cells and only Ask cells are shown and makes an even wider range prices visible to the user. These tabs can be used so the trader can focus on buying only or selling only. The Smart Order Action feature can still be chosen for this tab or a different scheme can be used where buying is focused on the Buy side only the Bid tab while the Ask side can be focused on Selling only. This is possible as each tab can be customized to have independent input schemes different from each other.

The order functionality of the Smart Order Action feature can still remain the same as when both bid side and ask side cells are visible or have the Smart Order Action features be set to function that it is focused on buying or selling. For example, a click on the Bid tab can be mapped as placing a Buy order when a click is performed on any cell as opposed to default behavior of the Smart Order Action feature where it first determines whether a click happened on bid cell or ask cell. A right-click can be mapped to STP Sell order.

If the Grid is on Child order mode then a Parent Order on the Sell side, could have a Child Order on the Buy side, etc. A Parent Close Sell Order on the Sell side, could have a Child BB Order on the Buy side, etc. A Parent Open Short Order (a Sell Order also), could have a Child Close, Cover Order on the Bid side and a STP Buy Order on the Sell side also, as a Bracket Order.

FIG. 11 shows a grid on a tab containing only the Bid side grid while the Ask side grid is hidden and instead a wider range of prices is shown to the user.

The Bid tab is selected on the tabset 734. Bid Ask tab show combined Bid and Ask sides, Bid tab show the bid side columns 757 only, while the Ask tab show the Ask side only. Tabs are not restricted to above configuration only. There could be more than one Bid tab, more than one Ask tab, more than one Bid ask tab. Each with their input methods and preferences.

Each tab can hold their own view configurations. E.g., one Bid Tab can may only have the price toggle button 742 set to enabled while another Bid tab can have only the volume toggle button 746 enabled resulting in two very different view of the same bid columns.

The tabset 734 tab names can be customized to better describe their purpose. Tabs can be rearranged, formatted, and renamed.

10 columns can be shown by using the column count drop down 698 and setting it to ‘10’ and this results in 10 bid side columns 757. As a result of the ten bid columns, the locations of child buy order 684, parent buy order 678, bid cell with size 690, parent order 754, are remapped into new locations in the bid side only grid.

Bid column headers 736 have a different labelling scheme as a result of changing the column count drop down 698. Since there are 10 bid side columns 757, the cells under a particular column would have to have the decimals shown on the label. E.g., all cells in column Bid 0.0 would have prices that have 0.0 as their decimal e.g., 1552.0, 1553.0 and all cells in column Bid 0.2 would have prices that have 0.2 in their decimals e.g., 1552.2, 1553.2. This keeps the headers compact while still being able to clearly identify the price of the cell by utilizing both price axis 756 cells and column headers. Left price axis toggle button 738 is enabled and thus the price axis 756 is displayed on the left of the grid. Disabling the left price axis toggle button 738 would hide the price axis 756. The right price axis toggle button 740 also perform a similar function except that it shows or hides a price axis on the right most column of the grid. Note that it is not recommended to all of the price axes unless there's some other way to identify the price of the cells such as price labels inside the cells as shown in FIGS. 9 to 10. The price toggle button 742 show or hide prices on the grid cells while the size toggle button 744 show or hide bid/ask sizes on the grid cells. Volume toggle button 746 show or hide volume traded on the price/s associated with each cell. P&L toggle button 746 show the P&L values instead of the bar graphs on P&L column 726 of FIG. 9

Manual centering toggle button 750 disables the automatic centering feature. The user would have to manually scroll the grid up or down when the trading activity goes out of view. This can be useful when the user wants the grid to not move e.g., when placing order like bracket order which have consists of parent and child orders.

Automatic centering toggle button 752 enables the automatic centering feature. When the automatic centering is enabled, the grid will automatically scroll the grid once the trading activity goes out of view or near out of view.

Centering triggers can be configured e.g., if the market touches the 2 bottom or the 2 top rows auto centering is triggered. Centering may also be configured to just scroll up or down a certain number of rows instead of putting the trading activity in the center of the grid. e.g., only move 3 rows up when the trading activity touches the 2 topmost rows; only move 3 rows down when the trading activity touches the 2 bottommost rows. Since the change in visuals is not as abrupt as a literal centering, this type of behavior may allow the user to retain context and have better point of reference since some prices on the price axis 756, and possibly some orders, would still be visible.

FIG. 12 is a complement of FIG. 11, showing the Ask side grid only while the Bid side grid is hidden. The Ask tab is selected on the tabset 734. Only ask cell with size 686 and sell orders like child sell order 680, parent sell order 682, child sell order 758, child sell order 760 and ask cells are shown.

Similar to bid column headers 736 of FIG. 11, ask column headers 762 also have the same scheme.

Note that the bid/ask tabs can have different column counts, the settings can become independent on a tab by tab basis.

The manual center button 764 is used to center the (trading activity/row containing the last trade on the grid. Aside from the last trade, other values such as Bid-ask Midpoint, best bid, best ask, can be used to center the trading activity.

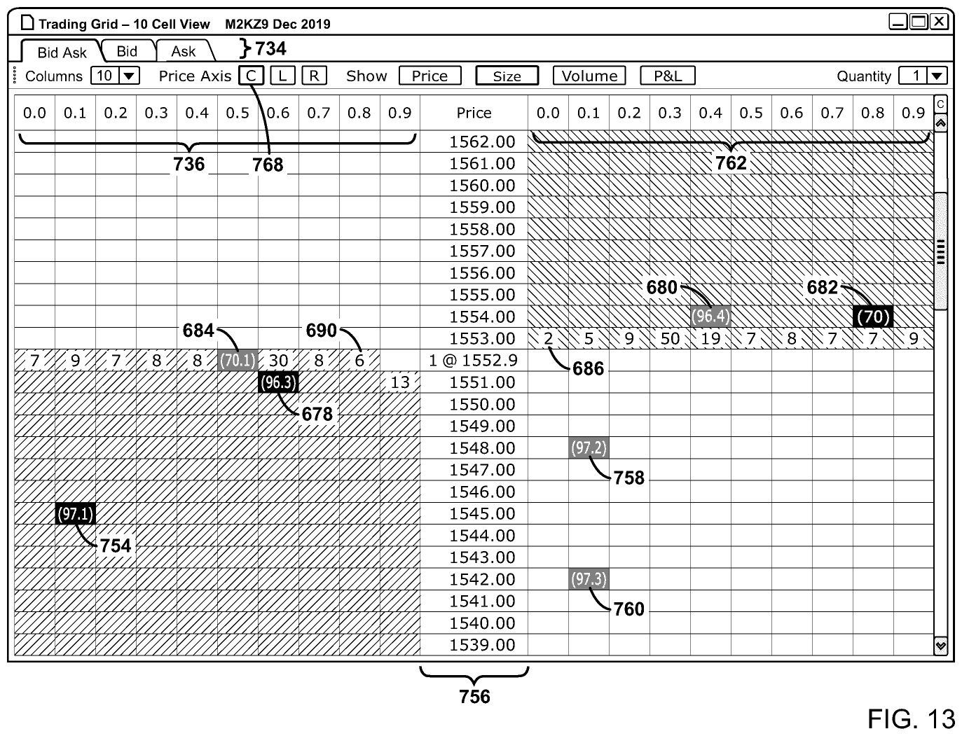

FIG. 13 shows the layout of the grid when the Bid Ask tab is selected from the tabset 734. The Bid Ask tab shows a consolidated view FIG. 11 and FIG. 12 where a common price axis 756 is shared between the Bid side grid and Ask side Grid. The trader benefits from the wide ranges of visible prices while still being able to precisely place orders.

The price axis center button 768 is enabled and as result the price axis 756 can be found in between the bid side columns and ask side columns.

Bid column headers 736 and Ask column headers 762 have truncated headers and only shows the numerical part without the ‘Bid’ and ‘Ask’ text. Default column arrangement is left to right and can be changed to right to left. Bid columns and Ask columns can have different arrangement. E.g., Bid Columns are right to left and Ask columns left to right.

When a mouse-over or when a cell or range of cells is selected, the Bid column headers 736 and Ask column headers 762 together with the common price axis 756 can have a visual change such as change of border or background color to help the user identify the price of the cell underneath the cursor or selection.

Ask cell with size 686 and bid cell with size 690 show the best bid and bed ask respectively. The spread may be hard to determine at first glance and if the traders prefer to, they can enable an option which echoes the ask cell with size 686 on the bid side grid and the and bid cell with size 690 on the ask side grid. Slightly muted colors, background, borders, or labels can be used to differentiate the echoed cells so they may not be confused with the other cells.

Orders from both sides can be seen with slightly less detail e.g., child buy order 684 only have the order ID and the size was hidden. The other orders child sell order 680, parent sell order 682, and parent buy order 678 still appear basically the same since they don't have size info. Still, the price of the order can still be precisely determined by referencing to the column headers and the cells of the common price axis 756. Order size and other order parameters can be displayed on a mouse-over pop up or tool tip.

Moreover, in FIG. 13, the user benefits from viewing a wider price range and having both the bid side columns and ask side columns visible. The user can see both parts of a bracket order namely the parent order 754, child sell order 758, and child order 760 which otherwise would not have been visible in a one column bid, one column ask view.

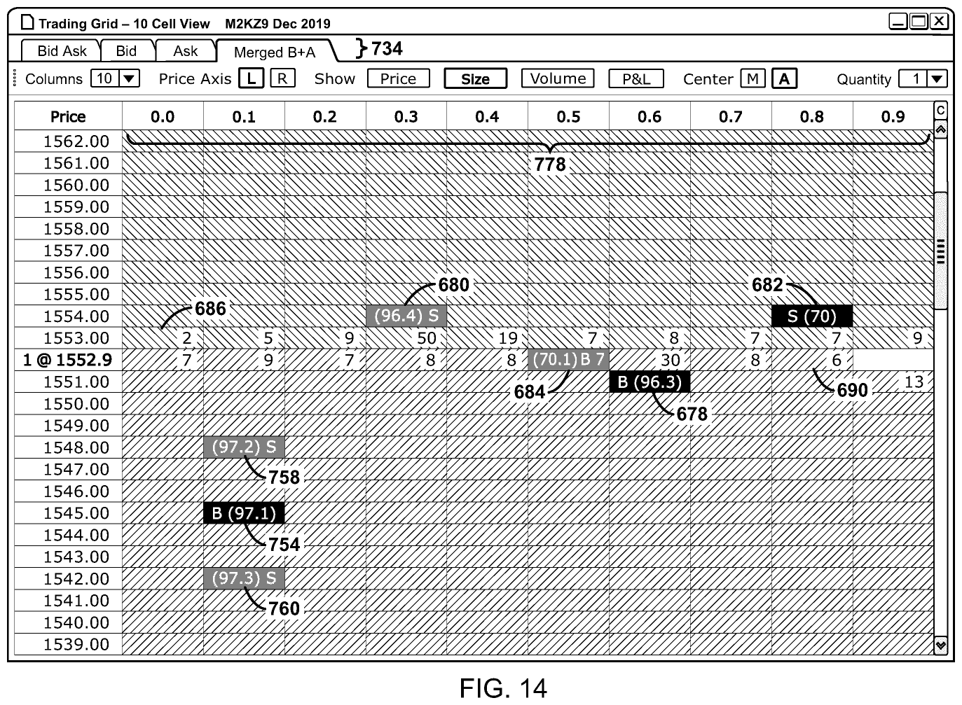

FIG. 14 shows a Merged B+A tab selected in tabset 734. Bid cells and ask cells are merged on a single grid. Ask side cells are on the upper part of the grid, while bid side cells are located on the lower part of the grid. In this view, the text is more legible and more information can be shown on each cell as the area of each cell is wider.

The column headers 778 represent the decimal portion of cells. Bid side cells and ask side cells now share the same price axis and column headers.

Empty space is utilized efficiently compare to FIG. 13 which have half of the grid as empty cells. Each cell also has more room since their widths are wider and more information can be shown.

Parent sell order 682 shows an ‘S’ on the right side of the order Id to represent a sell order. Aside from the letter ‘S’, the position of the letter to the right side of the order Id is utilized to represent a parent order. Its child buy order 684 shows a ‘B’ on the right side of the order Id to represent a child buy order. Aside from the bid size and order size, child buy order 684 also shows the bid size information after the ‘B’. The position of the ‘S’ and ‘B’ can be configured to be on the left or right side of the cell. Parent buy order 678 and parent order 754 shows a ‘B’ on the right side of the order id to represent a parent but order. Parent order 754, child sell order 758, and child sell order 760 are parts of a bracket order. One advantage of the Merged B+A view is that it's easy to gauge how far apart the orders are just by counting the cells

Bid cell with size 690 and ask cell with size 686 represent the inside market. The spread can be seen by the blank cell in between these two cells which means there's a 0.2 pts spread. If there are no blank cells between the two cells, it would mean that the spread is 0.1 pts. A spread of 0.0 pts would mean that the best bid and best ask overlap on the same cell.

Most of the time there's no overlap between bid cells and cells. When there's an overlap, the overlapping bid and ask can be shaded differently from the ask cells and the bid cells.

Placing orders on FIG. 14 is done by clicking on a cell. A click generates a buy or sell order depending on what type of cell is clicked. If a Bid cell is clicked, a Buy order is generated and if an Ask cell is clicked, a sell order is generated. If there's overlap or the click is performed.

Single Order moves on the Grid can be supported by clicking in one location to place the Order and then Clicking in a new location to move the Order. The click to move Order can be constrained to just to the Bid side, just to the Ask side, or allow the click to cross the Bid, Ask Spread to the other side so there can have 2 Orders on the Grid, one on the Bid side, one of the Ask side and both can be moved via a Click in their respective Bid side, Ask side areas. If a Single Lmt Order is allowed to cross the Bid Ask area, then the click would only work with a single Active Order on the Grid.

Constraining the move to one side makes sense because moving to the other side of the grid would usually result in an instant fill if allowed to be moved to the other side (bid side to ask side, ask side to bid side). The user can be given a pop-up warning for install fill or the order type can be changed from LMT to a STP or from Buy order to Sell order or vice versa. A time limit may be introduced to differentiate when the user intends to create a new order or just intends to move the recently created order. Note that a click on the other side would just result in a new Order placed on that side if Orders are not allowed to be moved to the other side as it will just result in an instant fill. So, a Buy Order will only be moved if the click is still on the Bid side. A click on the Ask side would result in a new Lmt Sell Order. This functionality can be shown as an Icon on a Toolbar to easily change the behaviour in real-time.

If there are multiple Orders in a Cell, user would likely be presented with a Dialog Box to choose the Order, or there would be some default preferred config. E.g., Move the Order closest to the market to this new Click location.

Other actions can be supported like click on a new cell to move an Order, click on an Order Cell to Cancel, Delete, Discard, or Remove the Order with minimal modifications by a person skilled in the art. The Grid is a multiple Orders displayed Grid so the Drag & Drop of Orders makes more sense but these other actions like Click on an Empty cell to place an Order there, click on an Order to discard the Order, and other click, right-click, and other inputs can be enabled if the user prefers to. So, the Drag & Drop of Orders to change Order Price is available and can be Enabled, disabled. Also click on an Order to cancel or delete it is available and can be Disabled. Disabled means click on an Order places a 2nd Order on the Cell.

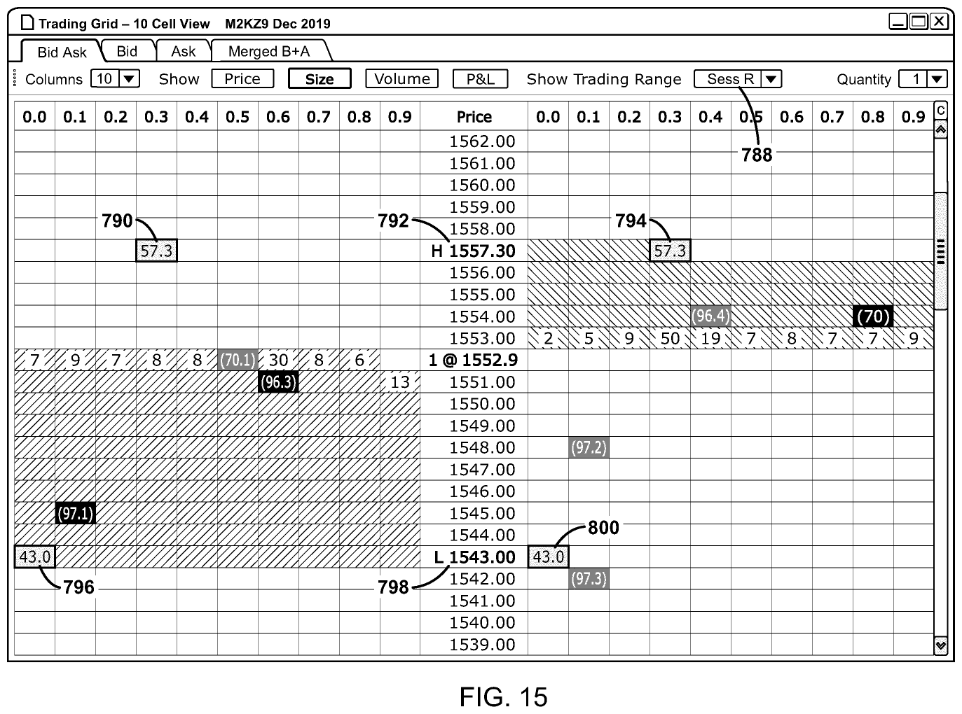

FIG. 15 shows a trading range on the Bid side grid, Ask side grid, and Price column.

The show trading range drop down 788 contain controls on showing different type of trading ranges. Not just trading range, but other range of values as well can be displayed. e.g., Bollinger band ranges.

The trading range displayed can be the current session trading range, a predictive range, historical ranges of the previous session or multiple sessions. An example of a predictive range is a linear regression on the Highs and Lows of a selected time period.

The Highs are shown by trading range high bid side grid cell 790, trading range high price axis cell 792, and trading range high ask side grid cell 794. The Lows are shown by trading range low bid side grid cell 796, trading range low price axis cell 798, trading range low ask side grid cell 800. The Highs and Lows may be displayed as price, colored cells, text labels, icons, or a combination.

A user may choose to display the actual high price and low price on the price column instead of the price column label as shown by trading range high price axis cell 792 and trading range low price axis cell 798. Trading range low price axis cell 798 just happened to have the same value as the Price row label.

Although the cells higher than the High cell and cells lower than the Low cell are not highlighted, their functions still remain the same, only the visuals are affected. The user may opt to attach special functions on these cells beyond the high cells and low cells. Since these cells may usually be far from trading activity and will take time to be filled, a user may opt to show a dialog to fine tune the order parameters and plan the order they want to place.

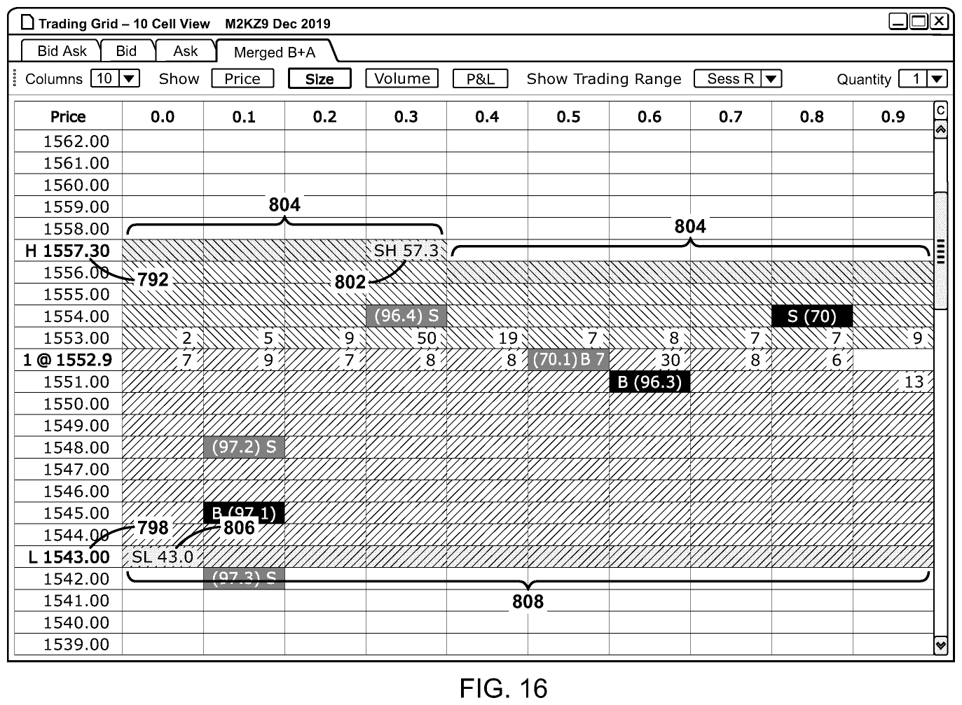

FIG. 16 shows another method to represent ranges on the grid in a different Merged Bid Ask side grid. Similar to FIG. 15, the high and low is shown on the price axis by trading range high price axis cell 792 and trading range low price axis cell 798.

The trading range high grid cell 802 shows the High price of the range, the wider cell width allows a display of a text indicator “SH” to denote session high aside from the session high's truncated price. On the other end, the trading range low grid cell 806 show the Low point of the range. The label “SL” is displayed to mean session low.

To aid in the visualization of the boundary of the session range, the trading range high boundary highlight 804 and trading range low boundary highlight 808 is can be seen on the grid in a different color scheme from the typical bid cells and ask cells.

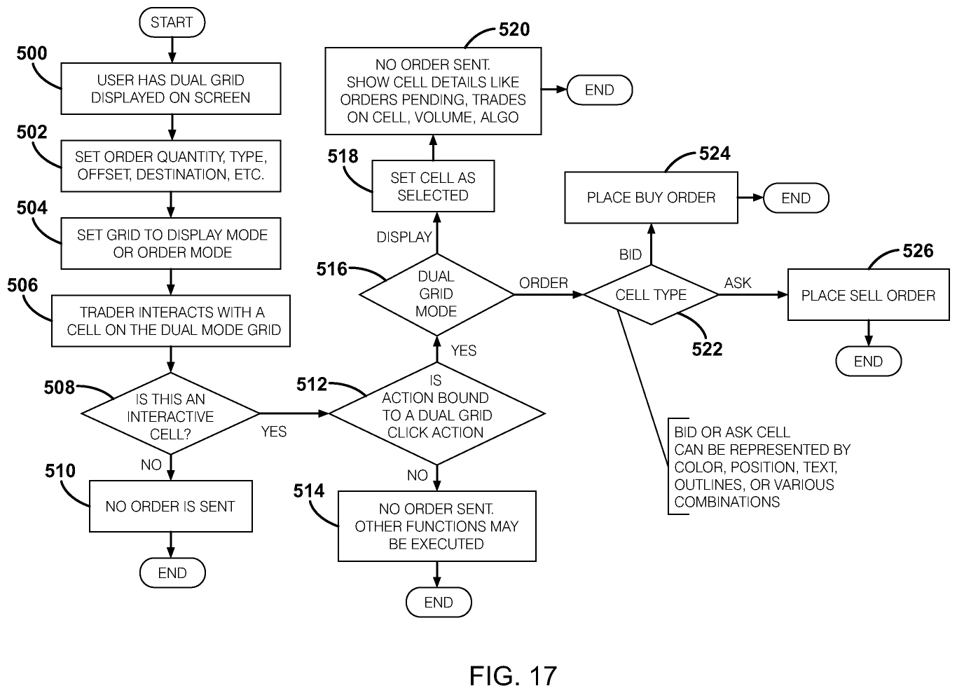

A process for placing orders using the Dual Mode Grid is shown in the flowchart of FIG. 17. Prior to placing an order, trader selects whether the Dual Mode Grid is in Order Mode or Cell Data Mode and also provide preliminary input relevant to placing an order such as the quantity to be traded, the account performing the trade, etc. Once all the necessary fields have been provided and the trader interacts with the Dual Mode Grid, the system will determine if the interaction performed by the trader is adequate to perform a trade. For example, a trader interacts with a cell on the Dual Mode Grid by using clicking on a cell in an attempt to place an order. The system will determine if the trader's interaction and the Dual Mode grid settings are valid for an order to be sent. The price of the order is determined by the associated value of cell where the user performed the click action. Aside from a click, an interaction maybe also be a tap, gesture, drag and drop, cursor movement, or key press over a cell on the Dual Mode Grid. Other interactions from other input devices may also be employed as long as the input can be assigned to a Dual Grid Mode action or command.

In step 500, the Dual Mode Grid is displayed to the user. In step 502, the relevant order parameters such as quantity, order type, offset, destination, and other order parameters are set by the user either manually or automatically thru a saved setting. In step 504, the user sets whether the Dual Mode Grid is set to Cell Data Mode or Order mode. In step 506, the trader interacts with a cell on the Dual Mode Grid thru a mouse click. In step 508, the system determines whether the clicked cell is an interactive cell e.g., a buy cell, a bid cell, a cell on either the bid column or ask column. If the clicked cell is not an interactive cell, then in step 510 no order is sent and the interaction is routed to other features which may want to handle the interaction. If the clicked cell is an interactive cell, then in step 512 the system determines whether the interaction is bound or assigned to a Dual Mode Grid Click action or command. If the interaction is not bound to the click action, then in step 514 no order is sent and the interaction is routed to other features that may handle the interaction. If the interaction is bound to a click action, then in step 516, the system determines whether the Dual Grid Mode is in Cell Data Mode or Order Mode. If Cell Data Mode then in step 518 the system sets the clicked cell as selected and/or highlighted as a visual indicator then in step 520, no order is sent and details associated with the cell may be displayed in another area of the UI, tooltip, window, or another device. Cell details may include but not limited to bid size, ask size, orders pending on the cell, trades on the cell, order history, volume on cell, algos started, stopped, pending on the cell, histogram. If Order Mode, then in step 522 the system determines whether the cell is a buy cell or a sell cell. If buy cell, then on step 524 a buy order is placed. If sell cell, then in step 526 a sell order is placed. As option, after step 524 or step 526, the system may further select and/or highlight the cell as in step 518 and show cell details.

The price of the buy order or sell order is determined by the price associated with the cell. Typically, the order is a Limit order but the user may change a preferred order type thru a setting. Different order types may also be determined thru key modifiers or by setting the interactions to a preferred order type e.g., a click may be assigned to a limit order and a right click maybe assigned to a stop order.

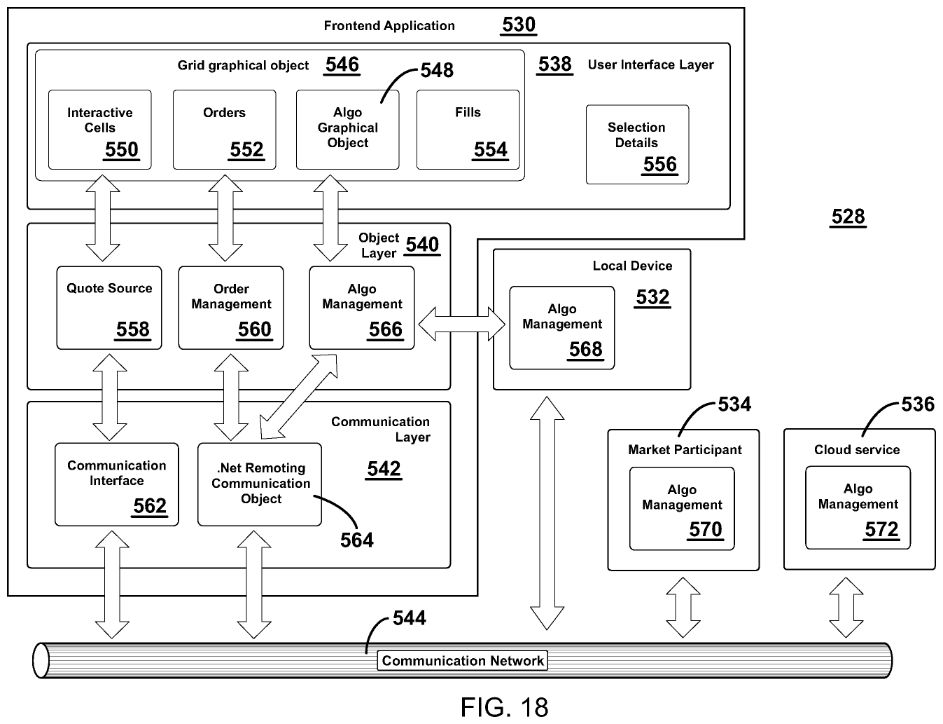

FIG. 18 shows the architecture of the system 528 which includes a Frontend Application 530, a Market Participant 534, an optional Local Device 532, and an optional Cloud service 536. Local Device 43 may be the same device where Frontend Application 530 is running from.

The Frontend Application 530 has a three-layer logical architecture, consisting of the user interface layer 538, an object layer 540, and a communication layer 542. This design gives the Frontend Application 530 the advantage of a clean, organized structure, wherein related software functions are grouped in independent layers, each layer communicating with the others using clearly defined programmatic interfaces.

The user interface layer 538 contains components that handle the graphics operations of the grid and other graphical objects. These include the construction of the grid; dynamic operations such as moving and highlighting the cells of the grid and showing the relevant details of the cell; and interactive operations like responding to user actions, e.g., adjusting number of columns displayed on the grid when the user changes a configuration on an appropriate graphical element (e.g., a toolbar textbox).

The object layer 540 groups together components that perform business logic, and components that implement utility functions. The components in this layer: (1) validate users' actions (performed on objects belonging to the user interface layer 538); (2) translate users' actions into commands—if applicable—to be sent to the back-end trading system via the communication layer 542; and (3) process return values, notification messages, or any other data sent by a Market Participant 534 or a Cloud Service 536 (through the communication layer 542), and/or a process in the Local device 532 which may or may not go thru the communication layer 542 depending on the implementation. The object layer 540 serves as an abstraction layer that shields the user interface layer 538 from the implementation of the lower-level communication layer 542.

The communication layer 542 consists of components that act as communication “gateways” between the front end and the backend trading system. This layer essentially translates programmatic requests (which are in the native format of the operating system and application platform of the front end) coming from the object layer. That translation may be into Simple Object Access Protocol (SOAP) messages, but any suitable option for facilitating communication may be chosen. It is to be noted that although SOAP maybe the primary protocol for Frontend Application 530, other suitable protocols—such as Winsock—can also be employed.

The communication layer 542 is designed to accommodate the “plug-and-play” addition and removal of communication components, each component implementing a specific type of communication protocol (e.g., Winsock, SOAP) for interfacing with a market participant 534, cloud service 536, or a local device 532. It will now be seen that the Frontend Application 530 is an important feature of the present invention, as it provides a graphically intuitive, fast, user-friendly application that any trader will use in order to view, edit, modify, start, stop, and manage algos and other algo related status, order, quote, predictive fills, and parameter information.

Typically, the Frontend Application 530 operates on a Windows platform, but not necessarily. Other platforms may also be employed including Linux, Android, and other proprietary platforms. Frontend Application 530 may also be made available platform independent by using cross platform technologies e.g., Java, Web Apps.

The Frontend Application 530 consists of a main executable program—which acts as the overall “controller” of the front end—and several software building blocks called “components” or “objects”. In a Microsoft Windows implementation of the front end, the main program is a Component Object Model (COM)-aware Win32 executable, and the software components are COM components. However, in an implementation of the front end for another operating system and application platform, the actual technologies used may be different, but the architecture will remain the same. COM allows the front end to organize functionality into multiple, independent, reusable software building blocks called “components” or “objects”. Although there is a difference between these two terms—a component is made up of one or more objects—the two terms are used interchangeably herein. Each of these components or objects encapsulates distinct software functionality, and interacts with other components through clearly defined programmatic interfaces.

The Frontend Application 530 is similar to conventional Microsoft Windows applications in that it adheres to the visual (e.g., menu structure, status bars, buttons, etc.) and behavioural (e.g., right-click behaviour, resize behaviour, etc.) standards for Windows-based applications. Thus, adherence to these standards by the front end of the present invention significantly eases the learning curve associated with mastering the application's features.

The front end's main executable program controls and manages the lifetimes of the application's various constituent objects—from object creation to object destruction. Furthermore, the main program coordinates the operation of the objects, by passing messages between itself and the objects.

The core of the front end however, is in the set of software objects implementing the bulk of the application's functionality. These software objects fall into two categories: (1) graphical objects, and (2) non-graphical objects. Both types of objects encapsulate software functionality, but the graphical objects also display a visual interface.

The software objects are grouped together, according to functionality, into “layers”. As noted above, there are three layers: (1) the user interface layer 538, (2) the object layer 540, and (3) the communication layer 542.

The most important software object is the grid graphical object 546. It displays Level II quotes in a two-dimensional matrix of multi-colored cells, which it constructs dynamically. The grid graphical object receives its data in real-time (or close to real-time) from a quote server (not shown) which resides on the market participant 534 like a broker or a market data provider; the data however, passes through the object layer 540 and the communication layer 542 first. The grid graphical object 54652 also implements the graphical placement and modification of algos using interactions like “drag-and-drop”, mouse button presses, keyboard inputs, screen taps, and gestures. The grid graphical object maybe is hosted inside a container object, to facilitate the easy grouping of multiple instances of the grid graphical object, discussed hereafter. The container object is a graphical user interface (GUI) element with the capability to “contain” other graphical objects. An example of a container object is a tab-based dialog object common in Microsoft Windows-based applications.

The algo graphical object 548 encapsulates the displayed and interactions to view, edit, modify, start, stop, and manage algos and other algo related status, orders, quotes, predictive fills, and parameter information. Examples of what data that can be displayed on the Algo graphical object 548 are algo status (running, stopped, error) fill price, fill count, P&L, next fill price, running duration, date, end date, location. Said data could be in the form of icons, animations, graphics, miniature charts, text, background, or border.

The algo graphical object 548 has a corresponding algo management object 566 which encapsulates logic necessary for interaction and display of an algo and its related data. An example of such interaction is the dragging and dropping of an algo cell which shows the next fill price to a different interactive cell. Such interaction could result on a command that moves the next fill price of the related algo to the price of the drop location. Such command would be communicated to the algo management object 566 to effect such changes, passing thru the .Net remoting communication object 564 and finally to the market participant 534 or a cloud service 536. Depending on the user's preference, the same drag and drop interaction could also result in the adjustment of the algo parameters instead of just changing the next fill price of the algo. Another example of an interaction is clicking on an algo cell, which may result in command that displays cell details on a selection details graphical object 556.

Cloud service may include various meanings such as a virtual machine on a server, it may be leased server space where the algo is running independently. Algos may also run on the broker's side if broker supported.

The algo management object 566 encapsulates logic necessary to consolidate, manipulate, and monitor the algos. Where the algo is run depends on the user and these locations may not be on the same machine as where the Frontend Application 530 is running Some examples of where an algo may be run are on the same device as where the Frontend Application 530 is running, a local device 532 on the user's location, on the site of the market participant 534, or on a cloud service 536 which includes leased server spaces, virtual machines, and private servers. These locations would have to have some form of algo management 568, 570, 572 and communicate their data to algo management 566 so that it can be displayed to the user thru algo graphical object 548.

The examples given for where an algo could be run may not always support manipulation and may only be available for monitoring. The data may also be not available in a uniform manner between algo management objects 568, 570, 572, as their implementations could vary. However, this should not be a problem so long as the algo management object 566 is able to scrape and consolidate data for the algo graphical object 548 so data can be displayed to the user. Interpretation of the user interactions may also depend on the configuration of algo management object 566 or another mediator object such that commands and manipulation from the user interface layer 538 can be sent to either local device 532, market participant 534, or a cloud service 536.

The data flow between algo management 566 and the other algo management objects 568, 570, 572 may be achieved several ways. One way that this could be done is algo management object 566 polls the other algo management objects 568, 570, 572 of their statuses, fill information, and other relevant data. Another way is thru a subscriber-publisher method where algo management 566 is notified of fills, errors, status as soon as they occur on the other algo management objects 568, 570, 572. Polling and subscription may be used in combination to provide a more accurate and reliable data.

The Algo UI controls on the Grid are a substitute for or complement Algo UI controls in the Algo code itself. E.g., If the Controls were not on the Grid, then the Start would still have an API connection to somewhere in the trading software or a third-party software. So, a Start at 1467.7 would be available as an input setting from somewhere in the trading system or a compatible third-party software. Now, that Start at 1467.7 would be on the Grid and the user can move the Control via Drag & Drop instead and the action would reflect the change in value of the setting to the value of the cell where the drop occurred. Other Algo controls such as Stopping the Algo on a certain Profit level or Loss level would have inputs in Pts or Dollars, and hence may not be suitable for a Grid where the cells represent a price or Tick value. A Grid can be configured for volume or Dollar gain, Dollar Loss.

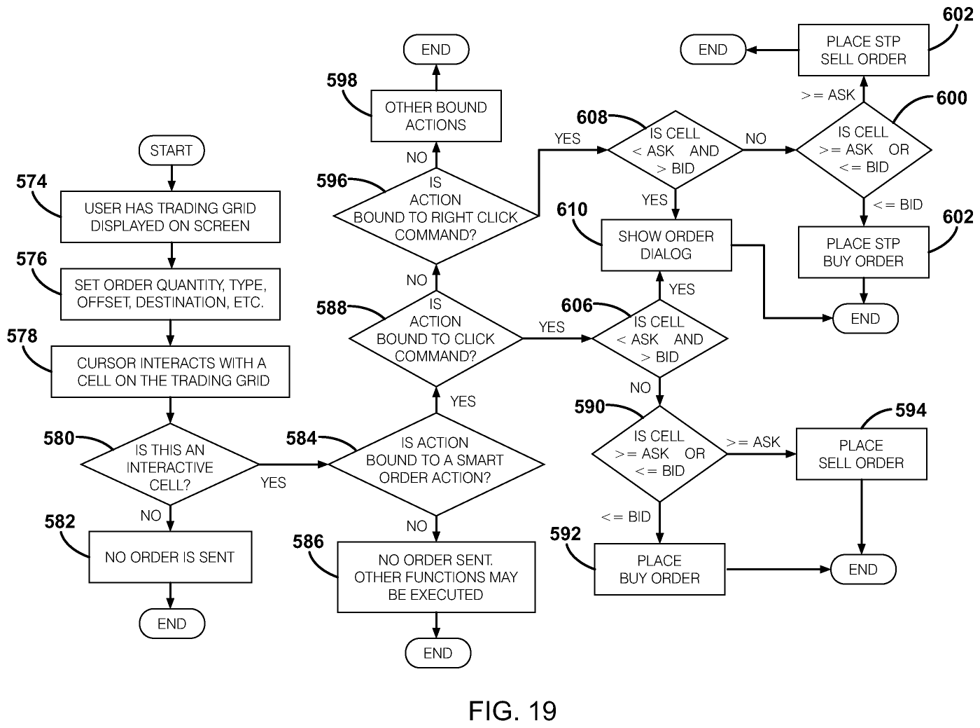

A process for orders using the Smart Order feature is shown in the flowchart of FIG. 19. Prior to placing an order, trader provides preliminary input relevant to placing an order such as the quantity to be traded, the account performing the trade, etc. Once all the necessary fields have been provided and the trader interacts with the grid, the system will determine if the interaction performed by the trader is adequate to perform a trade. For example, a trader interacts with a cell on the grid by clicking on a cell in an attempt to place an order. The system will determine if the trader's interaction and the grid settings are valid for an order to be sent. The price of the order is determined by the associated value of cell where the user performed the click action. Aside from a click, an interaction maybe also be a tap, gesture, drag and drop, cursor movement, or key press over a cell on the grid. Other interactions from other input devices may also be employed as long as the input can be assigned to a grid action or command. An interaction with the relation to the present invention is a combination of a user input and a selected or cursor pointed to an object e.g., clicking on a cell, right clicking on a cell, shift+clicking on a cell.

In step 574, the grid is displayed to the user. In step 576, the relevant order parameters such as quantity, order type, offset, destination, and other order parameters are set by the user either manually or automatically thru a saved setting. In step 578, the trader interacts with a cell on the grid thru a mouse click. In step 580, the system determines whether the clicked cell is an interactive cell e.g., a buy cell, a bid cell. If the clicked cell is not an interactive cell, then in step 582 no order is sent and the interaction is routed to other features which may want to handle the interaction. If the clicked cell is an interactive cell, then in step 584 the system determines whether the interaction is bound or assigned to a Smart Order action or command. If the interaction is not bound to the click action, then in step 586 no order is sent and the interaction is routed to other features that may handle the interaction. If the interaction is bound to a Smart Order action or command, then in step 588 the system determines if the action performed by the user is a click command. If the interaction is a click command, then in step 606 the system determines if the price of the cell is between the bid and ask by testing if the price of the cell is less than ask and greater than bid. In case of ambiguity, then in step 610 the systems show the order dialog to the user so the user can resolve the ambiguity. If in step 606 the price associated with the cell is not ambiguous, in step 590 the system determines if the cell's associated price is greater than or equal to the ask, or if the cell's associated price is less than or equal to the bid. If the cell's associated price is less than or equal to the bid, then in step 592 a buy order is placed. If the cell's associated price is greater than or equal to the ask, then in step 594 a sell order is placed. If in step 588 the system determines that the action performed by the user is a click command, then the system continues in step 596 where the system determines if the action performed is bound to a right click command. If the action performed is not bound to a right click command, then in step 598 the system determines if the there are other relevant interactions and is passed to other functions in the system that may handle the interaction. If the action performed by the user is bound to a right click command, then in step 608 the system determines if the price of the cell is ambiguous by testing if the price of the cell is less than ask and greater than bid. In case of ambiguity, then in step 610 the systems show the order dialog to the user so the user can resolve the ambiguity. If in step 608 the cell is not ambiguous, then in step 600 the system if the cell's associated price is greater than or equal to the ask, or if the cell's associated price is less than or equal to the bid. If the cell's associated price is less than or equal to the bid, then in step 604 a stop buy order is placed. If the cell's associated price is greater than or equal to the ask, then in step 602 a stop sell order is placed.

The price of the buy order or sell order is determined by the price associated with the cell. Typically, the order is a Limit order but the user may change a preferred order type thru a setting. Different order types may also be determined thru key modifiers or by setting the interactions to a preferred order type e.g., a click may be assigned to a limit order and a right click maybe assigned to a stop order.

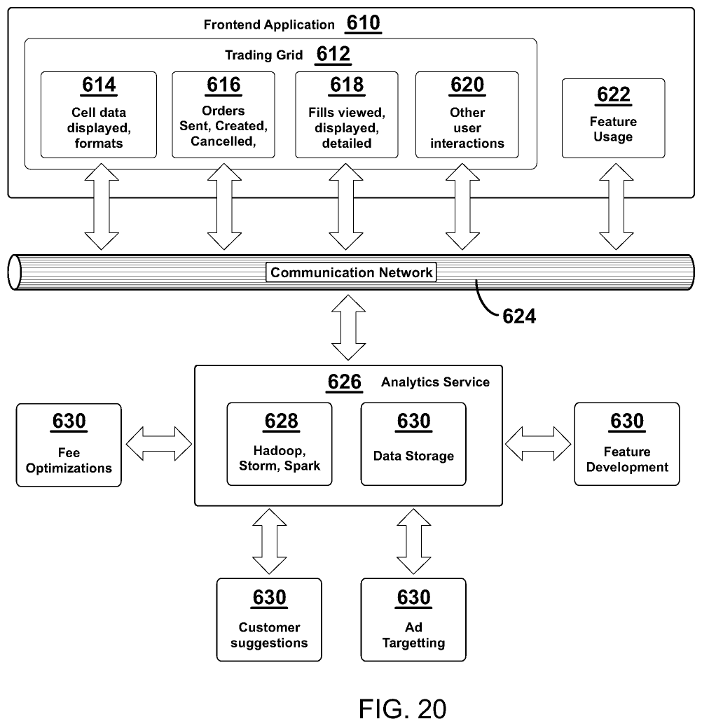

FIG. 20 shows the architecture of the system 528 which includes a Frontend Application 530 and an Analytics service 626.

The Frontend Application 530 includes various trackers that communicate with the Analytics service 626 over a communication network 544 which is typically the internet. Trackers that are concerned with the usage of the Trading Grid 612 and other feature usage 622 send data over the to the Analytics service 626 for processing by frameworks like Hadoop, Storm, or Spark 628 and/or for storage to a Data Storage 630. A component that acts as in between the various trackers to manage traffic, fault handling, and general communications with the Analytics service 626 may be present on Frontend Application 530.

Several types of trackers are included in the Frontend Application 530. The general usage of the Frontend Application 530 and its other features that is not on the Trading Grid 612 is handled by the tracker other feature usage 622. An example of the other feature usage 622 includes the viewing and editing of the Frontend application 530's settings and the values entered by the user on various configuration items, which can be used for contextual suggestions on the Frontend Application 530. Cell data displayed, formats 614 may track how the user prefers various data are displayed and how a user interacts with the Trading Grid 612's cells. Tracking the orders placed on the Trading Grid 612, order type, order action, and how often an order is moved, changed, or modified in price, quantity, etc. may be tracked thru a component Orders sent, created, cancelled 616 which could help in determining how to monetize the system 528. Tracking may be done on side of Frontend application 530 and/or on the market participant's side. Another aspect that may help in the monetization of the system 528 is tracking the number of open and close fills and the fills view, displayed, and detailed 618.

Monetization of the system 528 can be the usage based on per trade made on the Trading Grid 612. e.g., charge $0.05 to $0.10 per Trade on a per use basis. The number of orders is placed on the Trading Grid 612, modified on the Grid could also get a charge, e.g. $0.01 or $0.02 per move, per working Order. Child Orders, STP Orders could also be charged a Fee. Parent Orders, i.e., the working Order, would carry a higher Fee. The entire Parent, Child order chain, the entire Bracket Order or Profit Taker, STP Pair would have a fee basis associated with it as one approach to monetization. If the Trading Grid 612 is never used, the client or is charged only a minimal Fixed Fee per month. Algo controls on the Trading Grid 612 may also be charged a per use Fee and usage are automatically sent to the Backend or the Backend Queries, Polls those statistics from each Grid user from Time to Time.

Some of the outputs of the Analytics service 626 are strategies for fee optimizations 632, an engine for customer suggestions 634, and ad targeting 636. Feature development 638 can also be an output of the analytics service 626 by analyzing which features make money or lose money for the user. Developing and/or promoting unused features of the Frontend Application 530 may result from analytics server 626.

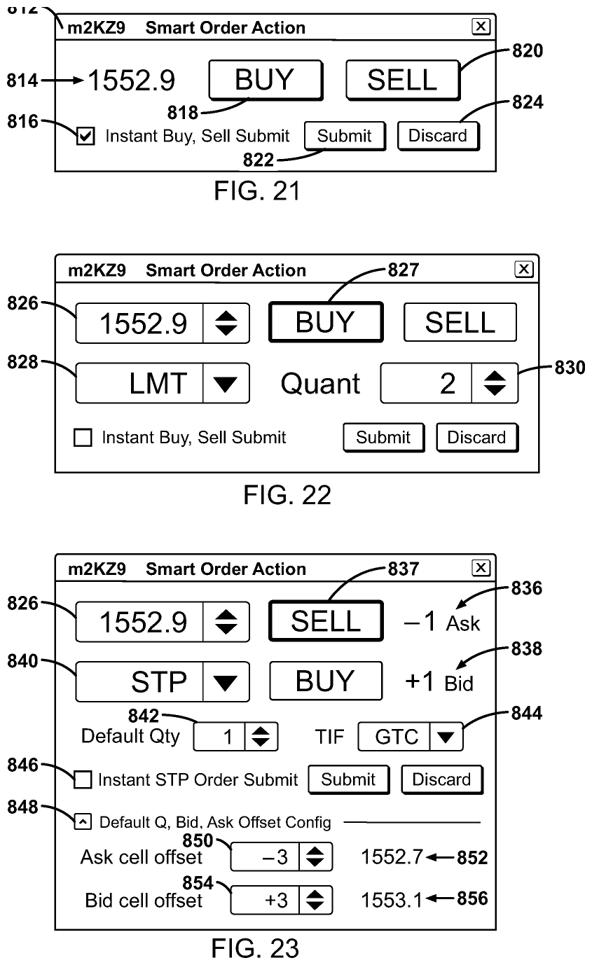

FIGS. 21 to 23 shows the Smart Order Action dialogs which help the user resolve conflicts in determining the order parameters in response to interaction with the Bid Ask cells of the grid. When the system cannot determine whether the user wants a buy order or sell order, the Smart Order Action dialogs allows the user to tell the system what the proper Order action is. Aside from resolving conflicts, the Smart Order Action dialogs also allow the trader to place/modify orders with more control.

If the Order intention is submitted, for example using the Smart Order Action Dialog Box or using a Bid, Ask, Last Offset, then the Instant Fill Protection feature will prevent the Order from being instantly filled if the Market Bid, Ask, last move at the instant the Order is submitted. Protection can be specified in Point units or in Tick increments away from the Market if necessary. The Instant Fill Protection is only needed or in force when the system detects that the Order as submitted will result in an instant Fill. It can be used with LMT Orders but can also work with Market Orders to prevent an instant Fill. If the user wants an instant fill, they can still drag the Order closer to the market's Bid, Ask, or Last price.

Instant fill protection can also be in the form of a warning dialog box. The trader can be shown a dialog box that would confirm his intentions that such action would result in an instant fill. Warning could be shown in a Red bar, e.g., Yellow Text, indicating Instant Fill. However, this feature is a Click protection, it is meant to move the Order after the Submit Order action is done, best as a backend function but it can also be done locally on the user's device with some drawbacks. Instant fill protection will move the Order away from the instant Fill price (user inputs number of Ticks away as the default).

So, the Feature can protect before the Submit Button is pressed, after (if the market moves in that 1 second before exchange gets the Order), etc. Even on a Market Order, which means likely Market Order Fill price and the Tick value away from such a likely instant Fill. It is meant to cover the 0-1 second from when the Submit Order is pressed to when the LMT Order registers at the Exchange. The user placed their Order a certain distance from the Bid, Ask and if the Bid, Ask change as the Submit Order is sent, a 1-2 Ticks of fast safety can still be had.

For example, if the user saw the move in Bid, Ask prices before they pressed the Submit Button, they would have maintained the Offset of the Order Submit from the Bid, Ask values. he bid, ask price moves just as the Order was submitted, either the Order is adjusted or the user is given a Dialog to confirm (Price Axis re-centered gives the Dialog).

FIG. 21 shows the most basic Order Action Dialog which only provides the user with a Buy button and a Sell button to resolve a conflict.

The order symbol is shown on the title bar 812 which indicates the security the order is created for. The price label 814 shows the price associated with the cell clicked. The price shown will be the price of the order if the user chooses to click the submit button 822. It will also be the price shown for buy button 818, or sell button 820. Buy button 818 and sell button 820 are toggle buttons, enabling one button disables the other.

Clicking the submit button 822 sends the toggled button order to the backend. Checking Instant Buy, Sell Submit checkbox 816 modifies the behaviour of the buy button 818 and sell button 820 making them a combination of setting if an order is a buy or sell and at submitting the order like similar to the submit button 822.

Discard button 824 closes the Smart Order Action dialog and no order is submitted.

FIG. 22 is an improved version of FIG. 21 where the user can change the price of an order using price spinner 826. Price spinners support changing the price thru keyboard input, adjustments thru a scroll wheel, drag and drop.

Order type combo box 828 allow the user to change an order from limit order to other order types. Quantity spinner 830 allows the user to change quantity of an order. Selected buy toggle button 827 is indicated by a thicker border and represents what order action will be submitted. A button may be preselected if the dialog is opened as a result of a correct context. e.g., A buy button may be preselected if a bid size cell is selected prior to opening the Smart Order Action dialog.

FIG. 23 shows a Smart Order Action which show additional controls to change the order parameters like TIF of the order, offset config, and distance to bid/ask. Other order parameters that are rarely changed by the user can also be shown on this dialog and grouped in a collapsible container so these can be hidden when the trader does not intend to modify them.

Distance to ask label 836 shows the distance of the last trade price from an order's price indicated at price spinner 826. Distance to bid label 838 shows the distance of the last trade price from an order's price indicated at price spinner 826.

Order type combo box 840 shows a ‘STP’ order type, FIG. 22 shows ‘LMT’ in order type combo box 828. The default quantity spinner 842 facilitates changing the default quantity of an order. TIF combo box 844 allow the user to change the Time in force parameter of an order.

Instant STP order submit checkbox 846 changes the behavior of the buy and sell buttons. If either are pressed, an order is submitted using the settings shown provided they are valid.

Default Q, Bid, Ask Offset Config collapsible panel 848 show configuration for additional order parameters.

Ask cell offset spinner 850 allows the user to configure how many cells from the Best Ask cell the system should consider as a Sell Order. An input of −−3 means that A click on the 1 to 3 cells below the Best Ask will be interpreted by the system as Sell order even the cell is a Bid cell. The price of the cell as result of the offset is shown by Ask cell offset resolved value 852. A click on a cell with the price or above the price indicated by Ask cell offset resolved value 852 will be considered by the system as a Sell order.

Similarly, Bid cell offset spinner 854 allows the user to configure how many cells form the Best Bid cell the system should consider as a Buy Order. An input of +3 means that a click on the 1 to 3 cells above the Best Bid will be interpreted by the system as a Sell Order even if the clicked cell is an Ask cell. The price of the cell as a result of the offset is shown by Bid cell offset resolved value 856. A click on a cell with the price or below the price indicated by Bid cell offset resolved value 852 will be considered by the system as a Buy order.

FIG. 1 could be modified in code to accept such an Offset scheme without looking much different than the current Prior Art FIG. 1.

Selected sell toggle button 837 is indicated by a thicker button border and in combination with order type combo box 840 means a Stop Sell order will be sent to the backend if the Submit button is clicked.

Users may customize the content of collapsible panels moving less accessed items into the collapsible panel while moving more frequently accessed items out of the collapsible panels.

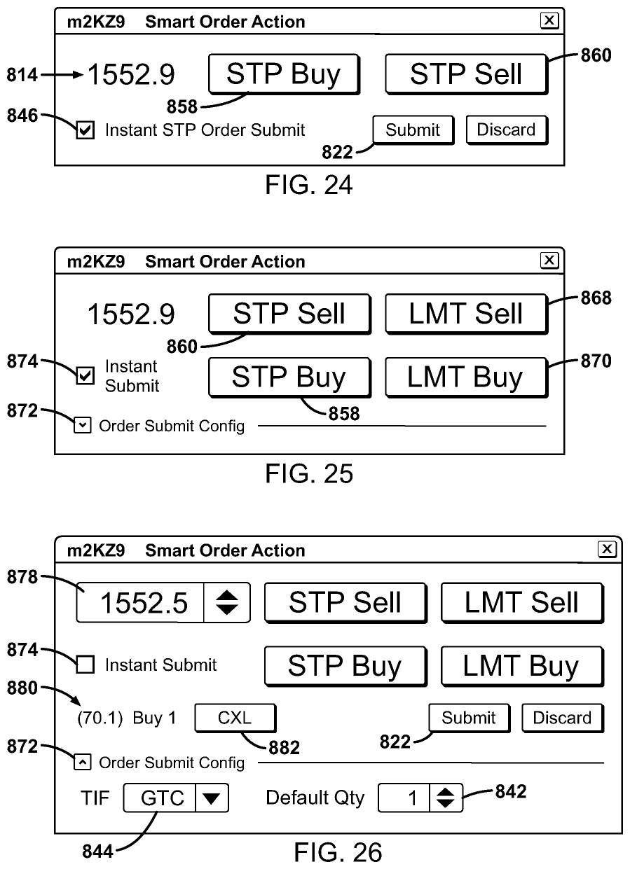

FIGS. 24 to 26 show variations of FIGS. 21 to 23 where STP order buttons are shown.

FIG. 24 is a variation of FIG. 21 where stop sell button 860 and stop sell button 860 are shown.

User clicks on either stop sell button 860 or sell button 860 to set the type of order to be sent to the back-end when the submit button 822 is clicked. The price of the sent order is determined by price label 814. Enabling instant STP order submit checkbox 846 modifies the behavior of the stop sell button 860 and stop sell button 860. When either is clicked, an order will be sent instead of just setting the order action to STP Buy or STP Sell.

FIG. 25 is a variation of FIG. 24 that have limit sell button 868 and limit buy button 870 in addition to the stop buy button 858 and stop sell button 860. Also, Order Submit Config collapsible panel 848 can be seen in a collapsed. Additional order parameters can be configured in the Order Submit Config collapsible panel 872.

User only need to clicks on one of the four buttons 858, 860, 868, and 870 to send an order to the back-end since instant order submit checkbox 874 modifies the functionality of stop buy button 858, stop sell button 860, limit sell button 868, and limit buy button 870. In addition to choosing the order type, an order will be sent to the back-end and the dialog will close when a user click on one of the four buttons 858, 860, 868, and 870. The order type is shown by the buttons label.

Some delay may be utilized before closing the dialog so the user can see which button they clicked. The feature can be helpful in a fast-moving market where the trading could have moved out of view before the user can decide on what order to submit and its parameters.

FIG. 26 is a variation of FIG. 25 which show additional controls that allow the user to configure the price of the order to be submitted. Controls on how a user can cancel an order found in the clicked cell can also be seen. Also, the controls of the expanded Order Submit Config collapsible panel 872 is shown.

Instant order submit checkbox 874 is unchecked so the order type action buttons will function as a toggle button, enabling one disables all the others. Only one button can be toggled selected at a time and the Submit button 822 is required to be clicked after configuring the order parameters for an order to be sent to the backend.

Orders on cell label 880 show the price, order id, and quantity of the order present in the cell associated with the price shown on the price spinner 878. Order parameters shown can be configured. The cancel order button 882 can be used to cancel the order.

The Order Submit Config collapsible panel 848 contain other order parameters such as default quantity spinner 842 and TIF combo box 844. Order parameters such as Destination exchange, etc. can be added or removed in the panel.

Aside from resolving order action conflicts, the dialogs of FIGS. 21-26 can also be used as manual order entry tool. The order price combo box will be seeded based on the which cell the user clicked and the other order parameters will be set by the user on a smart order action dialog box. The order price can be edited manually if necessary

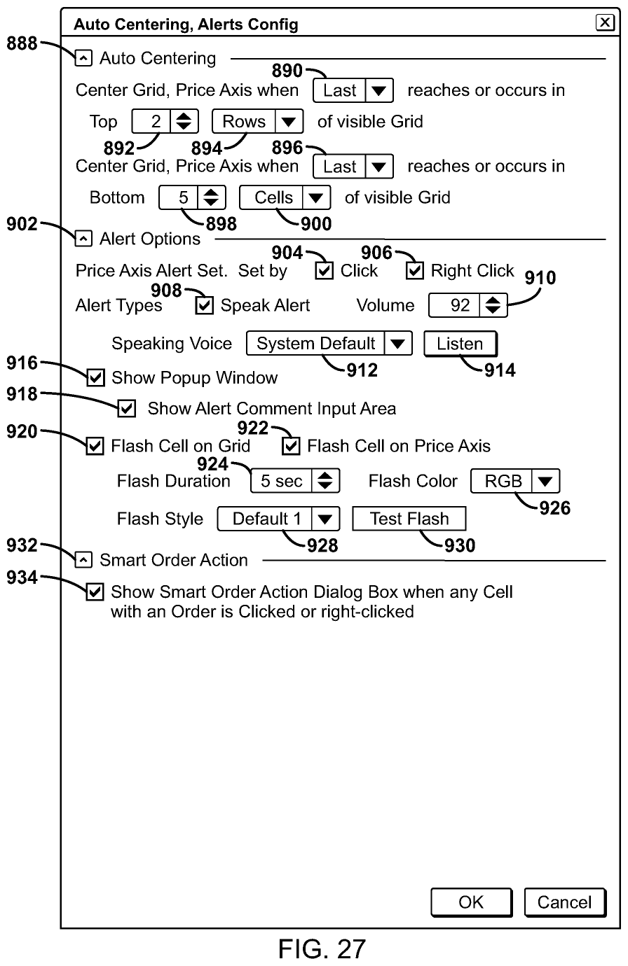

FIG. 27 show Auto centering options, Alert options, and Smart order action settings.

When some conditions are met, the Auto Centering feature will center the trading activity on the grid. The Auto Centering feature keeps the trading activity always visible to the trader. The settings that trigger the Auto Centering feature can be found on the Auto Centering collapsible panel 888.

The combination of trigger combo box 890, count spinner 892, and unit combo box 894 define how the auto centering feature triggers when trading activity approaches the top cells of the grid (i.e., cells associated with a higher price). The combination of trigger combo box 896, count spinner 898, and unit combo box 900 define how the auto centering function behave when trading activity approaches the top cells of the grid (i.e., cells associated with a lower price).

Any number from one can be put in the count spinner 892 and 898. Other than Last, other options include bid price, ask price, bid-ask midpoint and other suitable values that can be used as reference to where the trading activity is.

Other than Rows, and cells, Columns may also show as option if the grid is in horizontal view. The system checks if the inputs are valid and will show a dialog or warning if the user have input a wrong setting.

The Alerts feature allows the system to notify the user when a certain event occurs. One type of alert that the user can create is when a trade occurs at a certain price. Some of the ways that Alerts can be conveyed to the user is with a visual indicator such as a flash, temporary color change, and popups. Audio cues such as beeps and other sounds can also be used.

An alert can be spoken thru Text-to-speech technology/voice synthesizer or pre-recorded audio files. Aside from the price, custom messages may be attached and spoken to each alert. The user can input such alerts as instructions for themselves or as general reminders. Voice synthesizer alerts can convey more information to the user.

The voice synthesizer can also be dynamic and read aloud for the user market data when an alert is triggered. Some examples of Market data include Last, Best Bid, Best Ask, Best Bid quantity, Best buy quantity, volume, Session Change, Session Change, value of an indicator and its name, market data and indicator values of other securities and indices. How these voice alerts.

When a user is sleeping or away from the trading screens, alerts can also be sent to devices such as cellphones, smart watches, smart TV, other wearable devices in the form of emails, SMS, calls, messages to third party apps like Facebook, Twitter, etc. The alerts can be set to repeat a number of times or until the user chooses to stop the alert.

Alerts can be a combination of any of the above-mentioned methods.

Alert options collapsible panel 902 show configuration on how Alerts behave, look, and sound. Enabling the click checkbox 904 and/or the right click checkbox 906 allows creation of alerts by interacting with the price axis.

User may choose to hear the alert by enabling the speak alert checkbox 908 and control the loudness by volume spinner 910. The speaking voice combo box 912 allows the user to change the voice if there are multiple text to speech voices installed on the system and the listen button 914 allows the user to hear a preview of the voice selected.

User may also opt to see a window containing the alert by enabling Show Popup Window checkbox 916 for better visibility. Additionally, Show Alert Comment Input Area checkbox 918 can be enabled to also show the user any comment or custom messages of the alert.

The Flash Cell on Grid checkbox 920 allows the user to see an alert flash on the grid and the Flash Cell on Price Axis checkbox 922 allows the user to see an alert flash on the price axis. Both options can be enabled at the same time.

Flash Duration spinner 924 sets how long the flash appear on the grid and/or price axis. Flash color combo box 926 and Flash Style combo box 928 allow the user to change the color and style of the flash. Test Flash preview box 930 shows a preview of the flash. Flash styles examples are Flash once, fast, slow, gradient, glow, cell border only, cell background only.

Alerts may be one cell or multiple cells, column, or row.

Alerts may be stopped before it's finished by clicking, multiple clicks, click and hold.

The Smart Order Action dialogs can also be used to edit an order on the grid that have not been filled. Smart Order Action collapsible panel 932 contain options for the Smart Order action feature. The user may enable checkbox 934 to show a dialog box when a cell with an order is clicked. This alters the default behavior of click to cancel which maybe.

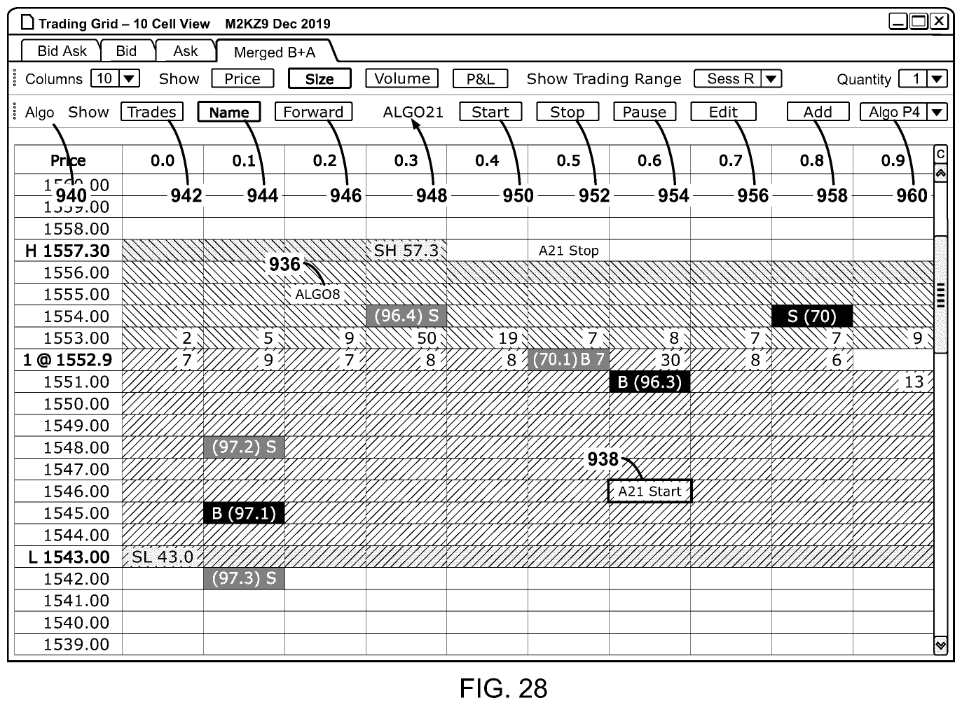

FIG. 28 show how Algo status cells can be displayed on the grid. Also shown is an Algo toolbar 940 which allow the user to manage Algos.

Algo cell 936 and selected algo cell 938 are Algo cells. Selected algo cell 938 is represented by the thicker border. When an Algo cell is selected, some functions on the Algo toolbar 940 will be specific to the selected Algo cell which otherwise may not function without a selected cell.

Algo Start and Stop events can be thought of as a Touch a Cell Price Events. The Start and Stop Algo controls can be Drag and Dropped to a cell to trigger a start or stop event when that cell is touched. A cell can also be clicked to set the Algo Start or Algo Stop event. The cell can display “Start A1”, “Stop A1”, etc., to show the user that there are algo events associated with the cell. Such Algo Controls (Start, Stop, Pause, Resume) may also appear on a Chart (interactive chart or a more passive, presentation chart) as Horizontal, Vertical, or Sloped Algo Control lines of continuous validity (Good till cancelled) or a validity of the Algo Action within the Slope Time Duration and Slope Price Range.

When an Algo is running, the Algo's pending or working Open, Close, Buy, Sell Orders and LMT prices can be reflected on the Grid. The Algo's Open & Close Fills can also be shown visually on the Grid for a short period of time and then disappear. The next set of Algo Orders will then populate the Grid so there is a visual idea of where the Algo's pending or working orders are. This means the user can manually move such pending or working Open, Close, Buy, Sell Orders, STP Orders, child orders, if allowed or permitted by the Algo design. In this way, the user can interact with the Algo and Algo orders without crashing the Algo. If the user cannot change the Algo's orders in such a direct way on the Grid, then the Algo Orders can be shown on the Grid, but are not interactive for drag & drop, modification, or cancel purposes.

An algo could go as far as showing parent-child orders, bracket orders, profit take, loss take orders, etc. The user would choose how many forward orders are shown on the Grid, depending on how much future parent & child order clutter they can accept or wish to see. This is similar to a Chess playing algorithm where the user is allowed to see on the chess board what moves the Chess playing algorithm would perform in turn for each Chess piece the challenger moves. Not every Algo would allow the user to change the LMT Price or Order Terms of the next Algo Order or some future Algo Order. Ordinarily, this would crash the Algo so the Algo has to be designed to allow such interaction. It is helpful in the sense that if there is bearish market news, the user can drop the LMT Prices on any working Orders. Bullish news, they can raise the Algo Sell, Close prices and not crash the Algo. How many Algo Orders or Algo Child Orders are shown on the Grid can be configured as an input value to represent the number of layers or forward-looking order levels. The next 1 or 2 Child Orders maybe plenty for Buy Order Actions, for Sell Order Actions, or for Open Order, Close Order Actions. Allowing the trader to see the next few Open, Close, Buy, Sell Orders, or other Algo actions may also help the user remember the Algo Rules so they can be Edited in the Algo Config Settings or Algo code if the need arises. Such edits can be done to improve the Algo quality or make the Algo run more efficiently.

GUI Object Order Icons can be placed in the regular grid cells for Buy, Sell, STP Orders, parent & child orders, etc. These Order Icons are more standard and not related to the Algo controls above.

If there are more than 3 Order Icons or any type of Icon per Cell, it is likely that the cell width won't fit them and several choices are available to be taken: i) Make the Icons smaller in size; ii) go to double height or extra wide width on the cell which contains the multiple Icons; or iii) display 1, 2 Icons and in the 3rd Icon spot, just show the number of Orders or Icons not shown as a Text label, e.g. “(3)”, and when the user clicks on the “(3)” Label, they see a cell pop-out near the cell showing all the missing Icons or all the Icons and the user can drag & drop or interact from the Icon pop-out box to a new cell location, or cancel, and edit the orders or Icons. This is an alternative to the Cell Data Table or Cell Data mode ways of how to manage multiple Orders in a single cell and the Algo controls present.

Multiple Order Icons can exist in a Single Cell while the icons can be dragged & Dropped and interacted individually or as a group to a new cell location. Some other examples that can be performed when 1 more Order Icons are present on a cell are click to cancel, remove each Icon on a cell or by accessing the same Order in the Cell Data Table, Cell Data mode, etc.

Technical indicators can be used to link Algo Start and Stop functionality. For example, the 50 DMA Indicator can be shown in a Cell and when Touched, can also Start tor Stop an Algo. Each Algo would also have a Direction preference, Long, Short, Etc. so we know of the 1st Algo Trade will be Long, will be Short, or a Mix, depending on the Algo design objective, code.

Ideally, the Technical Indicators resolve to a price such as the 50, 100, or 200 DMA, but it can also be a non-price Technical indicator such as an RSI set at a specific value. When the value is reached or touched, it would be the Price where the Event was Triggered, and the Algo can Start or Stop. A user can place the Start or Stop Event on the Grid at the estimated Start, Stop Price or even after the fact, once the Algo has Started or Stopped. Such an indication can persist, be removed, or hidden by the user if it becomes annoying or becomes a distraction. If an Algo is running and providing info to the Grid, an Info Row can be displayed showing the Algo Name, number of Trades, P&L, run Duration, etc. Even Start Time, Date, and Algo objective can be seen with a mouse-over on an Algo “i” Icon along the Algo Info, Data Row Toolbar.

Mapping to the grid can defined by Algo start price, Algo close order price, Algo next order price, Algo previous fill price, Algo end price.

Algo toolbar 940 contains functionalities that concern with interacting and management of algos displayed on the grid. Selected Algo cell 938 Algo id (alias, nickname, custom name) is shown on the Algo toolbar 940 by selected Algo cell name 948. Pressing the Start Algo button 950. Stop Algo button 952, Pause Algo button 954, or Edit algo button 956 will affect ‘ALGO21’. The Edit Algo button 956 may show a dialog containing the editable Algo properties.

One or more Algo Control Buttons can reside or be placed in a single Cell of the Grid. The Button(s) or Algo controls may be static, specific to a given cell, or drag & droppable and can be to be moved to a new or different cell location. Such buttons are used for Starting or Stopping a specific Algo, or have “Start Algo on Touch”, “Stop Algo on Touch” functionality. The Algo Control Buttons are GUI Objects in the cell and can exist near or adjacent to other GUI Objects such as Order GUI Objects, Text Labels in the same cell. Pressing such Algo control buttons would not remove the button like pressing an Order button would remove the Order Icon & discard or cancel the Order. Some Algo Control buttons, whether present inside a specific cell or on the Algo Toolbar may calculate or re-calculate a value manually. i.e., some intermediate Algo metric or update of Algo statistics & performance.

An example of an intermediate Algo control button is the Algo's STP Loss, or STP Buy Cell location. If the user doesn't like the Algo's suggested location, the user can move the location to a new cell or new price. This can be done while the Algo is running, in real time, without pausing the Algo necessarily.

Although these ideas control the running of the Algo, they don't control what to do with the positions or holdings +Q, −Q accumulated during the Algo Run. Hence, the user can be given Algo Cells for Close all +Q, cover all −Q, STP +Q, STP −Q, STP Buys, STP Sells of 1 or more +Q, −Q while the Algo is Running. i.e., Pausing Algo when the market is selling off may not be practical, it may be more ideal for the Algo to effect a STP Loss, the Price and placement of which is shown on the Grid and can be changed by a new Price Input, Trim input, or Drag & Drop of the Algo STP control on the Grid. Similarly, the user can opt to use an Algo Profit Take and a Higher Cell Price, Algos which show their Bracket orders, Profit Take, STP Loss, STP Buy, STP Sell Orders and other types of automated Parent Orders, Child Orders on the Grid. Such Algo Control cells can be interactive on the Grid or Passive and only for presentation, display.

ALGO Control Cells for Profit Take Actions, Stop Loss Actions, Stop Buy Actions, and other Algo Quantity Control Cells shown, presented, or placed on the Grid can be interactive Controls or passive indications of such Algo controls. Each of these Cells representing Algo actions would also have a Tab in the Algo Control or Algo Configuration window or frame. It should be noted that a Profit Take Cell, STP BUY Cell, STP SELL Cell can Close all Accumulated +Q, −Q Holdings automatically via the Algo settings at a Set Price. However, such Algo Actions and their associated Cells can also just Trigger the Close +Q, −Q or Open +Q, −Q actions in a more gradual, time delayed manner. So, the Profit Take, STP Buy, STP Sell actions begin an Algo process of taking profits on existing holdings, taking a STP Loss on existing holdings, or STP Buy to open Holdings or close Short position holdings. +Q means Long Holdings, and −Q means Short Holdings.

A user can use a class of Algo Control Cells on the Grid which are specific to Triggering the Start of Algo Actions which accumulate more quantity holdings or reduce such quantity holdings for the Long side Algo, the Short side Algo, or a mixed Long Short Algo. Multiple different Algos or Algo Types can operate on a common Grid if they are acting on a common Grid security. If the Algo is trading a basket of different securities, each specific security's Grid can show that portion of the Algo Control Cell.

In general, there are at least 4, but not limited to, sets of Algo Controls that can be made available on the Grid: i) Basic Algo Controls consisting of Start, Stop, Pause, Resume controls; ii) Algo Price Controls which can be set and Drag & Drop modified to a new Price Cell later as necessary; iii) Algo Quantity Controls which determine when an Algo Starts to Take Profits on its Holdings, starts to Take Losses, starts to accumulate more holdings or reduce holdings; iv) Algo Control Cells which inform the Algo at which price to start to CXL such Open, Pending, Working, or Child Orders. The Trigger Event is usually a Price Touch Event on the Grid but can also be based on Price Range, Price Velocity, Volume over a given Time interval, etc. More Technical controls based on DMA or Technical indicators, Pivot Points, a derived or calculated value of a combination of market data values, 3rd-party plug-in values, can be set on the Grid or in the Algo Configuration settings directly.

Open Orders implies working Orders, not yet Filled. Holdings imply Quantity actually Opened by the Algo or by the user but under Algo control for the duration of the Algo run. It is important to note that the controls not necessarily close all Open, Pending, Working, or Child Orders at once. The controls may just be starting the process of making the Algo less active, e.g., when Losses get too high, or it's time to Profit Take the Holdings. The Algo code can become more conservative on the Open +Q, −Q side, and start to reduce Actual +Q, −Q Holdings. Where this happens can be an Algo Control Cell on the Grid, so the wind down phase, wind up phase of the Algo has Algo Control Cells on the Grid. This would of course be for more complex Algos with sub-Controls, start Triggers, associated with a Price and referenced or accessible, modified, changeable on the Grid.

If there are too many Algo Control Cells on a Grid, the user may get a Mouse-over description to remind the user the function of each Algo Control Cell so they don't get confused. This also makes the 10, 20, 25 Cell column wide Grids give the user incredible utility so the user can see a 1 week to 1 month range and know where some key Algo Control Cells are on a larger display. Basically, the user sees the Status of the complex Algo by seeing which Algo Control cells are Active (e.g., a visible color or border) and which are dormant (e.g., greyed color or border) while the Algo works over days, weeks, or months continuously.

The Algo may exist as a separate entity or plug-in, Add-on and so it has its own Dashboard and config controls. There could be thousands of Algos for a user to choose from, each having specific goals and specific Algo Control Cells which could be configured to show on the Grid for a particular symbol or for the specific Algo while it is running or enabled to run on short notice.

An Algo control Icon can exist in the same cell as a user's Order Icon and both can be interacted with, moved to a new cell location, new cell price. An Algo's On, Off, Start on Price Touch, Stop on Price Touch events can be circle, square, hex Icon on a Cell. There is enough room in the Cell to show other Icons or Text (such as the Cell Price Label) adjacent to the Algo Icons or Algo controls The Algo Icons can have distinct colors and shapes so they are not confused with the user's Order Icons. The Algo Control can have a Algo ID label on or in the Icon, and if there is no room, we can show the Algo ID, name, and other Algo details as a mouseover box on the Algo Icon, Algo GUI Object in the Cell.

A dedicated Algo Tab will allow a user to Hide the Algo Control Icons shown on the Grid. Algo controls and changes can be done in the Algo Tab. Unlike an Order Icon, clicking on an Algo Icon or Algo control will not necessarily remove, cancel, or delete it. Clicking on the Algo Icon may result in a pop-up Algo configuration settings or dialog box, or take the user to the Algo Tab instead, especially if the Algo Icon is not drag & droppable to a new Cell location, cell price.

Algo button mapping such that when an Algo Icon is clicked, right-clicked, or mouse-overed, the associated Algo can give some Algo info verbally via speech audio and other interactive functions that can convey information to the user such as display to a mobile device. For example, mouseover on a specific Algo control can speak the Algo control, e.g., “Algo Stop” “Algo Pause” “Algo Start”, if the Algo design supports such speech functionality. The text pop-up on mouseover can be disabled.

Show name toggle 944 displays Algo names on the grid. Show trades toggle 942 makes the Algo trades visible on the grid. Trades shown on the grid can persist depending on the user's preference or be transient and just be displayed for a limited amount of time, e.g., 15 seconds. During this displayed period, aside from displaying the Algo name, the text on the cell could be displayed cyclically and display the trade that occurred, the price, etc, then stop and go back to just showing the name after the time period lapsed. Show forward toggle 946 when enabled shows the existing algo orders or forward looking orders that an algo may execute and send to the backend.

Algos may be managing or is associated with multiple orders at the same time. User may choose to show all orders or show only the Algo orders that are close to the last trade price, or bid price, ask price. How many Algo orders to be shown can also be configured. User may also choose to filter to show all or show only some Algos on the grid.

Aside from the orders already sent by the algos to the back-end, predictive or forward-looking orders that have not been placed yet can be shown on the grid. Visual indicators like border color, cell color, icons, text, and text-to-speech can be used to represent when an algo order goes live and is sent to the backend.

The user can toggle the Add Algo button 958 by a Long press or a Right Click. Toggling the Add Algo button 958 to the enabled state allows the user to place a new order on the grid by clicking on a cell while the Add button is highlighted. Dragging the Add Algo button 958 to a cell on the grid achieves the same effect. If the selected algo need additional configuration, a dialog box may be shown when the add algo button 958 is clicked or after attempting to place the algo on the grid by drag and drop or by clicking on a cell while the Add Algo button 958 is highlighted. Clicking Add Algo button 958 will seed a dialog box with the relevant properties of the selected cell. On the dialog box, the user confirms their algo settings before adding the algo to the grid. Different types of algos can be selected on the Algo Type combo box 960.

Algos outside of the viewable grid area can be represented as icons near the top or bottom of the grid. Algos can also be displayed in a dedicated toolbar window or area.

### Algo Controls on Chart

The Algo Controls can also be shown on a Chart as a Horizontal Line or as a Sloped Line, vertical Line. A typical chart has an X-axis associated with Time and a Y-axis associated with Price or value. The Algo controls on the Grid, for Start, Stop, Pause, Resume can be shown on a chart. When shown as horizontal lines, the Trigger action is the Price or value at which the Action Line intersects the Price Axis. When shown as a Slope with a Begin and End Time, then we have a Time window for when the Action can take place before it expires. A Sloped Action Line, shown as a line overlay on the chart, can also mean the Price or Value at which the Action takes place can change over time. For example, the Stop Algo or Start Algo Line can increase in value or decrease in value over time and can track a falling security's Price as a trendline, or hold a position and track a rising security's Prices as a trendline. Then, a Long or Short Algo can Start by opening a position or quantity, or the Long or Short Algo can Stop by closing a position or closing a set of smaller positions.

The Sloped line which changes Price Reference to Start, Stop, Pause, Resume, or some intermediate price or time input associated with a Line on a chart, whether Horizontal, Vertical, or a positive or negative Slope so Price or value changes with Time is not a setting input that can be shown as clearly on the Grid or a matrix of the Grid cells.

The Chart Trendline can be moved using Up, Down, left Right using Trim Arrows, Shift Arrows, which show on the Trendline or Algo Action Line on mouseover or on Right-click. This is faster than a going to a Config Setting Panel to change settings. In the Center of the Trendline or Slope Line, the functionality is a Shift up, down, left, right. A mouseover near each End of the Slope Line is more focused on Trim that End up, down, left, right in terms of both Price and Time Reference. So, dividing each Trendline or Slope Line into 3 Sections or Segments for this functionality can be done. E.g., 25%, 50%, 25% or 30%, 40%, 30%, or 33%, 34%, 33%, etc. Buy, Sell, Buy STP, Sell STP Orders can be Triggered with a Slope Line on a Chart. Such a Slope Line can be fixed or be docked and move with the Last Price, most Recent Bar, or the Recent H, L Prices detected.

When the Slope Line is drawn, an Enable, Disable Control can appear on the drawn Slope line, ideally on an uncluttered portion of the Line. This is what is used to easily and intuitively enable the slope line for an Order Action. The system can guess the Order, but the Order can be changed. The color of the Slope line is indicative of the Order Action. For example, Red can mean a Sell Order, Blue or Green can mean a Buy Order. Another control can be present on the Slope line for the Quantity or a default quantity can be used, for example, 1 contract or 100 shares. A user preference can be input according to each Symbol or Symbol Group in a Settings or configuration panel.

An example of Smart Order Action can be as follows: i) For a Long Buy Order or Open Order, if the Slope Drawn is a Negative Slope or a horizontal Slope segment, and the Bars over the Slope Time duration are below the Slope Line, the system will assume the Slope drawn is intended as a Buy Order to Open or Buy Order to Close a Short; ii) For a Long Sell Order or Close Order, if the Slope Drawn is a Positive Slope or a horizontal Slope segment, and the Bars over the Slope Time duration are above the Slope line, the system will assume the Slope drawn is intended as a Sell Order to Close or a Sell Order to Open a Short Position.

Part of a Slope's Smart Order Action includes the ability to disable any Order which if Hot would result in an instant Fill. Such warnings can be disabled, but there would be a Text message to explain why the Hot Order Action was disabled. The User has the option of changing the Slope line orientation and the Time duration, Slope angle to avoid an Instant fill. The user can click on the slope line and there would be handles to move the Slope segment or each End of the Slope Line. The Order Types and Quantity are easily accessible to modify the pending or working Order represented by the Slope on the Chart. Multiple Slope Order Action Lines may be placed on the same Chart and the Chart can support Company Teams or Community Trading on the Same Chart.

The Slope's Order Action can be indicated by the Color and Weight, Dash Pattern of the Slope Line. A Text Label along the Slope can indicate the Order Type intuitively, and this can become a drop-down list of other Order Types. A right-click action on the Slope or settings in a Chart Toolbar, either Docked to the Chart menu area or freely floating in the Chart Draw area as an overlay may also contain the Order Action when Touched, the Quantity, and other Order parameters and Statistics such as how long the Order has been Pending.

An Enable, Display Slope for an Order can be as intuitive as an empty checkbox or radio Button. When enabled by a click, a Tap, or any suitable gesture, a checkbox or radio button shows inside the circle. This type of enable, disable control is placed on the Slope Line oriented to the Chart Grid or to the Slope line itself. Similarly, a line or curve, even a complex curve may be drawn on the Chart with the Order Action Controls. Additionally, the controls may be drawn on a DMA line shown on a Chart, or a Technical Indicator having its own Chart Box area. For example, an RSI indicator or MACD indicator, even a Volume area below the main chart. In other words, any Technical Indicator or Chart Bars, Chart data can be shown and a Slope, Line, or Curve drawn to submit any suitable Order Type when Touched. The Slope line can be an Order Action for the Chart Symbol Shown or a different Chart Symbol selected.

A Slope line or Trendline is typically drawn on a Chart by a drag & drop action from one location on the chart to another location on the chart when such functionality is enabled by selecting the Slope or Trendline draw mode if the feature is not available by default. The subsequent slope may then be drag & Dropped as a line segment or the location and end-points of the slope line or trendline may be fine-tuned visually or by text input.

The Grid or a cluster of cells or Chart for one security may be used to change an input or Start, Stop, Pause, Resume an Algo which is trading one or more security. E.g., A VIX Chart or VIX Grid, SPX Grid, can be used to Trigger an Algo Action such as a Start, Stop, Pause, Resume, Close All Holdings, change an Algo intermediate input variable which may change with time, for an Algo which is trading a different security or a basket of securities. So, the VIX Chart may have a Sloped or Horizontal Line, as an example, which can change a parameter or Start, Stop, Pause, Resume an Algo which is Trading the RTY Futures for the Russell 2000 Index.

It's important to understand that each Algo Control, whether on the Grid as a Cell control or Cell indication, or a Chart, as a Horizontal Line or a Sloped line, can be restricted to a single purpose or Trigger when touched. After the Trigger Event which can be to Start, Stop, Pause, Resume, or change an Algo input parameter, the associated Chart Line can remain, disappear, or stay but change color & functionality. For example, the Start Algo line, when touched, can change color from Blue to Grey or flashing Blue, and then the user can click the line and stop it from flashing. The Algo Start Line would be a one-time use setting. Once the Algo is started, the Algo Action Line is disabled from further Start Events but the user can still see the Start details on mouse-over or right-click on the one-time Start Action Line.

In some cases, an Algo action line can toggle to a new Action Type, but it may still need to be moved to a new location on the chart. For example, a Start line can toggle into a Stop Line, which after the Stop Trigger can toggle back into a Start Trigger line. The slope of the line may allow for such Toggle events without changing the location or duration of the slope line. Each Algo Action Line have easy to access Action Configuration settings accessible by a right-click menu or an icon on the Chart menu areas, or an Algo Tool Bar.

Having multiple Action lines on the same Chart also means a user can have Multiple Start lines on the same Chart for Different Algos which may be operating on the same security, different securities, or a basket of identical or not-identical securities. An example of different Start Stop Algo Action Lines can be used to compare two Algos and their subsequent P&L Results and Trading statistics to see which is better or more effective. This also means the Algo Action Lines of multiple users can be shown on a common Chart, common Grid for a Community Chart, or Company Team Chart, and on a company Grid, community Grid for multiple users. In this way, a supervisor can cancel or close all Long Algos, all Short algos, etc. depending on market developments or risk conditions.

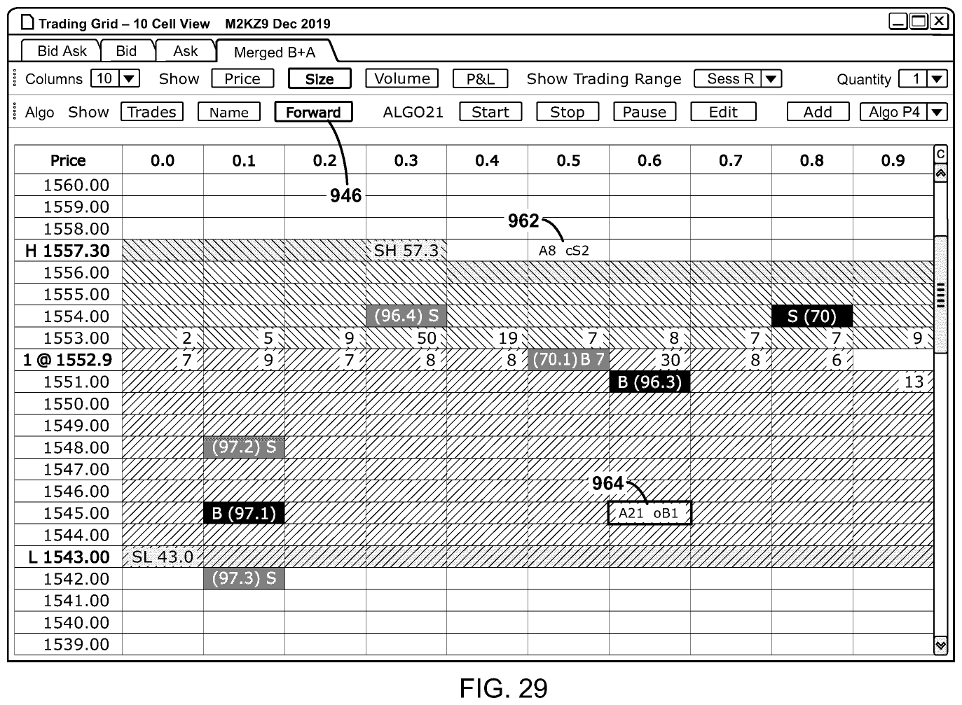

FIG. 29 shows an example where the show forward toggle 946 is enabled and how algos and their status can be displayed on the grid. Text shown on the algo forward close sell order cell 962 and algo forward open buy order cell 964 are changed from their algo names to their algo forward orders.

Algo names are truncated/shortened to allow the display of the status of an Algo's orders. Algo cells show the shortened algo names, the order action as letters, and the order quantity. Some of the Algo's text indicate ‘cS’ means close order, ‘oB’ means open buy. These ‘cS’ and ‘oB’ text is followed by a number which indicate the order quantity. ‘cS’ and ‘oB’ are shortened text displays of the Algo's next possible action and can be configured by the user. Not only text but icons and graphics can also be used to the Algo Forward display.

Not only forward orders, but other actions of the algo can be displayed as a Forward status. Some algos may not send orders but just trigger other algos or some other action and these can be displayed to the user.

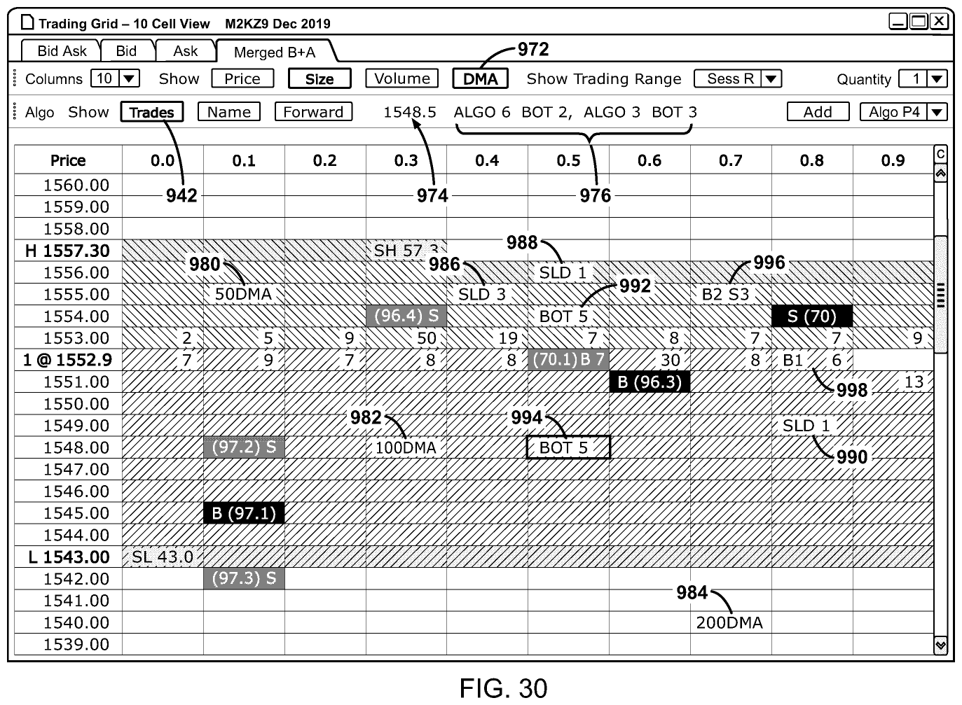

FIG. 30 shows algo trades on the grid and DMA indicators. The versatile nature of the present invention's grid allows the display and interactions of a variety of objects.

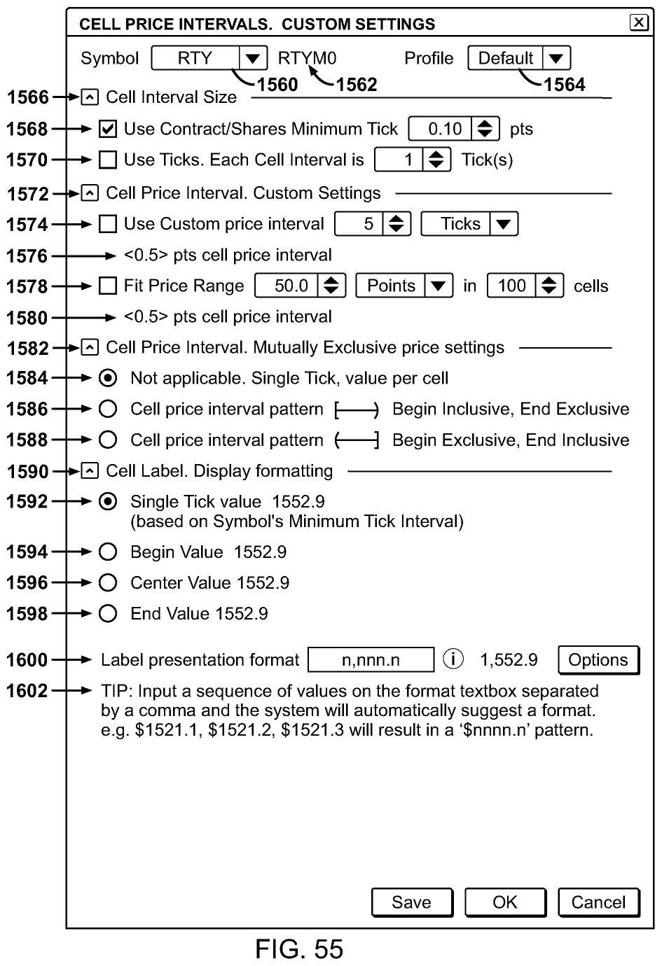

Show DMA toggle 972 shows or hides DMA indicators on the grid. DMA indicators are shown on the grid by 50 DMA cell 980, 100 DMA cell 982, 200 DMA cell 984. The grid can map DMA values even though they are not exact on the price associated with the cell. For example, 100 DMA cell 982 is associated with the cell that has a price of 1548.3. This means that the DMA's value is between 1548.3 and less than 1548.4. Even if each cell seems to hold 1 price value only, a range can still be assigned to the cell from the representative price of 1548.3 to less than the value of the neighboring cell 1548.4. The nature of the range of each cell can be changed and 1548.3 can mean that it's the max value that can be held by the cell and the minimum value is 1548.2 exclusive. How these cell values and ranges are discussed in FIG. 55.

The grid provides a way for the user to view algo trades on the grid. The feature can be used to monitor the progress of algos while still providing the user a view of the market. Algo trades can be shown on the grid by enabling the show trades toggle 942. Sell trades can be found on sell trades cell 986, sell trades cell 988, and sell trades cell 990. Buy trades are shown on buy trades cell 992 and selected buy trades cell 992. An example of both Buy trades and Sell trades happening on the same price can be seen on the mixed trades cell 996. ‘B2’ means Buy trades with 2 quantity while ‘S3’ means Sell trades with 3 quantity. ‘B2’ appearing on the left side means that the buy trades occurred first before the sell trades.

Sometimes there are several things that need to be displayed on a cell's limited space. An example of mixed info cell 998 where the it shows ‘B1’ meaning Buy trade with a quantity of 1 and the bid size ‘6’ is shown on the cell. The Grid tries to display as much data as possible. When the Grid is not able to display all data, some of the data may not be displayed and only the ones on the top of the priority is displayed. The hidden data may be shown on a mouse-over, right-click, a gesture, or a custom binding that the user chooses. The priority of the data can be determined based on which button was pressed most recently or based on a list that a user can edit.

Usually, when multiple objects need to be displayed on a cell, orders take priority to be displayed on a cell since orders can cause loses if not seen by a trader. When other data is displayed, presence of orders on a cell can be conveyed to the user by different visual cues like background color, foreground color, a symbol, text, icon, or semitransparent watermark, etc. One way to keep Order related data displayed on a cell while keeping the user informed of the presence of other object such as indicators, studies, session OHLC, etc., is by showing the other data for a short period of time then cell returns to displaying order data. Some data are transient and may only have value the moment they occur so these data can be displayed for a short period when they enter or leave a cell with an order or other data. Another trigger that can be used to display other data transiently is when their value is updated.

In Cell Data mode, clicking on the cell would show the Cell Data Table, and allow the user to Enable, Disable the DMA indicator. One option is to show the DMA as a Border in a user color to indicate DMA 50, 100, 200, etc. In Order mode, like in BookTrader, a click on a Cell with an Order can mean cancel the Order. This is a user Preference. Clearly, the DMA indicator, other technical indicators which resolve to a price or value that can be shown in a cell should not be affected by a click in the cell. So, if user wants to Edit the indicator choice or disable, enable, the best thing is to do such Edits in the Cell Data Table where the DMA or other Technical indicators will just show up as an item in the Order Table and show as an Order Row. The Edit options would be the DMA value to use, and choice of Enable, Disable, Cell Color, and type of indication (Label, background color, cell border, and other formatting choices).

The Cell Data Mode is the Grid mode which allows the user to click a cell and see the Cell details including the number of orders and Edit, Cancel, Delete, Discard orders inside the cell one at a time or All orders all orders at once. Cell Data is shown in the Cell Data Table which is a table type display of Data helpful for seeing Cell Data. The Cell Data Table contains a Cell Data Toolbar to access common, helpful tasks easily. The Toolbar may be customized, have a user preference, arrangement of items, Icons, and other features. If the Grid is not in Cell Data Mode, then it is likely that clicking or right-clicking on a cell will submit an order if the Grid is configured to do so like in its default settings. If the Grid is in Cell Data Mode, clicking and right-clicking give access to Cell details present in the Cell Data Table, or using right-click, a menu of easy options such as Cancel All Orders, Move all Orders (one time use), set an Alert, Alarm on Touch.

When the grid is in Details of selected buy trades cell 992 is shown on algo trades list 976. This list breaks down the composition of the trades if there are multiple algo trades performed on a particular grid cell. The algo name, order action, and quantity can be seen on the list. The price associated with the selected buy trades cell 992 of the cell is shown on selected algo cell price 974.

DMA is only one example of the number of indicators that can be possibly displayed on the grid. Any indicator can be displayed on the Grid as long as a value can be derived from an indicator. An indicator can be added or removed from the toolbar for ease of access. The toolbars display text only button as a way to clearly define the intention of each but the text can easily be replaced by icons or other graphical images. For example, The Cell Data Table toolbar can have a “TI” Icon so user can get a pop-up menu of Technical Indicators supported on the Grid. Selecting one will display the technical indicator on the Grid. The “TI” Icon could even be in the Grid Toolbar for easier access.

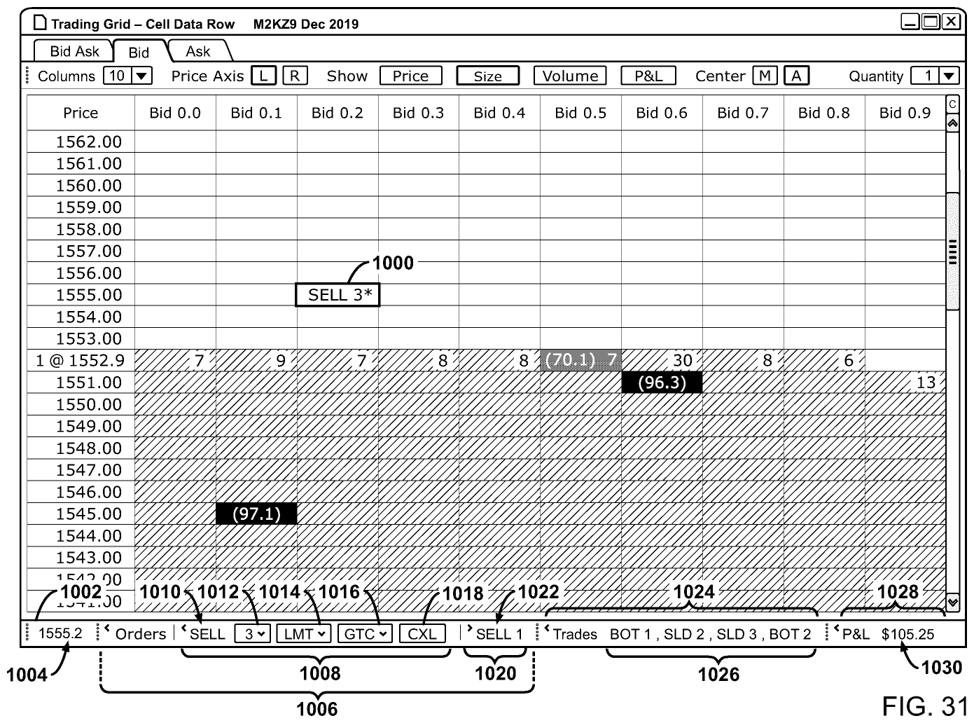

FIG. 31 shows the cell data row which allow the user to see more details about a cell in a minimal area.

When a user selects a cell, the details of the selected cell 1000 is shown on the cell details toolbar 1002. The selected cell 1000 shows an ‘*’ to show that there's more than one order in that cell aside from ‘SELL 3’.

The cell details toolbar 1002 contain sections that are collapsible and expandable to fit the needs of the user. Sections can be rearranged by drag and dropping the handles or by going into a configuration window.

The selected cell price 1004 echoes the price of the selected cell 1000. This can be a single value or a range of values depending on the configuration of the grid and its cells.

Orders section 1006 shows the orders that are present in the selected cell 1000. There are two orders, one is displayed in sell order edit mode 1008 and the other in collapsed order section 1020, order type combo box 1014, and TIF combo box 1016. Cancel button 1018 can be used to cancel the order and the sell order edit mode 1008 will be removed from the cell data row.

Sell order edit mode 1008 consist of several parts. order type 1010 shows the order action of the order. The editable parts consist of order quantity combo box 1012, order type combo box 1014, TIF combo box 1016, and an order can be cancelled by using cancel button 1018.

To save space and focus on one order at a time, a user may choose to have a minimal view of an order such as collapsed order section 1020. Only ‘SELL 1’ is shown by the collapsed order summary 1022 which means that this order is a Sell order with a quantity of 1.

Trades list section 1024 show the trades on the selected cell 1000 as shown by trades list 1026. Oldest trade can be found on the left and most recent on the right. The arrangement of the trades can be configured to match the user preference. Some examples of the attributes the order arrangement may be based on time executed, P&L, quantity, and order action.

The P&L section 1028 shows the P&L 1030 of the trades shown in the trades list 1026. Alternatively, P&L 1030 may be configured to show the resulting P&L should the orders represented by sell order edit mode 1008 and collapsed order section 1020 be filled.

Any symbol, icon, color, background, can be used as indicator for extra details not displayed on the cell. The cell details toolbar 1002 can be moved snapped around the window or can be made to float as a separate tool window.

The cell details toolbar 1002 will have a “TI” Icon so user can get a pop-up menu of Technical Indicators supported on the Grid, selecting one will place it on the Grid. The “TI” Icon could even be in the Grid Toolbar since it is not known in advance which cell will get the Indicator chosen.

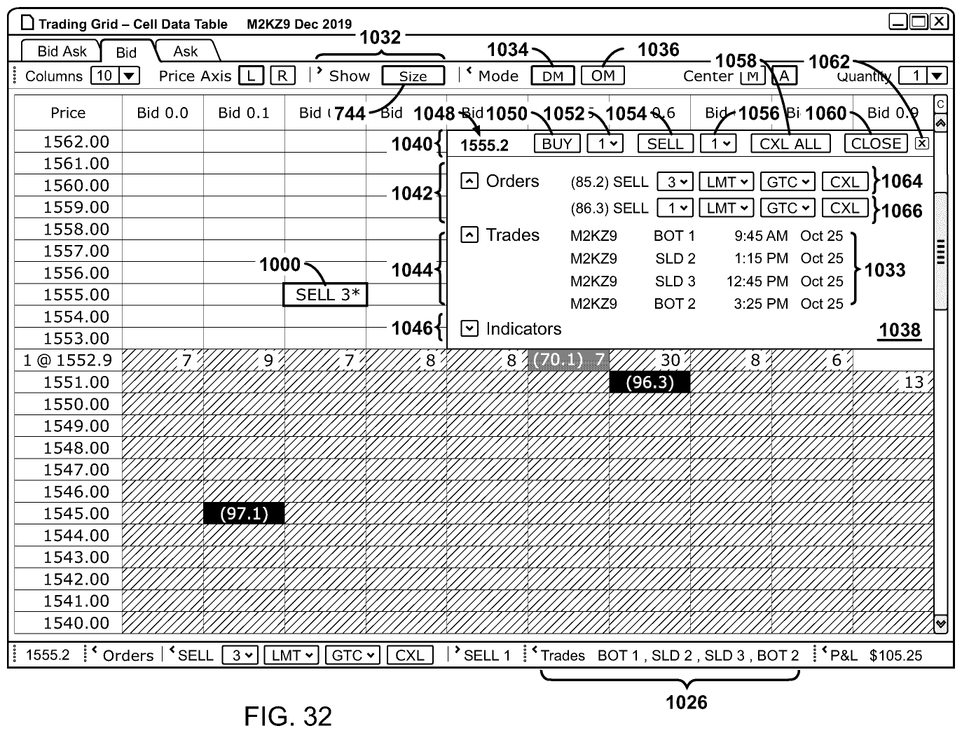

FIG. 32 shows the cell data table. The Cell data table show a more detailed view of data of the cell. A few examples of these details are pending orders, trades, indicators, and Algos.

On the collapsed Show section 1032, only the size toggle button 744 is displayed which is the only toggle button enabled in the Show section 1032 because of collapsed state. Only the enabled toggle buttons are shown to the user and the other options disabled toggle buttons are hidden when the state is collapsed.

Cell Data mode toggle 1034 is enabled instead of order mode toggle 1036 so the user can click on a cell safely without unintentionally placing an order. This allows the user ease of interaction with the cell details table 1038. Otherwise, if the order mode toggle 1036 is enabled, mouse-over on the selected cell 1000 will only be displayed on the cell details table 1038 while the mouse cursor stays on that cell. Each mode can be made available in a separate view. For example, 3 separate grids or in a separate sub-tab. By doing so, switching between Grid Modes can be the same as switching between dedicated Mode Tab or dedicated View of the different Grid Modes. The user can use the same Grid Config or favorite Grid layout and would prefer using separate tabs instead of using the Mode toggle buttons. This way the user may have additional toolbars, tool windows or other settings that may facilitate better placement of orders or whatever task a particular grid the user has intended. The number of views and modes is not required to be unique. For example, there can be two Order Mode grid with just slightly different settings and one dedicated Data Mode grid.

The cell details table 1038 show the details of the selected cell 1000. Toolbar 1040 contain some common order related functionalities. Selected cell price 1048 show the price associated with the selected cell. Pressing the buy button 1050 or sell button 1054 will produce an order with the selected cell price 1048.

User can send a buy order using buy button 1050. The buy order will use the number displayed buy quantity drop down 1052. To change the buy order quantity, user must change the buy quantity drop down 1052 by typing the desired quantity or selecting one of the listed quantities in the drop down menu.

Similarly, a sell order can be sent by using the sell button 1054 with a sell order quantity indicated at sell quantity drop down 1056.

Since Child Orders need a Parent Order as a Reference, they only become working orders when the parent Order is Filled or partially Filled. So, in TWS, child Orders are placed by a right-click menu option on the Parent Order (since it's assumed the parent Order is still an Open or pending Order before the user can use the Parent Order details as the reference for the Child Order details. For example, if the Parent Order is a buy Order, the child order (or dependent order) may be a Sell Order or a STP Sell Order or both (a Bracket order).

Placing a Child Order, STP order, Profit Taker Order, or Bracket Order. can be done using the Cell Data Table mode. Since a List of Orders in a Cell is shown, a trader can go to the Parent Order and (from the Grid Data Table Toolbar) select the type of Child Order the trader wants, for example, a Profit Taker Order, a STP Order, a Bracket Order (has both the Profit Take Order and the STP Order as a pair of Child Orders, one child Fill cancels the other child Order or a corresponding quantity). So, in the Grid Data Table, the Toolbar would support Icons for a Profit Take “PT” or “Profit” Child Order, a Loss Take “STP” or “STP Loss” Child Order, a Bracket child Order pair shown as a bracket Icon, “[ ]”, or “Bracket” Text. Other Order types may also be available from other Icons or from a Drop-down list. Once a Child order is selected or chosen, the Child Order Row under the Parent Order Row is created automatically and the user can review the child Order parameters or properties such as Quantity, Order Action, Price, Order Type, Time in Force, etc. Once the user is satisfied the Child Order details and intended use is correct, the user can submit the child Order in the Child Order Row using the Submit or Transmit Button.

A dedicated mode called Child Order mode can be implemented. Traders goes to the Parent Order, Right-click, then Pick Profit Take, STP Loss, or Bracket and the default settings would populate the Grid and the user can modify the price parameters by drag and dropping the populated elements wherever applicable. This can also be done on the Cell Data Table also since it contains a Parent Order Rows also listed. In Cell Data Table's List of Open Orders, Child orders would be placed similar to TWS Quote Rows. right-click, select a Child Order type.

In the Parent, Child mode or Parent, Child View, the user sees various Child Order types that can be added when the Parent Order is about to be placed, or after the fact, when the Parent Order is already Open, Pending, or a working order. Generally, pressing a Child Order Icon would be done when a Parent Order is selected. The Child Order Icon is applied to the Parent Order selected. If the Child Order Icon has no Parent Order as its Reference for the Symbol, Child Order Offset, Quantity, Time in Force settings, etc. then the user will get a prompt to input the missing Order data fields. To avoid errors, it's likely on any preset Child Order Settings, that the Child Order and its Parent Order are visible on the Grid and both can be moved, drag & dropped to their final location or price on the Grid. Then a final <Apply> button can be pressed to place the Child Order or both Parent & Child Orders. Key values can be supported which allow the downstream Child Order to be Referenced to its upstream parent Order and allow multiple sequenced Child Orders to be supported.

Finally, if the <Apply> or <Place> Child Order final step gets tedious, the user can be allowed to input such Child Orders Hot. i.e., The Child Order is instantly placed when the Child Order Icon is pressed or selected on the Tool Bar, as long as no other Parent or Child Order fields or conditions are missing. So the Hot Child Order allows the Price Offset default input for various Child Orders such as a STP, Trailing STP, Profit Taker, or Bracket Order to be applied to the Parent Order instantly. The user can still move the Price up or down, for example, using Trim Buttons or Drag & Drop of the Order in a Cell, but they are doing so to an active working Order or to an Open, Pending Child Order, or an Order in the Brokerage System's Queue, waiting to be submitted to an Exchange or Market.

In the Cell data Table, a Toolbar can be shown which have Icons for different Child Order Types (1) Order mode; (2) Cell Data mode; (3) Child Order mode, etc.

The Child Order mode is just a graphical version of what can be done in the Cell Data Table, since a Child Order can't be placed if you don't have a Parent Order defined in advance or pending or working already.

So instead of pressing an Order mode vs Cell Data mode Icons, a 3rd Icon can be shown, the Child Order mode.

Using a PC Mouse, in the Grid's Child Order mode, a trader moves to an Order and click or Right-click on it to see a menu of Order Actions, e.g. “Create: Profit Take Order, STP Loss Order, or Bracket Order”. A Smartphone or Touch Screen display, there would also be a Child Order mode and Tap on an Order, or Double Tap on it to place a Child order or Edit the Terms of any Order. The nice thing here is if all 3 modes are Off (no Grid mode is selected) then the default mode shown is the Order mode, but it's not interactive, i.e., the touch screen area around the Grid is Locked, and thus in a type of touch Safe mode, key lock, grid locked mode. Technically, the Grid in Cell Data mode doesn't submit Orders immediately. The user clicks or right-clicks on a cell to see more information about what's inside the Cell. So, the Child Order mode can be merged with the Cell Data mode by adding the Child Orders to the right-click menu items and using the click to see Order data inside the cell. The Cell Data Table has a Toolbar above the list of open, pending, or working Orders so we can also create, place, and submit (Transmit) Child Orders from the Cell Data Table also. The STP Orders, Profit Take, and Bracket Orders have a default Point offset (which the user can Edit before or after such child orders are created) and then the user can drag & drop such default locations to their final price and submit or Transmit the Order. Once the Child Order is in the system (waiting for the Parent Order to Fill so they go into effect as a working Order I believe), the price and Child Order terms can still be Edited, moved, and the Child Order can still be cancelled.

A default setting for the Child Order Offset can be enabled such that a Child order is created for every Parent order. The parent order is created by interacting with a grid cell thru a click or right-click, and then the child order can be drag and dropped or clicked a second time to its final cell location if necessary. E.g., A Parent Buy Order can have the Profit Taker located +2.0 pts higher for RTY. Generally, Parent Orders which create Child Orders would hop across the Bid-Ask Spread area to the other side.

An alternate method of creating child orders is thru the use of a toolbar so the order types, order actions, and other order attributes can be easily can be easily accessed. The Order types and Order actions will be shown on the toolbar as icons and when the user wants to attach a child order, the user first selects a parent order to attach the child order to, then drags an icon to a cell associated with a price where the user wants to create the child order. Once Cells have Parent Orders, Child Orders, the Cell Data Mode allows direct access to both Order Types, even if they are in the same Cell. The expanded Grid, Cell Price Range would allow the user to see most of the Parent, Child Cells appear on the same Grid.

A Child Order that is the same Order Action as the Parent, so there can be a Buy Parent, and Buy Child. This would mean both are likely on the Bid side of the Grid. The more normal Child Order or Bracket Order is the Profit Take, or Profit Take & STP Loss Bracket Orders. The Profit Take would be on the opposite side of the Parent, on the Sell Side, and the STP Loss Order would be on the Bid Side, but it would be a STP Sell Order. Click or Right-Click is fine for Desktop use, but even so, the user may prefer to mouse-click on a Toolbar. It's more direct, intuitive. Select a Cell, Parent Order Cell, then click on the Toolbar to select which Child Order Type is desired. The Toolbar Child Order Type select would work better on Smart-phones, Touch screen devices.

The Child Orders would go into effect when the parent Order is submitted (as a click, right-click, Tap, etc.) and that such an operating mode is configured off the Grid, but the settings may be accessible from a menu or Icon in the Grid window.

Aside for the Parent, Child mode, in the Order mode and Cell Data mode, a toolbar can be shown to the user containing icons that can allow the trader to easily place different types of Parent and Child orders. For example, a toolbar icon for Bracket Child orders, for STP Loss child orders, for Trail STP Child order, for Profit Taker child order, etc. TWS uses a drop-down list to select the Child Order type, but specific child order icons on a nearby Icon Toolbar can provide more intuitive placement of the above-mentioned order types.

A control that says [x] Hide Child Orders in Order Mode can be done to hide child orders. Child Orders will appear in Cell Data Mode and Child Order modes. The idea is to reduce Order clutter but make the Child Orders visible for Editing, for planning Trades, for changing price using Drag & Drop as necessary. So as the user switches Grid modes from Order to Cell Data to Child Orders, relevant information appears which may not appear in each cell for all 3 Grid modes.

The cancel all orders button 1058 cancels all orders listed at orders panel 1042. Individual orders can be cancelled by using the CXL button on their respective order rows. As a user preference, Orders in a cell may be cancelled, removed by clicking on the Cell with that has an Order. A “Cancel All Orders” button can also be shown on the Smart order action dialog box.

Pressing the close all positions at the selected cell price button 1060 will send an order that closes all the user's open positions for this security using the selected cell price 1048.

The orders panel 1042 lists the orders that are present in the selected cell 1000. Two orders exist as shown by sell order 1064 and sell order 1066. These orders rows can be dragged and dropped to a cell so as to change the associated order's price. Selecting the row then clicking on a new cell location can also be implemented to change the associated order's price.

When a new order is created, the system knows which Quantity is used for certain symbols so the value can be provided by the system. One way to adjust the quantity using the Order items in the orders panel 1042. The user can type or select a quantity in the quantity combo box. Quantity labels or text could be displayed on a cell or in a Larger Text area which changes on mouseover of a row or multiple rows in a grid. The orders can also be shown on other places like on a toolbar, on the grid, on parent, child grid modes, or on its own panel or frame.

When multiple orders are present on a cell, the cell height, width can be larger to accommodate the display of the orders. The cell area would go from 1 cell width to 2 cell width, or to 2 cell height, 4, 5, 6, 8 cell area and so on. The other cells that don't have orders in them can adjust or shrink in height or width and wrap around the larger cell. Doing such would help the user to see how many orders are in a cell without any guesswork since each order can be seen as distinct due to the expanded cell area. It is similar to displaying multiple order Icons in one cell to represent multiple orders.

Child orders can be shown as a row under a parent order in the orders panel 1042. A dedicated panel or area can also be made to show the child orders.

Additional areas or panels can also be implemented to group orders for easier management. For example, there can be dedicated panels for STP Orders, STP Buy Orders, STP Sell Orders, parent STP Buy orders, child STP Buy orders, etc. These areas can have items as rows or icons and can be sorted by time, area, price, and other attributes.

The trades panel 1044 show trades that occurred at the selected cell 1000. The trades list 1033 show the 4 rows which means 4 trades. This is a more detailed view of the trades list 1026 that can be found on the cell data row.

Indicators panel 1046 show the indicators that have values that can be mapped to the price associated with selected cell 1000. In this view, it is collapsed to provide more screen real state to the orders panel 1042 and trades panel 1044.

The orders panel 1042, trades panel 1044, and indicators panel 1046 can be freely expanded and collapsed by the user to suit their needs. Cell details table 1038 can be freely resized to view more data or provide a less obstructive view. Pressing the close table button 1062 closes the cell details table 1038 away from view.

On the Toolbar area, or a dedicated Order Toolbar, a manual Buy, Sell, CXL All, CXL Buys, CXL Sells buttons can be shown so if there is a sudden development, the user can easily Open, Close, CXL positions manually, rather than finding an Order, then Drag & Dropping it to the other side to cancel individual order, or other methods that may be time consuming and lead to delay the user's response to the present conditions.

When a situation occurs that could move a security up or down $10-$20 and momentum is coming. A trader won't have time to individually cancel Orders, but with the grid, an order can be clicked to cancel. If the Cell has multiple orders, a trader can just keep clicking to cancel each one as each order raises on Top of the Queue. The grid may also detect triple or any successive number of clicks and show the user a dialog box asking the user if he wants to cancel all the orders present on the cell. Aside from cancelling, the user may also be shown a button or option to close all orders in that cell and change them to a market order so the orders can be filled immediately.

Childs are also cancelled once the parent orders are cancelled. If the trader prefers, child orders can be cancelled separately if the trader wants to link the child orders to a new parent order later. The child orders can remain active but could mess what the original trader had intended so instead they can be made dormant until the trader setups a new parent order. The dormant child orders may have been cancelled on the exchanges but still visible to the user so they have the option to link to another parent order or delete the child orders.

In addition to buttons that cancel orders, the Toolbar are can also show buttons that change an order or group of orders to MKT so the user can fill orders immediately. An example of this feature is a Button to change all Buy Orders to Market, All Sell Orders to Market, to force a close. The feature is not just to CXL pending or working Orders, but to Close one side (Long Holdings, Short Holdings) very quickly.

The user can select which type of buttons to Show by enabling them from a List of available buttons. If shown in a Toolbar, it can be specific to the Security of the Grid. If shown in a Frame or container that contains or show multiple Symbols, then a button can apply to all Symbols in that frame or container. The user may also be shown a list of all Holdings by Symbol, then [x] Enables which Symbols to Act on, then press the <Apply> Button, so it becomes a two-step process when multiple Holdings, or securities are affected.

To summarize, Cell Data Mode is the Grid mode which allows the user to click on a cell and see the Cell details including the number of Orders, and Edit, Cancel, Delete, Discard Orders one at a time or All orders inside the Cell. Cell Data is shown in the Cell Data Table which is a Table type display of Data helpful for seeing Cell Data. In Cell Data Mode, clicking and right-clicking give access to Cell details present in the Cell Data Table, or using right-click, a menu of easy options such as Cancel All Orders, Move all Orders (one time use), set an Alert, Alarm on Touch. The Cell Data Table contains a Cell Data Toolbar to access common, helpful tasks easily. The Toolbar may be customized, have a user preference, arrangement of items, Icons feature. If the grid is not in Cell Data Mode, clicking, right-clicking on a Cell will typically create and/or submit an Order.

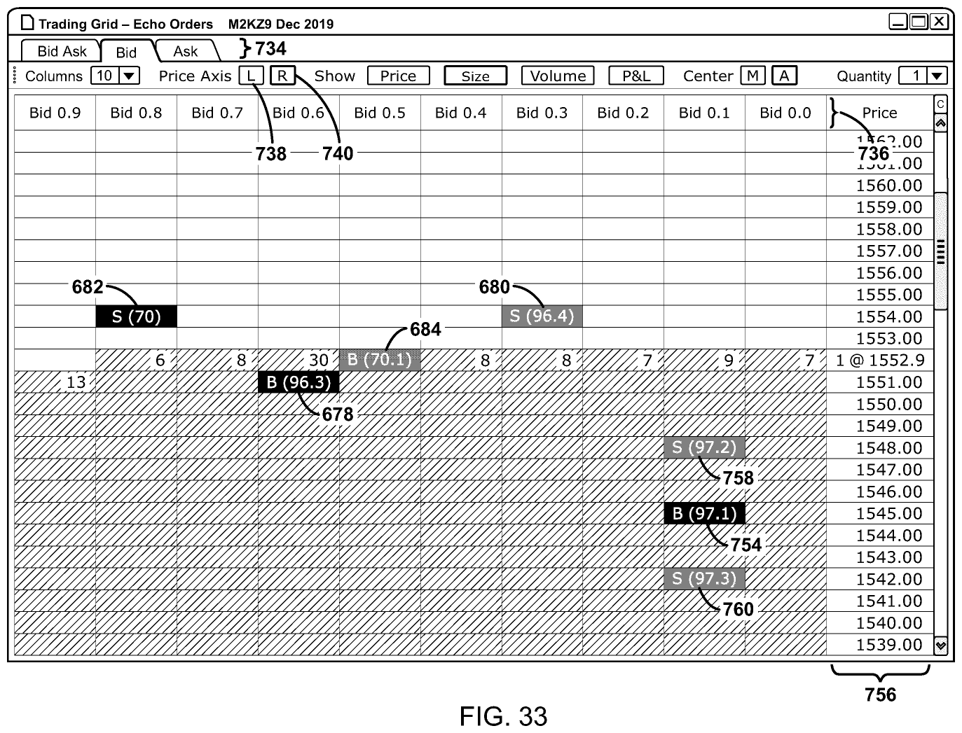

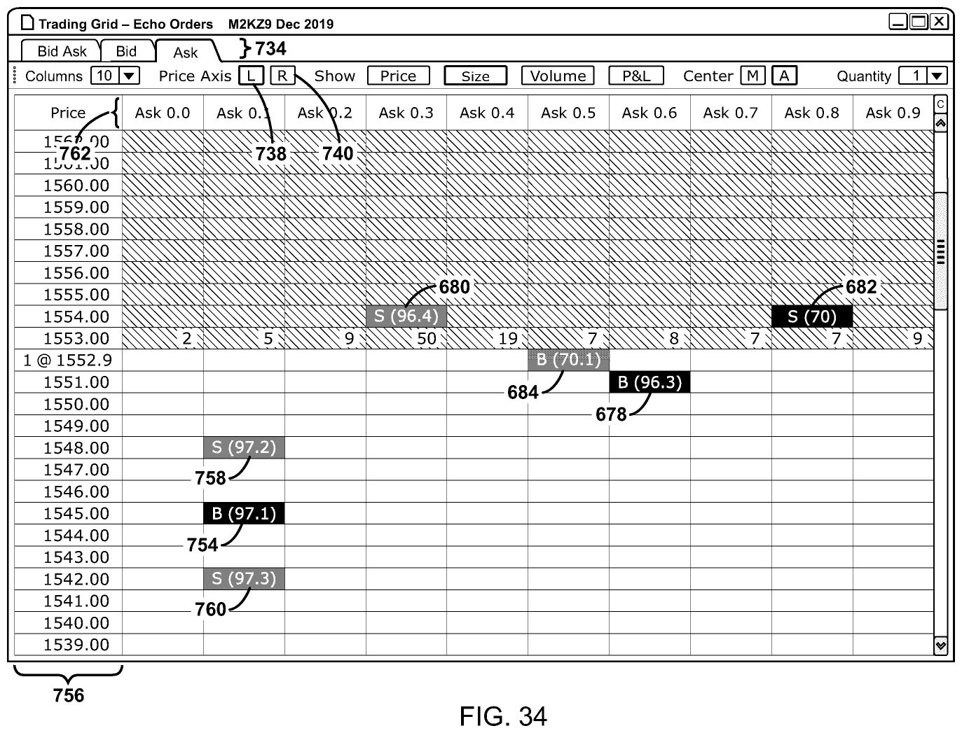

FIGS. 33-34 show how echoed orders can be advantageous for mapping various orders, fills, and other buy/sell events in a single grid. Doing so could facilitate placing, editing, and managing multi order strategies like bracket orders.

Trades can also be echoed so the user don't miss BOT fills even if the user is currently viewing the Ask tab. Similarly, it also allows the user to see SLD fills even if the user is viewing the Buy tab.

FIG. 33 show sell orders echoed when the bid tab is selected on the tabset 734. FIG. 33 also shows the right price axis toggle button 740 enabled instead of the left price axis toggle button 738 resulting in a right side price axis 756. If both options are enabled, two price axes would be displayed on the left and right side of the grid.

The bid column headers 736 is arranged from right to left. This particular arrangement of the bid column headers gives the user reference that the farther away the cell is from the price axis 756, the farther the value of the cell is from the price row label when looking at a particular row. The arrangement of the columns can be changed by the user depending on preference.

In the earlier figs, the bid tab only had child buy order 684, parent buy order 678, and parent buy order 754. In this view, the sell orders child buy order 684, child sell order 680, child sell order 758, child sell order 760, and parent sell order 682 are also echoed.

FIG. 34 is a companion view of FIG. 0.33 that show buy orders echoed when the ask tab is selected on the tabset 734. FIG. 34 also show the left price axis toggle button 738 enabled while the right price axis toggle button 740 is disabled. As a result, price axis 756 is located on the left side of the grid.

The ask column headers 762 are arranged from left to right and as a result the orders are mapped differently from FIG. 33 even though they show the same orders. The sell orders child buy order 684, child sell order 680, child sell order 758, child sell order 760, and parent sell order 682 can be found on this view as well as the echoed buy orders child buy order 684, parent buy order 678, and parent buy order 754.

Orders are mirrored vertically if FIGS. 33 and 34 are put side by side.

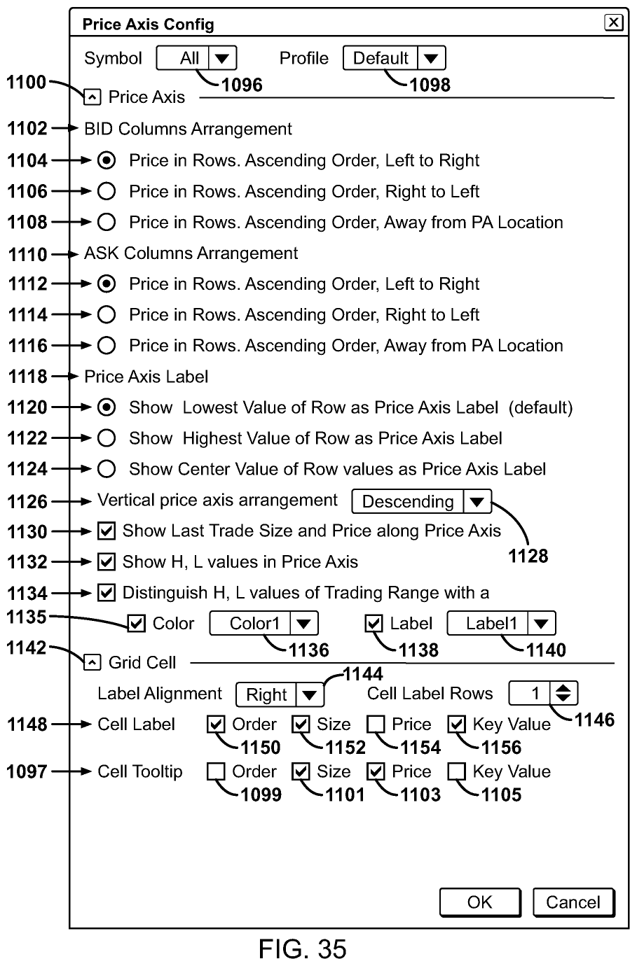

FIG. 35 show price axis and grid cell settings. Settings for the grid such as Bid and Ask columns arrangement, Price axis label settings, and Grid cell settings can be found on this configuration window. The symbol combo box 1096 show which symbol(s) the settings apply to. A different set of settings may also be configured targeted to an individual security. A setting could also be applied based on symbol and some filters (by security type, currency, minimum tick, etc). Different preset settings can be loaded and edited by using the profile combo box 1098 which can help the user to switch settings quickly depending on the market situation.

The price axis panel 1102 contain settings for how the price axis appears and how the other columns are arranged relative to the price axis.
Settings under Bid columns arrangement 1102 affect how bid columns are arranged relative to the price axis. Radio button 1104 arrange the cells left to right in ascending order. Radio button 1106 arrange the cells right to left in ascending order. Radio button 1108 arrange the cells horizontally where the lower priced cells are placed closer to the position of the Price axis.
Settings under the Ask columns arrangement 1110 affect how ask columns are arranged relative to the price axis. Radio button 1112 arrange the cells left to right in ascending order. Radio button 1114 arrange the cells right to left in ascending order. Radio button 1116 arrange the cells horizontally where the lower priced cells are placed closer to the position of the Price axis.
Settings under the price axis label 1118 affect what label is shown in the price axis cells. Radio button 1120 would show the lowest value of the row as price axis label. Radio button 1122 would show the highest value of the row as price axis label. Radio button 1124 would show the center (middle, midpoint) value of the row as price axis label.
Vertical price axis arrangement 1126 allows the user to change whether the price is arranged in descending or ascending order by using the combo box 1128. Enabling checkbox 1130 would show last trade size and price along the price axis. Enabling checkbox 1132 will show the High and Low values of a trading range in the price axis.
Enabling checkbox 1134 allows the user to change how the High and Low values of a trading range appear. Enabling color checkbox 1135 will show the High and Low values with colors. User can select a preset and can customize the appearance by using color combo box 1136.
Enabling label checkbox 1138 allow the user to see a label on the cell containing the High and Low values. User can select from a preset and can customize the label appearance by using label combo box 1140.

The High and Low cells can be represented with the same color or each may have its own individual color and label settings. Both Color and Label options be enabled at the same time.

Settings under the grid cell panel 1142 allow the user to change the visuals of the interactive grid cells. The label alignment drop down 1144 changes the way how text and objects are aligned inside a grid cell. The cell labels row combo box 1146 enable user to change how many lines of text and objects maybe displayed on a cell.

The cell label options 1148 allow the user to select what items to display inside cell. Enabling order checkbox 1150 displays orders inside the cell. Enabling size checkbox 1152 displays the bid size or ask size inside the cell. Enabling the price checkbox 1154 displays the price associated with the cell. Enabling key value checkbox 1156 will display the order key inside the cell.

The checkboxes may be rearranged in order of their display priority, the left most item will be displayed first. When multiple cell label data is available and user chose to display more than what would fit legibly inside the cell, the cell label would be truncated starting with the data that have least priority to be displayed as determined by the checkbox arrangement. The grid may try to display abridged label data (if user chooses to do so) in an attempt to display as much data as possible. E.g., shortening ‘BUY’ labels into ‘B”. Truncated data on a cell may still be shown on a pop-up when the user mouse-over or selects the cell.

Aside from text, other objects can be displayed inside the cells. These objects include icons, symbols, buttons, that may represent a grid function or a status of an order, algo, alarm, etc. Data and function can be tailored to suit the user needs and the context of the displayed grid. For example, in FIG. 1, no Bid size information can be seen above the Bid price, Bid Cell. So, in this sense, Bid size data does not exist above the Bid Cell. It is not hidden, it doesn't exist. However, in a merged grid, Sell size data would exist, and it could be hidden by showing no label information in the cells above the Bid cell. This doesn't mean the click, right-click functionality went away. It remains. If the user wants to remove the click, right-click functionality above the Bid Cell, that's a separate issue, separate control.

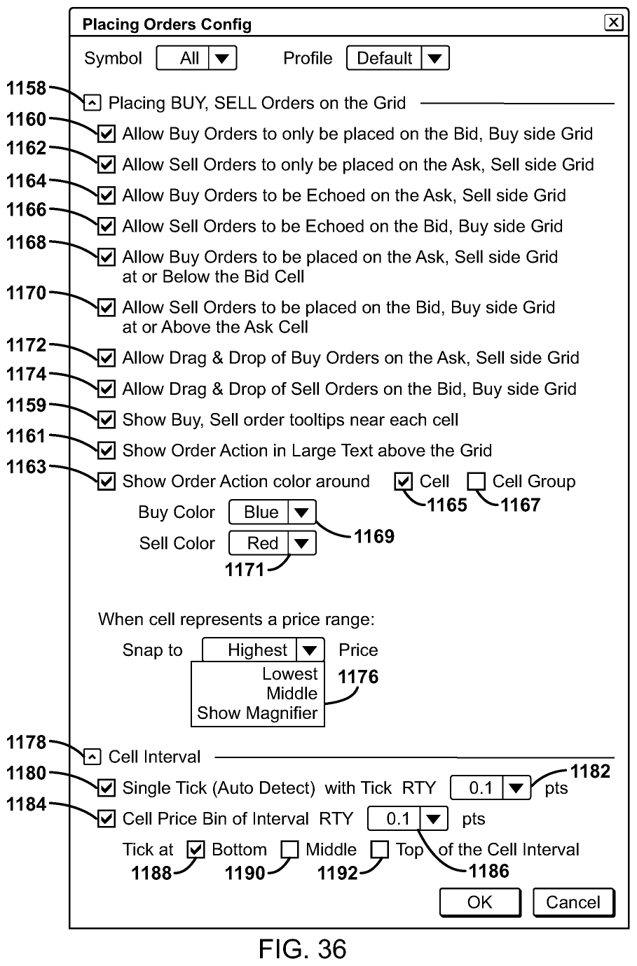

FIG. 36 show settings on placing orders and cell interval.

The settings under Placing Buy, Sell orders on the Grid panel 1158 affect how the user interacts with the cells on the grid with respect to the placing, editing, and management of orders. Checkbox 1160 Allow Buy Orders to only be placed on the Bid, Buy side Grid. Checkbox 1162 Allow Sell Orders to only be placed on the Ask, Sell side Grid. Checkbox 1164 Allow Buy Orders to be Echoed on the Ask, Sell side Grid. Checkbox 1166 Allow Sell Orders to be Echoed on the Bid, Buy side Grid. Checkbox 1168 Allow Buy Orders to be placed on the Ask, Sell side Grid at or Below the Bid Cell. Checkbox 1170 Allow Sell Orders to be placed on the Bid, Buy side Grid at or Above the Ask Cell.

Checkbox 1172 Allow Drag & Drop of Buy Orders on the Ask, Sell side Grid. Checkbox 1174 Allow Drag & Drop of Sell Orders on the Bid, Buy side Grid.

Checkbox 1159 Show Buy, Sell order tooltips near each cell. Checkbox 1161 Show Order Action in Large Text above the Grid. Enabling checkbox 1163 shows a border to identify buy and sell orders. The border drawn can be around a cell by enabling the cell checkbox 1165 and/or around a group of cells by enabling the cell group checkbox 1167. The border colors can be changed by using buy color combo box 1169 and sell color combo box 1171.

Combo box 1176 allow the user to change how an order price is determined when a cell represents a price range.

Settings under the Cell interval panel 1178 contain options on how a price range affects a cell.

Checkbox 1180 Single Tick (Auto Detect) with tick amount combo box 1182 result in a setting where each cell has mutually exclusive prices, a unique price or price Range. Two adjacent cells don't have any price overlap. If a trader wants cells to represent a price range, a user can use combo box 1182 to quickly edit the interval. Checkbox 1184 is where user goes to set the Price Bin width for the cells of the Grid by using the interval combo box 1186. When a cell represents a price range, the cell can display the tick in any one of three options: bottom checkbox 1188, middle checkbox 1190, and top checkbox 1192.

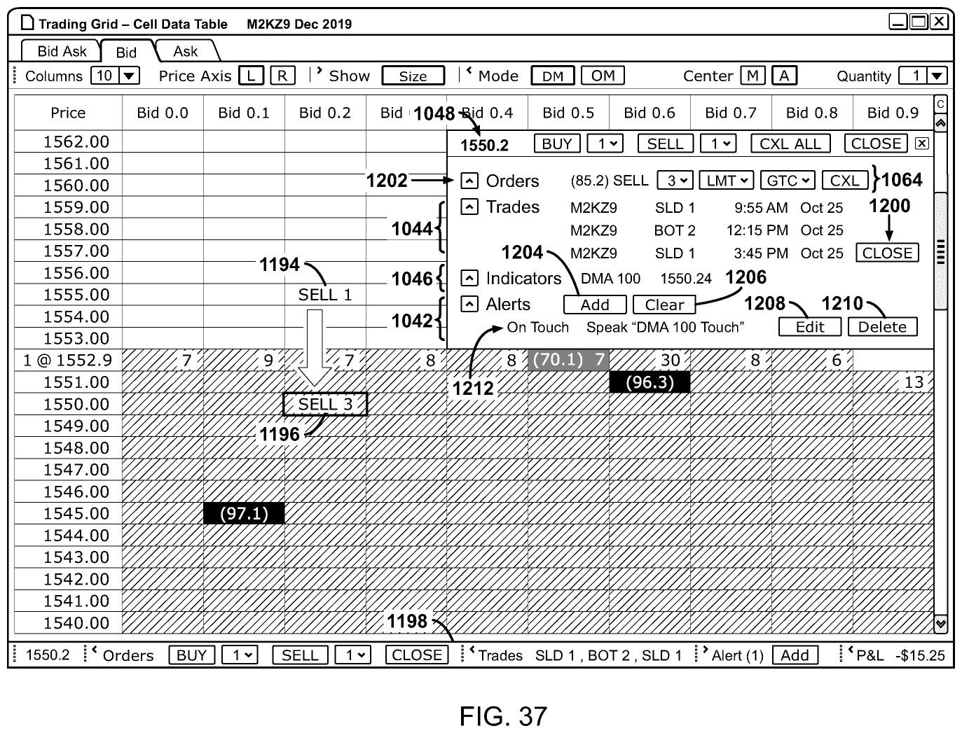

FIG. 37 show a movement of the cursor from a cell with an order to a cell without an order and the resulting changes to the cell data table and to the cell details row. The cell details table 1038 on FIG. 32 is the reference ‘before’ image before the order is moved.

The cursor was dragged from origin cell 1194 and dropped to the destination cell 1196. The price of the cell is updated to 1550.2 as shown in selected cell price 1048. Destination cell 1196 now shows ‘SELL 3’ to reflect the moved order. Origin cell 1194 now show ‘SELL 1’ to reflect the order that was not moved. Note that the only the price of the sell order 1064 was changed when it was dragged to the bid cells area, the order action SELL remains the same although if the user clicked on an empty bid cell, a BUY order would have been generated instead. The trader can change this behavior if they prefer and have the order action changed too. The sell order would have been short lived and would be filled immediately since the Sell order price 1550.2 would be lower than the Best Bid price and that usually means an instant fill. There could be cases that such operations that would result in instant fills might be accidental. The system can provide protection against this instant fill by ignoring the operation or by showing the trader a dialog box to confirm their action.

Alternatively, a single order can be also be moved on the grid and effect a change in price by using clicks or taps. An order can be placed on the Grid by clicking on one location and then clicking on a new location will move the order to clicked cell.

The user may choose to limit the move via click to just the Ask Side or Bid Side where the order was originally or allow the click to cross over to the other side of the Bid, Ask spread. If an order is only allowed to move on the Bid side only for Buy orders and Ask Side only for Sell orders, there can be one Buy order and one Sell order present simultaneously in the combined Bid-Ask grid and click to move an order will still work. A single Buy order can be moved on the Bid side by clicking on a new cell location and if clicked beyond the Bid side, the move is not recognized. Similarly, a single sell order on the Ask side can be moved by clicking on a new cell location on the ask side and the Sell order will be moved to the clicked cell. If a click is performed on the spread, the action can just be ignored by the system or the user can be shown a dialog or warning that the spread was clicked and the system is unable to determine the user's intention. The shown dialog or warning can contain possible actions that the user can take, e.g. Place MKT order, just close the dialog, etc.

As a complement to the click to move an order feature, the user can enable settings that allow clicking on an order to cancel, delete, discard, or remove the clicked order. If there are multiple orders present on a cell, the user can be shown a dialog box where the multiple orders can be seen in more detail and batch actions such as batch cancel, batch move can be performed. A default action can also be performed when clicking on a cell such as: cancelling the most recent or the oldest order; moving the most recent order to Market to filled instantly, select all orders in the cell to be moved to a new location by clicking, etc.

Certain checks can be implemented such that the click to move an Order remains logical and not result in an instant fill, unless a click is permitted to cross the Bid area or Ask area to the other side. Note that a click on the other side would just result in a new order placed on that side if such behavior is disabled. So, a Buy Order will only be moved if the click is still on the Bid side. A click on the Ask side would result in a new LMT Sell Order. These functionalities may be presented as Icons on the Toolbar to easily change the behavior in real-time.

The Drag & Drop of Orders to change Order Price is available and can be Enabled and disabled. Also, click on an Order to cancel or delete it is available and can be toggled on-off. Disabled means click on an Order places a 2nd Order on the Cell. User preferences also allows an Open or working order to be moved by clicking on a new Cell location when a single Order is present on the Grid as a whole, or a single Order is present on just the Bid Side, or just the Ask side. The Order moved via a click to a new location is logical and will not result in an Instant Fill.

Orders panel 1202 now shows only sell order 1064. In this case, the top most order is the only one that was moved to the destination cell. A user can change this behavior and change it to move all orders in a cell when a drag and drop is performed. The orders panel 1202 can also be dragged to the destination cell 1196 to move all orders displayed in it. If the user wants to move an order other than the top most order, they can use the orders panel 1202 and look for the row the row of the order that they want to move, then drag and drop that order row to the destination cell.

The trades panel 1044 is also updated to the trades that occurred on the destination cell 1196.

The close button 1200 closes a filled position. If the filled order is a buy order, it will send a sell order with the position quantity. The type of order may be a limit order, market order depending on user config.

The indicators panel 1046 show indicators that can be mapped to the cell. Although sometimes not obvious, a cell may not just represent one price point but a price range.

The alerts panel 1202 show alerts that are present on the cell and some buttons related to alert management. The add alert button 1204 adds a new alert by a dialog box or by a new section appearing. The clear alerts button 1206 clears all the alerts displayed under the alerts section. The alert description 1212 shows the summary of the alert like trigger and message (alias, alert names, duration, security). The edit alert button 1208 edit allows the user to edit the particular alert shown by alert description 1212. The delete alert button 1210 allow the user to delete the alert indicated by alert description 1212.

Similarly, the context of cell details row/status bar 1198 update. In this image, the pending orders section is hidden since the user can use the cell details table to view the pending orders better. Instead, the area is replaced by buttons similar to the toolbar of the cell data table.

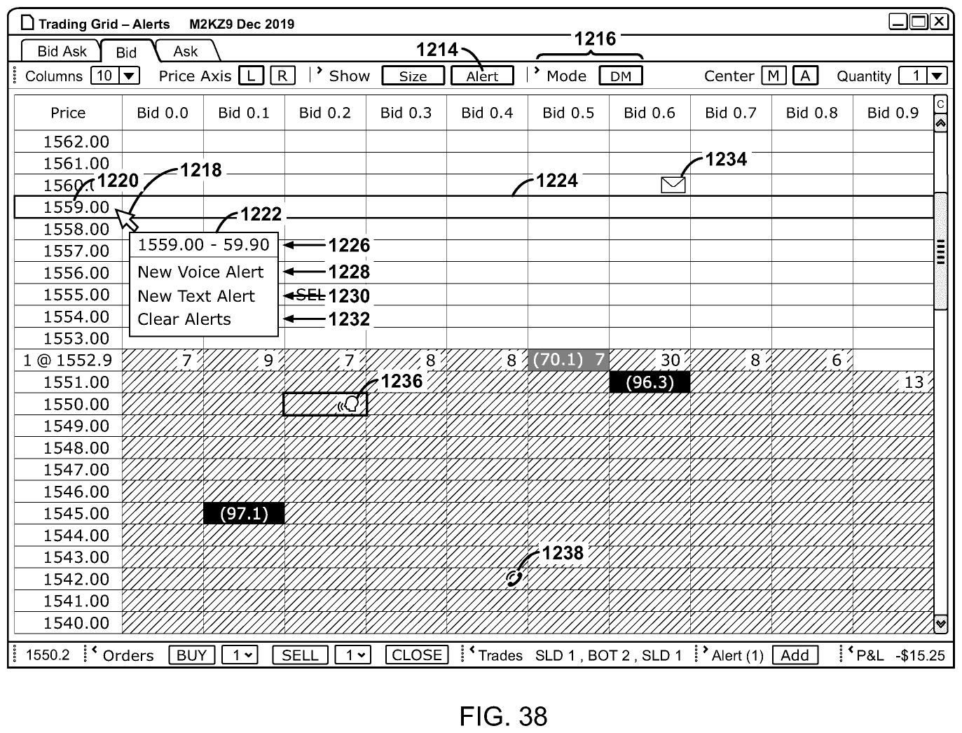

FIG. 38 shows an alerts menu when a cell on the price column is right-clicked. It also shows several alert icons.

The alert toggle 1214 button shows/hides alerts on the grid. Show section is collapsed, only the enabled options are visible. Mode section 1216 is also collapsed and only the enabled option “DM” is shown. Collapsing sections allow the user to save real state and view more relevant controls.

When PA cell 1220 is right-clicked, the popup menu 1222 is shown near the cursor 1218. The grid row 1224 is highlighted to indicate the position of the right-clicked price column cell.

The popup menu 1222 show data and commands available for the PA cell 1220. Data includes the row price range indicator 1226 of the cell, which is representative of the prices highlighted by the grid row 1224. The New Voice Alert command 1228 creates a new voice alert when any of the cells highlighted by the grid row 1224 is reached the Last price or trading activity. Similarly, New Text Alert command 1230 creates a new text alert. Clear alerts command 1232 clears all the alerts on the row of the PA cell 1220. Different types of alerts may be represented in the cells thru icons. e.g., email alert icon 1234 is an example of an alert that sends an email to the user when it triggers; voice alert icon 1236 is an example of alert that reads an alert using text to speech software when it triggers; call alert icon 1238 is an example of an alert that calls the user when it is triggered.

Aside from the Last price, other market data such as bid price, ask price, bid-ask midpoint, and other indicator values can be used as inputs for alerts. Alternatively, the user may enter alerts in a more detailed manner by using a dialog box. This behavior may be switched in a config panel.

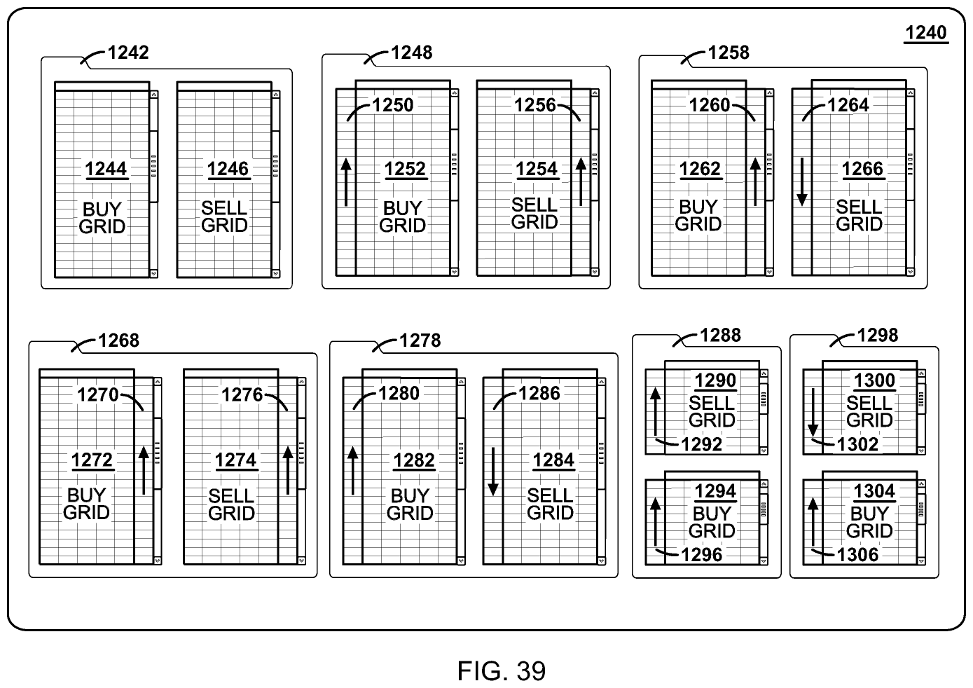

FIG. 39 shows schematic views 1240 of the various arrangements of the buy grid, sell grid, and price axis. On some schemes, the buy grids and cell grids can be scrolled independent of each other. The behavior can also be changed that the bid grid and ask grid are scrolled in sync.

Tab 1242 have the buy grid 1244 and the sell grid 1246 side by side, with scroll bars independent of each other. Cells inside the grid maybe arranged horizontally or vertically independent of each other.

Tab 1248 buy grid 1252 and sell grid 1254 side by side, independent of each other. descending price axis 1250 on the left side of the buy grid 1252, descending price axis 1256 on the right side sell grid 1254.

Tab 1258 descending price axis 1260 on the right of the buy grid 1262, ascending price axis 1264 on the right of the sell grid 1266.

Tab 1268 descending price axis 1270 on the right of buy grid 1272, descending price axis 1276 on the right of sell grid 1274.

Tab 1278 descending price axis 1280 on the left side of the buy grid 1282, ascending price axis 1286 on the left of sell grid 1284.

Tab 1288 show sell grid 1290 on top and buy grid 1294. descending price axis 1292 on the left of sell grid 1290, descending price axis 1296 on the left of buy grid 1294.

Tab 1298 show sell grid 1300 on top of the buy grid 1304. The sell grid 1300 has an ascending price axis 1302 while the buy grid 1304 has a descending price axis 1306.

Buy grid and sells grid maybe flipped to match the user preferences and culture settings. e.g., if a buy grid is found on the left and the sell grid is found on the right, by changing a setting, the buy grid may be switched to the right and the sell grid can be found to the left. Since the bid grid and ask grid are independent of each other, each grid can have independent settings, even different PA interval. One side can have cells arranged by column while the other arranged by row. The column counts can also independent, one side can have 10 columns while the other 5 sides, it doesn't have to be symmetrical.

A great amount of flexibility is demonstrated by FIG. 39 where various types of alerts are displayed on the grid by using icons. Similarly, the grid has enough flexibility such that other types of data can be also displayed graphically on each cell by using icons, drawings, pictures, and other graphical elements. In addition to displaying the user's own trades in the grid, the orders, trades, positions, and other trading activity of other users from the Community Grid feature can be displayed on the grid by using icons, pictures and graphics. Trading activity from other users can be shown on the user's own grid together with the other users' picture, avatar, user id, and other identifiers to differentiate those from the user's own trades, orders, and positions. If there's too much clutter in a grid, a user may show other user's trades, orders, and positions on a separate grid. A user's avatar can be right clicked, mouse over, tapped to find out more details about the user's trading history, trades, positions, open orders, profile, and even other functions such as private messaging, blocking, reporting, etc.

The Community Grid feature allows other user's trades, orders, positions, and other trading activity to be displayed on the user's grid. Different users may share their trading activity to other users then other users may opt to view said shared trading activity on the user's own grid. Trading activity such as buy and sell orders, order quantity, stops, positions, position quantity, and others may be shared by a user in full or partially. i.e. A Trader may show you where their Buy or Sell Order(s) are but may not wish to broadcast their Quantity, just Price. Similarly, they may wish to show as a verified user, but not their Chat, identifiable name. If a user just shows their anonymous name, then may show their Order Quantity, etc. Safeguards are needed against spoofing orders, which is placing orders only to yank them later, having a genuine order on the opposite side. So, if a user is detected to be spoofing or manipulating other users, they can be kicked off or suspended, temporarily or permanently for the community Grid. A user may also opt to block a particular user from viewing his trades to protect their interests.

A user can choose to mimic other user's orders, trades, and positions any time by clicking on the other user's orders, positions, and trades visible on their own grid. When a user decides to mimic another user's orders, positions, and trades, the user may choose how many trades they want to mimic. i.e., They can mimic the user's trades for only 1 trade, a pair of open and close trades, mimic trading activity for a certain period of time or number of trades then close whatever remaining opening orders, mimic all trading activity until user decides to stop to mimic the other user's trades, mimic all trading activity including open positions, and other schemes. The user may also choose to copy the quantity of orders, trades, and positions 1:1 or they can allocate a portion of their funds and the system can increase or decrease the quantity of the order and trades according to the scale set by the user.

Aside from mimic, a user may choose to just subscribe to another user to view the other user's trades on the grid and have them alerted when that user makes a trade or places an order, then they can choose to manually mimic each order by click the order, trade, or positions shown in the grid. The user has a choice to mimic the exact orders to arrive at the same position as another trader's or the user can just buy at market to immediately mimic the other user's positions.

All resulting trades, orders, and positions as a result of choosing to mimic another user can be displayed on the grid and the user can intervene anytime if they don't like the results of mimicking another user. Interventions such as closing a mimicked position, attaching a stop loss, drag and dropping the mimicked order to another cell to change the price, cancel the mimicked order, change the mimicked order type, and other types of order modifications. Note that generally, the user can only intervene with orders, and positions a user owns as a result of the mimicked order and not the orders of the other users unless permissions were granted to the user. E.g., Trader employee is done for the day, and Transferring their Orders to the new shift in a 24-hr operation. If the user intervenes while mimicking another user, then the mimic trading activity might automatically stop the mimicking if the modification or intervention done by the user would interfere with the feature.

Community feature is also useful in a team environment where multiple people are trading together and can be monitored by team members to avoid conflict in order, trades, and positions. A group can be created by one user and invite other users to trade in a common grid. Specific roles and permissions may be created on who can view, modify, place, cancel orders and positions. For example, a team manager can modify his team members orders in real time, and even attach notes to an order to inform a user why his orders were modified. In a financial advisor setting, clients can be shown the advisor's order on the grid and additionally, the clients can modify orders if the advisor gives them permissions to do so. A chat messaging and video conference function can be implemented so users can discuss strategies. A shared workspace where users see the same grids, tab settings, toolbars, and windows can be implemented where multiple users have access to the same grid and each trades, order, action and change are logged for tracking purposes. Notes can be attached to orders, alerts, avatars, users, and other objects to the grid.

User's sharing said trading activity can be monetized by charging a fee when other users want access to view, follow, or copy the sharer's trading activity. Other examples to monetize s user's shared trading activity are by commissions of the profits, trade amount, subscriptions, and ad revenue. To encourage other users to subscribe to a user's shared trading activity, trading stats could be shared to other users such as weekly, monthly, yearly performance, user verification status, average selling and buying price per session, and others. Trial periods where other users can try subscribing to a trader's trading activity for free can be implemented to allow users to promote themselves.

The grid can be adapted to a device where it is displayed on a surface with a display where a single user or multiple users can place their orders by using physical tokens. Each user's token would represent their account and placing a token on a surface where a cell is displayed is interpreted by the system as the user placing an order on that cell's associated price. When filled, the cell will glow, the token may light up, vibrate, produce a sound alert, a notification may be sent to the user on their phone, and other visual, physical, and auditory alert may occur when the order is filled. The user would be able to check their positions, account, P&L on their phone, a dedicated terminal, or a display on the surface or other display device. If the user's order has not been filled, the user can move the token to a different cell to change the price of their order. The user can also remove the token on the surface to cancel their order if it has not been filled. The token may have built-in displays to show the user's positions, orders, trades, and settings. The token may also contain buttons, sliders, dials, to change order type, size, quantity, and other parameters. Dedicated tokens can also be used to represent order types and quantities. A combination of dedicated order types and a separate order quantity tokens can be used to decide the parameters of the order. E.g., the user would stack a Buy token and a quantity token of 100 to place a Buy order with 100 quantity. The user can stack multiple quantity tokens to create a larger order. The way the user stacks tokens can be given special meanings such as attaching bracket and STP loss orders but it can also be stacked in any order and just the sum of quantity tokens and order type token would be read by the system for simplicity. The token may be multi-sided and each side can be configured to represent a Buy, Sell, STP Buy, STP sell, and other types of orders. Depending on what side the user places on the surface a different order type would be placed.

The tokens can also show the Quantity and Security. When an Order is filled, the Chip would change color, flash, and eventually go dead (no visual indication). ie., The Pair Trade is done. The security symbol would show on the Display or be Printed on the token. Same with the Quantity, Printed on the Chip or show on a display.

Machines like robotic arms or a person can be utilized to clean the grids, move the tokens, or return tokens to the users when their orders are filled or need to be removed from the grid. E.g., when the grid's display needs to scroll since the best buy and sell cells will be going out of view as a result of a sudden movement in price.

A casino or casino like setting can utilize the grid where a user can just walk-in, deposit money, trade using tokens, terminals, or a combination. So, all the user has to do is put their tokens in a Square, move it to a new Price if they wish. When Filled, they take their chip back and a P&L, Account is done at the cashier, which they can confirm on a Smartphone App.

In an office setting or group setting, each user may have a dedicated terminal but a shared grid where anyone on location can also see their trades on each other's terminals. The terminals have would have Tabs for different Securities and in each Tab would be a Master Grid, a Side window showing the Chat for that security, and the Terminal user as a user with tokens, Contact card of Value, e.g., $100 Pieces, $500, $1000 Pieces and then they Trade, take their Profits, Losses at checkout time. Collect their Cash balance, and go home.

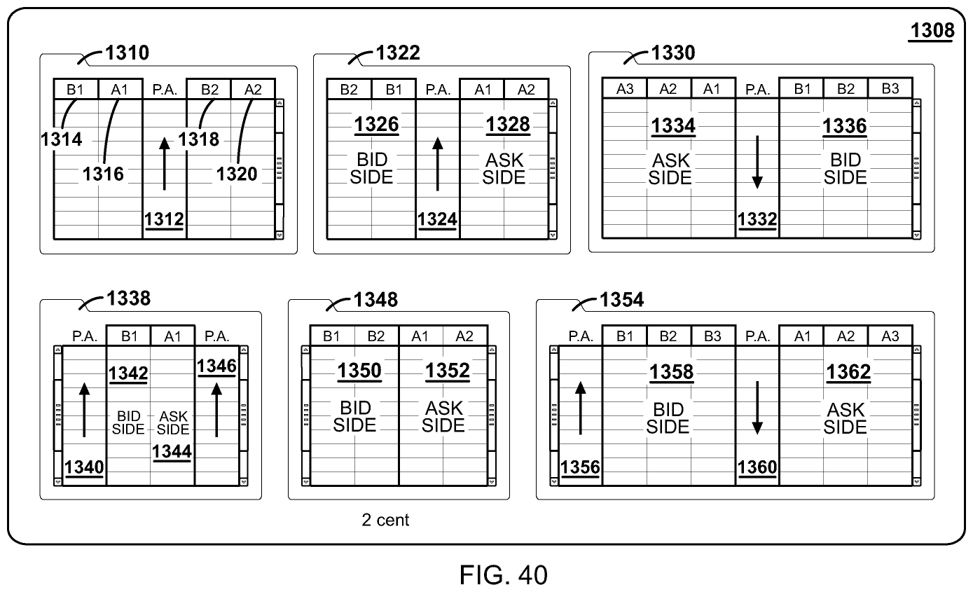

FIG. 40 shows schematic views 1308 of the various arrangements of buy side columns and ask side columns.

Tab 1310 show descending price axis 1312 in between the bid columns and the ask columns. The left half of the grid contains bid column 1 1314 and ask column 1 1316, while the right half show bid column 2 1318, ask column 2 1320. The bid column and ask column with the same cell prices are grouped on one side.

Tab 1322 show descending price axis 1324 in between the bid side columns and ask side columns. The left half show bid side columns only on the bid side grid 1326, while the right half show ask columns only on the ask side grid 1328. A1 and B1 are closest to the PA. Columns of the same type are grouped on the same side of the PA.

Tab 1330 ascending price axis 1332 is shown in between 3 ask columns on the ask side grid 1334 and 3 bid columns of the bid side grid 1336.

Tabs 1310, 1322, and 1330 have a common price axis, scrolling affects all columns Tab 1338 the descending price axis 1340 is shown on the left of the bid side 1342 while descending price axis 1346 is shown on the right side of the ask side 1344. Each cell represents 2 Minimum ticks. e.g., 0.2 pts on RTY. bid side 1342 and ask side 1344 can be scrolled individually or scrolled at the same time by enabling a config setting.

Tab 1348 show 2 columns on the bid side grid 1350 and also 2 columns on the ask side grid 1352. Each cell also represents 2 Minimum ticks. Bid columns and ask columns are together with the lower priced columns on the left (B1 and A1) while the higher priced columns are on the right (B2 and A2). Price labels may be shown inside each cell to aid the user for the cell price since the PA is hidden. The bid side grid 1350 and ask side grid 1352 can be scroll independently or scrolled together by changing a config setting.

Tab 1354 has advantage such that the closest to market are located on the top rows and the farthest from the market are located on the bottom rows. descending price axis 1356 located on the left side of the bid side grid 1358, ascending price axis 1360 of the ask side grid 1362 is located on its left between before the bid side grid 1358.

Multiple securities can be displayed in the trader's window in the same view. So, if the trader is monitoring 6 securities, the trader will see the 6 Grids, each Grids Header area one under the under. The user uses the vertical scroll bar in the Window or Browser page or Tab to scroll up and down to get to their favorite Grid. The trader can also do this using a left side menu or Symbol buttons or Symbol links like a Wiki page. Each Grid can still be customized for Rows and Header area Stats.

The Grids can be arranged vertically, horizontally, or as a Matrix of Rows, Columns of Grids. The Grids can even be plotted on a Sphere, Ball, Cylinder, or similar curved shape that the user can spin, zoom into and out of a Grid, like Google Earth and other Mapping applications.

The Grid presentation and Symbols can be arranged in any order the user wants. i.e., Drag & Drop Grid Icons associated with a symbol similar to arranging Icons on a desktop view or Icon view.

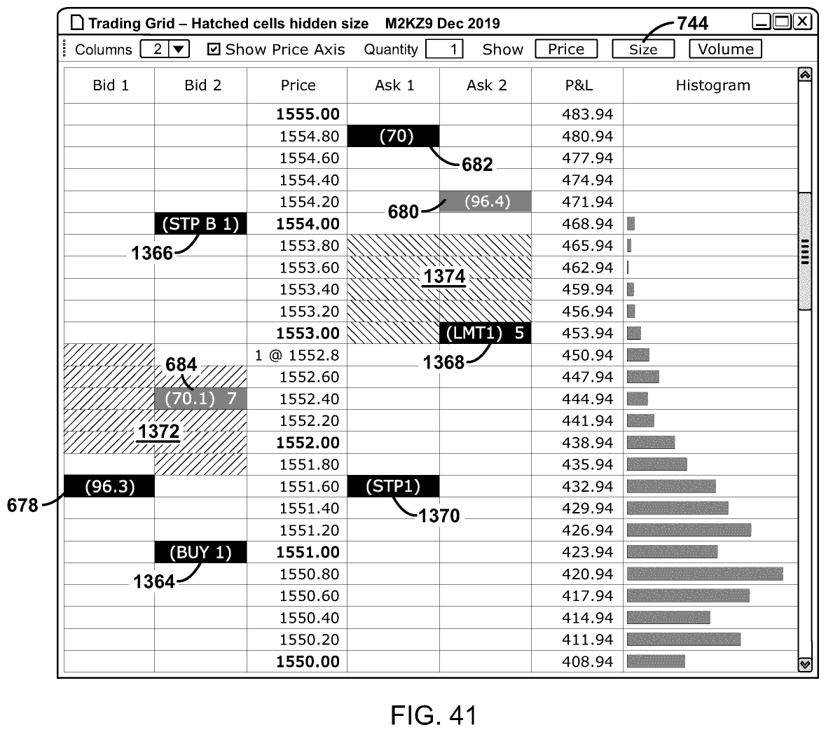

FIG. 41 show the grid with the size toggle button 744 disabled. FIG. 41 also shows some stand-alone order types with no parent or children.

As a result of disabling the size toggle button 744, bid cells with size 1372 and ask cells with size 1374 don't have their bid size and ask size in the cell even though market depth data is available. These cells are only shaded. Parent buy order 678, child sell order 680, parent sell order 682, and child buy order 684 remain the same.

The limit sell order 1368 show a stand-alone order. It tries to display the order quantity “1” and Ask size “5” if space available permits it.

The stop sell order 1370 represent a stand alone stop order. Since no market data is available, the cell only contains an order type “STP” and order quantity “1”.

Limit buy order 1364 is displaying the “BUY” action instead of the order type.

Stop buy order 1366 shows the “STP” for stop order, “B” for buy, “1” for quantity. The text on the cell means “Stop Buy 1 Qty”.

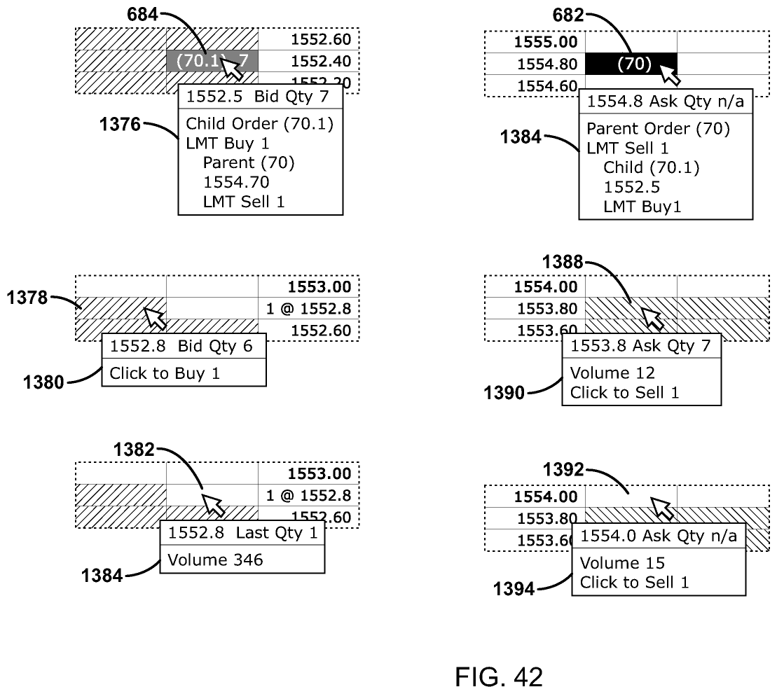

FIG. 42 shows mouse-over on various cells the resulting context sensitive pop-ups.

Mouse-over on a child buy order 684 results in a mouse over popup 1376 which contain details about the child order, the bid quantity on the cell, and the associated price. Additional details of the child order such as order type, order quantity, and parent order details are shown.

Mouse-over on bid cell 1378 results in a mouse over popup 1380 showing a hint of a possible action such as “Click to Buy 1”.

Placing the cursor on last trade cell 1382 shows a mouse over popup 1384 showing the price and quantity of the last trade. Additionally, the volume is also shown in the details of the pop-up. Note that the last trade cell 1382 is above the bid cell 1378 and clicking on the cell would result in a different command. Such commands may include placing a different type of order or have no action at all depending on configuration.

Placing the cursor over the parent sell order 682 shows the mouse over popup 1394. The mouse-over popup 1394 show details of the parent order such as the order type and order quantity and the details of the child order such as the child order's price, order type, and order quantity.

Placing the cursor on an ask cell 1388 displays a mouse over popup 1390 showing the price associated with the cell and the ask quantity. Additional details associated with the cell such as volume traded and an actionable hint is also shown.

Placing the cursor over ask cell with no size info 1392 shows a mouse over popup 1394 which shows the price associated with the cell. The ask quantity is displayed as n/a since no size info is available.

Shown details on the mouse over may be configured by the user by editing the system's mouse-over settings or templates or by creating a new template.

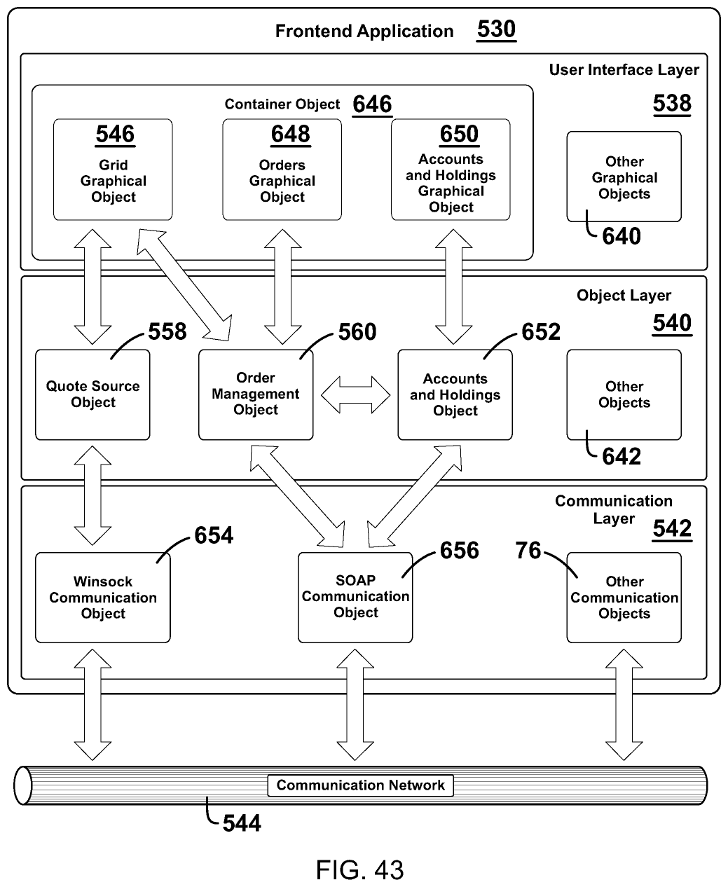

FIG. 43 shows the architecture of the system which includes a Frontend Application 530. The Frontend Application 530 has a three-layer logical architecture, consisting of the user interface layer 538, an object layer 540, and a communication layer 542. This design gives the Frontend Application 530 the advantage of a clean, organized structure, wherein related software functions are grouped in independent layers, each layer communicating with the others using clearly defined programmatic interfaces.

The user interface layer 538 contains components that handle the graphics operations of the grid and other graphical objects. These include the construction of the grid and price axes; displaying information such as quotes, orders, holdings, P&L, alarms, ranges, notes and other grid mappable objects on a cell or a range of cells on the grid and price axes; dynamic operations such as moving and highlighting the cells of the grid and showing the relevant details of the cell; and interactive operations like responding to user actions, e.g. adjusting number of columns displayed on the grid when the user changes a configuration on an appropriate graphical element (e.g. a toolbar textbox).

The object layer 540 groups together components that perform business logic, and components that implement utility functions. The components in this layer: (1) validate users' actions (performed on objects belonging to the user interface layer 538); (2) translate users' actions into commands—if applicable—to be sent to the back-end trading system via the communication layer 542; and (3) process return values, notification messages, or any other data sent by a Market Participant (through the communication layer 542. The object layer 540 serves as an abstraction layer that shields the user interface layer 538 from the implementation of the lower-level communication layer 542.

The communication layer 542 consists of components that act as communication “gateways” between the front end and the backend trading system. Communication which typically use the communication network 544 such as the internet. This layer essentially translates programmatic requests (which are in the native format of the operating system and application platform of the front end) coming from the object layer. That translation may be into Simple Object Access Protocol (SOAP) messages, but any suitable option for facilitating communication may be chosen. It is to be noted that although SOAP maybe the primary protocol for Frontend Application 530, other suitable protocols—such as Winsock—can also be employed.

The communication layer 542 is designed to accommodate the “plug-and-play” addition and removal of communication components, each component implementing a specific type of communication protocol (e.g., Winsock, SOAP) for interfacing with a market participant 534, cloud service 536, or a local device 532. It will now be seen that the Frontend Application 530 is an important feature of the present invention, as it provides a graphically intuitive, fast, user-friendly application that any trader will use in order to view, edit, modify, start, stop, and manage algos and other algo related status, order, quote, predictive fills, and parameter information.

Typically, the Frontend Application 530 operates on a Windows platform, but not necessarily. Other platforms may also be employed including Linux, Android, and other proprietary platforms. Frontend Application 530 may also be made available platform independent by using cross platform technologies e.g., Java, Web Apps.

The Frontend Application 530 consists of a main executable program—which acts as the overall “controller” of the front end—and several software building blocks called “components” or “objects”. In a Microsoft Windows implementation of the front end, the main program is a Component Object Model (COM)-aware Win32 executable, and the software components are COM components. However, in an implementation of the front end for another operating system and application platform, the actual technologies used may be different, but the architecture will remain the same. COM allows the front end to organize functionality into multiple, independent, reusable software building blocks called “components” or “objects”. Although there is a difference between these two terms—a components is made up of one or more objects—the two terms are used interchangeably herein. Each of these components or objects encapsulates distinct software functionality, and interacts with other components through clearly defined programmatic interfaces.

The Frontend Application 530 is similar to conventional Microsoft Windows applications in that it adheres to the visual (e.g., menu structure, status bars, buttons, etc.) and behavioural (e.g., right-click behaviour, resize behaviour, etc.) standards for Windows-based applications. Thus, adherence to these standards by the front end of the present invention significantly eases the learning curve associated with mastering the application's features.

The front end's main executable program controls and manages the lifetimes of the application's various constituent objects—from object creation to object destruction. Furthermore, the main program coordinates the operation of the objects, by passing messages between itself and the objects.

The core of the front end however, is in the set of software objects implementing the bulk of the application's functionality. These software objects fall into two categories: (1) graphical objects, and (2) non-graphical objects. Both types of objects encapsulate software functionality, but the graphical objects also display a visual interface.

The software objects are grouped together, according to functionality, into “layers”. As noted above, there are three layers: (1) the user interface layer 538, (2) the object layer 540, and (3) the communication layer 542.

The most important software object is the grid graphical object 546. It displays Level II quotes in a two-dimensional matrix of multi-colored cells, which it constructs dynamically. The grid graphical object 546 receives its data in real-time (or close to real-time) from a quote server (not shown); the data however, passes through the object layer 540 and the communication layer 542 first. The grid graphical object maybe is hosted inside a container object 646, to facilitate the easy grouping of multiple instances of the grid graphical object, discussed hereafter. The container object 646 is a graphical user interface (GUI) element with the capability to “contain” other graphical objects. An example of a container object is a tab-based dialog object common in Microsoft Windows-based applications.

The orders graphical object 648 is a compound object (i.e., object made up of several smaller objects) which users of the front end utilize to interact with their orders (and all its associated parameters). The orders graphical object 646 may also be hosted inside a container object 646 and may be associated with a specific cell.

The accounts and holdings graphical object 650 is another compound object that displays summary and detailed information about an account and the holdings of the user. This information includes the account balance, order status, account summary, portfolio, fills, etc. Some of this information can be associated with a cell on the grid graphical object 546 such as individual fill prices and quantities, average fill price, P&L.

Each of the three graphical objects described has a counterpart object in the object layer 540. The grid graphical object 546 has a quote source object 558, which encapsulates the logic necessary for requesting and receiving Level II data from the back-end trading system. The orders graphical object 648 has an orders management object 64, which implements the logic and business rules necessary for posting, monitoring, and modifying orders to the backend trading system. The accounts and holdings graphical object 650 have an accounts and holdings object 650, which implements the logic necessary for requesting, receiving, and updating account information from the back-end trading system.

The communication layer 542 has one or more objects that implement the logic involved in translating requests and commands coming from the upper layers of the front-end application 530 into the format expected by the backend. This format conforms to a standard protocol, which is typically based on XML. The communication objects also translate the data coming from the backend trading system into the format expected by the objects in the upper layers of the front-end application 530. In FIG. 4, there are two communication objects: the Winsock communication object 654, which implements the logic for remote communication using the Winsock protocol, and the SOAP communication object 656, which implements the logic necessary for remote communication using the SOAP protocol.

Other objects 640, 642, 674 may be found on each of the respective user interface layer 538, object layer 540, and communication layer 542, as may be determined by a skilled programmer who is familiar with the present invention.

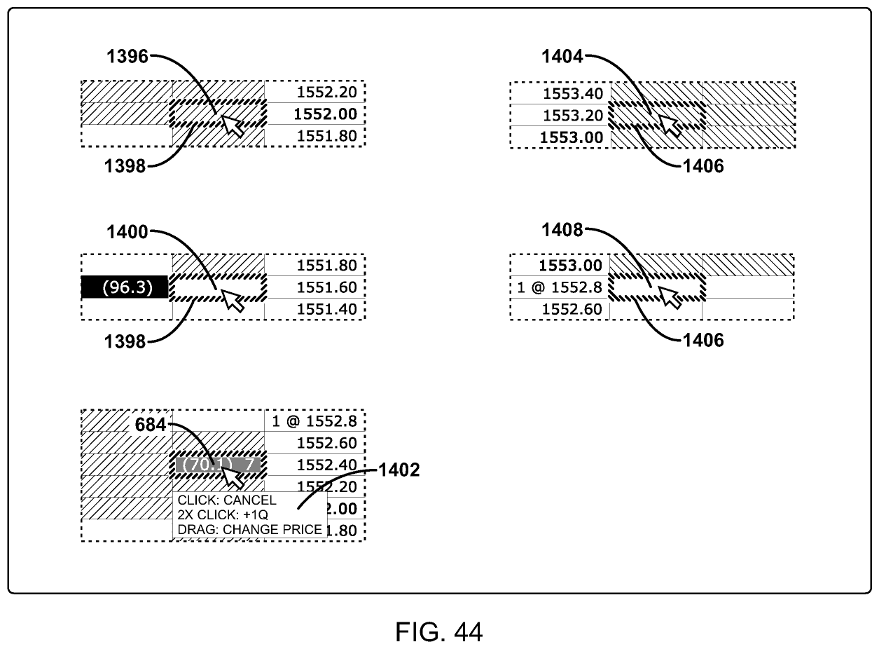

FIG. 44 shows mouse-over and the resulting border variations based on cell context.

A mouse-over on bid cell with size 1396 or bid cell without size 1400 result in a bid border color 1398. Similarly, a mouse-over on an ask cell with size 1404 or ask cell without size 1408 would result to an ask border color 1406.

An example of context sensitive hints 1402 is shown when a mouse-over is performed child buy order 684. The hints 1402 indicate some of the possible actions the user may perform and their corresponding commands. E.g., Clicking on child buy order 684 would result; a double click would increase the quantity of the order, dragging the order would change the price. Depending on the type and contents of the cell where the cursor points, the hints may also change. E.g., a cursor pointed at bid cell without size 1400 may just contain “Click to place Buy order”.

Border colors may be changed thru a config setting. Hints may be configured as for their arrangement and which hints are a priority. As the user gets familiar with the more common functions, the user may prefer to show the more abstract and complex actions and commands. Hints are similar to mouse over cells in FIG. 42 but on a more compact and contain less text which may benefit the trader in the way that there are less distractions.

Context sensitive hints can be combined with the features of FIG. 42 in such a way that the more detailed FIG. 42 mouse-over details are shown after a displaying the context sensitive hints for a certain amount of time. (e.g., 5 seconds).

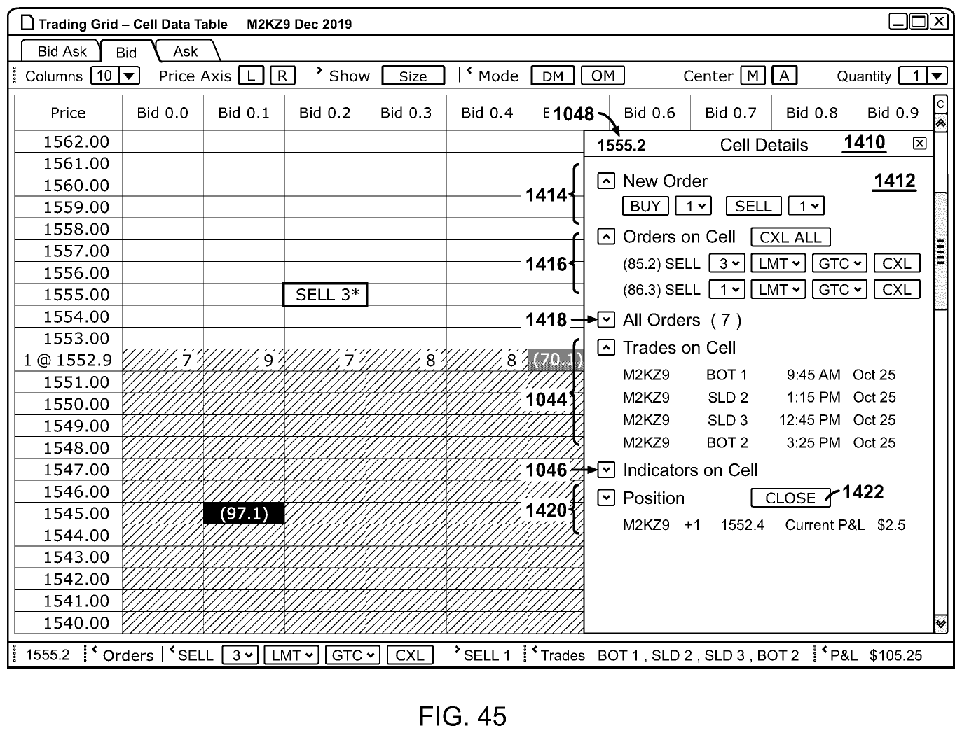

FIG. 45 show the Cell Details table 1412 where a more detailed data related to the selected cell is shown.

Title bar 1410 show the name of the tool window. Title bar 1410 can be dragged and dropped around the user's screens to change its position. The tool window can be docked to the window or made to float freely.

The selected cell price 1048 show the price or price range associated with the cell. Actions and data shown in the table are mostly linked to price or price range displayed by the selected cell price 1048.

New Order panel 1414 allows the placing of new orders on the cell. The BUY or SELL button can be clicked to place an order. The new order will have the price indicated by selected cell price 1048.

If a different price is desired, the BUY or SELL button can be dragged and drop into a different cell to place a new order on the drop target cell. Depending on user setting, the selected cell may change to the drop target cell and the Cell Detail table may update its content to show the details of the new selected cell. The user may also opt to just have the new order place while maintaining the selected cell and not move the target drop cell.

A Buy order will have the quantity indicated by the number on the combo box on the right of the BUY button. A Sell order will have the quantity indicated by the number on the combo box on the right of the SELL button. The quantity of a Buy order or a Sell Order can be changed.

Orders on Cell panel 1416 shows the order that are present on the price range represented by the cell. Order details such as order key, order action, and editable parameters are displayed on each row depending on user preferences.

Users can mouse-over on ‘(85.2)’ to highlight the related orders (parent, children, siblings) on the grid. All orders can be cancelled by using the ‘CXL ALL’ button. Individual orders can be cancelled individually using ‘CXL’ button found on the order's row.

Order parameters can be changed like quantity, order type, and order validity. Price can be changed by drag and drop the order row onto a cell on the grid or a dialog shown after a right-click on an order row. All orders panel 1418 show all orders of the security. A config setting can be turned On by the user to display only BOT fills or only SLD fills which may be dependent on the type of tab that is currently displayed.

Trades panel 1044 show the trades that occurred on the selected cell. Each row represents a fill or partial fill. Each row can also be configured to show an order instead of individual fills.

Indicators panel 1046 contain the types of indicator whose values may fall on the price associated with the cell. In this case, none are present on the cell.

Position panel 1420 show the user's current holdings. The symbol, position size, average price, and current P&L is shown. Mouse over on the position can show extra detail such as Market value, market price, trades, Unrealized P&L, and Realized P&L. When the user has a position or holdings, they can have the position indicated on the cell average buy price, average sell price, last BOT price, last SELL price, or any value that can be associated with the position. The position can be represented an icon, quantity, border color, animation, text label, and other visual indicator on the cell. E.g., a cell can show a label “LONG +1”, “Average”, “AVG”, “AVG BOT” on the cell 1552.4 to indicate the average price of the user's position as shown in position panel 1420. The average price can also be shown with 2 or more decimal digits in a cell to convey the average buy price or average sell price with more accuracy. Additionally, a cell P&L can be displayed on each cell that will indicate the possible P&L should the user place an order on a cell and gets filled. The cell P&L display on the grid can be toggled On/Off using a control like a toggle icon on a tool. Cell P&L can also be displayed less intrusively by displaying the P&L on the cell during a mouse-over. Cell P&L can also be displayed on a pop-up or tooltip during a mouse-over to avoid clutter. The average price or any visual indicator on the cell to represent holdings can change color to represent profit or loss. E.g., The Avg. Price of Holdings can change Font color, Red, Blue, Green, to indicate Loss or Profit. It would also help in Taking a Profit, buying back under the Avg. Price to Lower the Average Price, etc. E.g., if the Trader is scalping around the Breakeven Price. The Close button 1422 allows the user to close position's using the price indicated at selected cell price 1048. The ‘Current P&L $2.5’ show the P&L of the position if the position is closed on the price of the cell as indicated by selected cell price 1048.

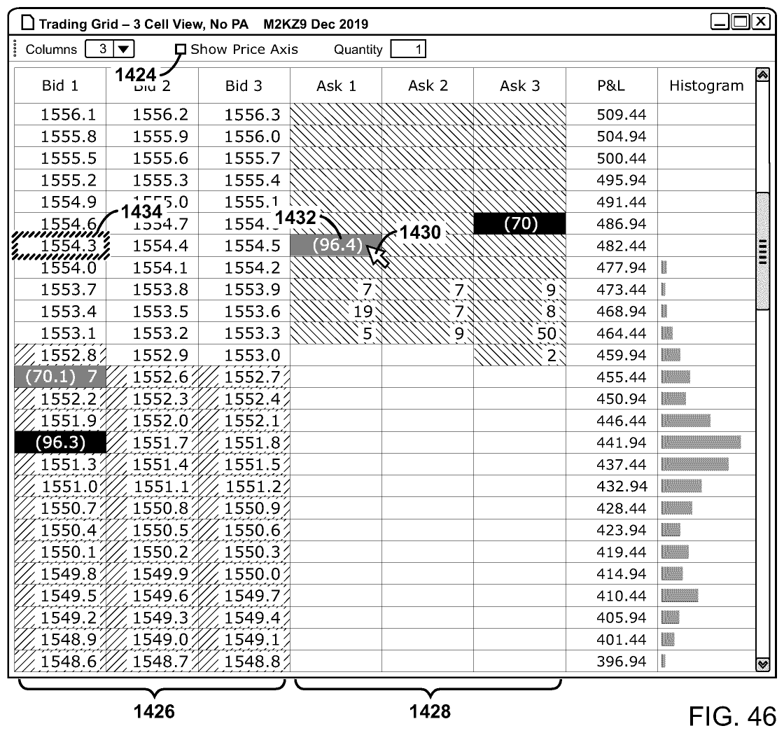

FIG. 46 shows a mixed mode cell label display where Bid columns 1426 is shown with a price label while Ask columns 1428 is shown is Ask size if available. Orders are still displayed on both sides.

No Price axis column is present because the Show Price Axis checkbox 1424 is unchecked.

Mouse cursor 1430 is positioned over ask cell 1432 and Bid columns 1426 the price of the cell is shown to the user by bid cell highlight 1434. This allows the user to see the exact price of an ask cell without a Price axis column.

The grid may be configured such that when the mouse is over the Bid columns 1426, the cell labels shown in the Bid columns 1426 will become bid quantities while the cell labels of Ask columns 1428 will become price labels. By doing this, the price of a bid cell can be highlighted on the Ask columns 1428.

Which label shown on a mouse over and which label shown on the non-mouse over can be configured by the user. For example, the mouse cursor 1430 can be positioned over the cell of bid cell highlight 1434 and the price would be displayed while the highlight shown instead on ask cell 1432.

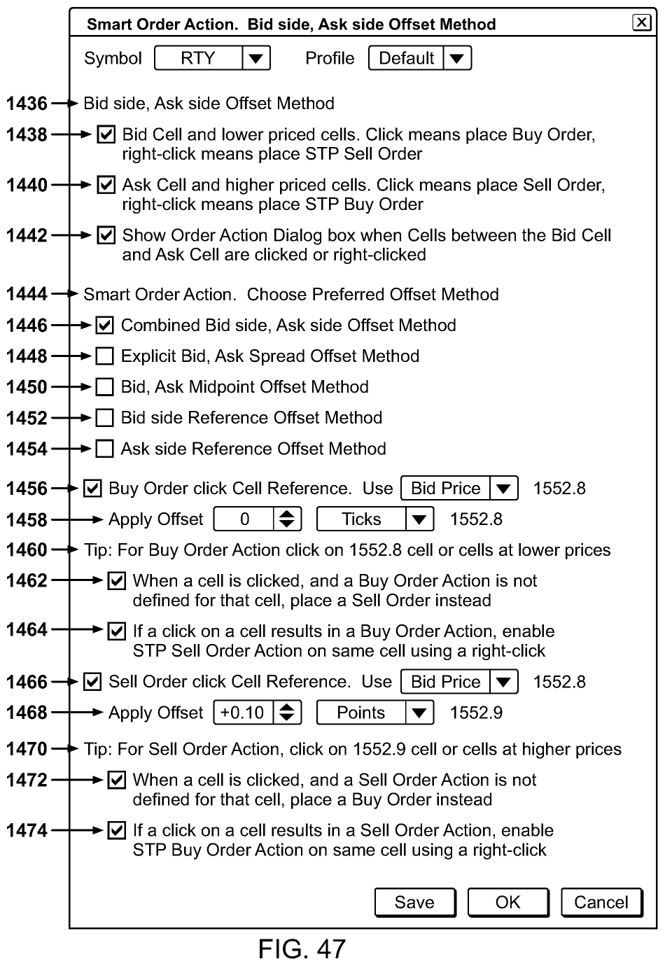

FIG. 47 shows settings for the Smart Order Action, Bid Side, Ask Side offset method.

Bid side, Ask side Offset Method section 1436 contain settings on how the grid responds to clicks and right-clicks on the cells in the context of bid cells and ask cells. The settings are: (1) Checkbox 1438 Bid Cell and lower priced cells. Click means place Buy Order, right-click means place STP Sell Order; (2) Checkbox 1440 Ask Cell and higher priced cells. Click means place Sell Order, right-click means place STP Buy Order. (3) Checkbox 1442 Show Order Action Dialog box when Cells between the Bid Cell and Ask Cell are clicked or right-clicked.

Smart Order Action Preferred Offset Method section 1444 contain settings on which offset method to use when the Smart order action is activated. The settings are: (1) Checkbox 1446 Combined Bid side, Ask side Offset Method; (2) Checkbox 1448 Explicit Bid, Ask Spread Offset Method; (3) Checkbox 1450 Bid, Ask Midpoint Offset Method; (4) Checkbox 1452 Bid side Reference Offset Method; (5) Checkbox 1454 Ask side Reference Offset Method.

Checkbox 1456 enables the Buy Order click Cell Reference. The price used for a buy order can be configured on the combo box and the current value of the selected option is displayed to right. Any action below the chosen Cell Reference will be considered as an intent to place a Buy Order. Some of the other options that can be seen on this combo box are Ask Price, Last Price, Bid-Ask midpoint. Settings 1458 allow an offset to be configured which will change where the Cell Reference is. The offset can be configured in ticks, points, or order units; Tip textbox 1460 show the user a helpful hint on what action to perform to do a Buy Order Action. There are two additional buy click order action settings: (1) Checkbox 1462 When a cell is clicked, and a Buy Order Action is not defined for that cell, place a Sell Order instead; (2) Checkbox 1464 If a click on a cell results in a Buy Order Action, enable STP Sell Order Action on same cell using a right-click.

Checkbox 1466 enables the Sell Order click Cell Reference. The price used to as reference to determine when a user intends to perform a sell order can be configured here. The same cell reference is chosen as in the settings of checkbox 1456. Having the same reference used for the checkbox 1456 and checkbox 1466 will cause ambiguity of whether the user intends to place a Buy Order or a Sell order. To solve this, a +0.10 point offset is configured on the settings 1468. Tip textbox 1470 show the user a hint on what action to perform to do a Sell Order Action. An additional two sell order click settings can be enabled by the user: (1) Checkbox 1472 When a cell is clicked, and a Sell Order Action is not defined for that cell, place a Buy Order instead; (2) Checkbox 1474 If a click on a cell results in a Sell Order Action, enable STP Buy Order Action on same cell using a right-click.

Aside from Bid Price and Ask Price, other market data or indicator value can be used as reference. Some market data examples are Bid-Ask Midpoint, Last price. In addition to from Ticks and Points as offset units, Order tick units can also be used.

These offset schemes can be applied to the Bid columns and Ask columns of FIG. 1. For example, both a Buy Order or a STP Sell Order can be inputted using a click on the Bid side column depending on where a click occurred in a column. One of the reference Offset Cell on the Bid column can be the Bid Cell and any clicks on or below the Bid Cell can be treated as a Buy Order action while any clicks above the Bid Cell can be treated as a STP Sell order.

Two offset inputs can also be used. One for Buy Action Order and one for STP Buy Action. If any conflict should arise from using two Offset inputs, such conflicts can be resolved by one of the Order Action dialogs. This allows the user to map two Order actions to the same button click on grids with separate Bid side and Ask side. Otherwise, any click above the Best Bid cell and any click below the Best Ask cell will just result in immediate fills.

An example setting for a Buy Order offset is a checkbox that has ‘Enable Buy Order Submit on Click or Tap. Bid Cell Offset (−1) and lower means submit a Buy Order’ where the user can freely change (−1) to another number as to prevent orders very close to the market and risk of immediate fills. A more negative number means lower than the Bid cell price.

An example setting for a STP Buy Order offset is a checkbox that contains ‘Enable STP Buy Order Submit on Click or Tap. Bid Cell Offset (+1) and higher means submit a STP Buy Order’ where the user can freely change the (+1) to any number. A more positive number means higher than the bid price.

Any conflict or overlap between the Buy Order offset and STP Buy Order offset can be resolved by showing an Order Action dialog. Conflicts can also just be ignored and the user just be given an audio or visual warning like dings and tooltips as a sign that their inputs are ignored.

On occasions of high volatility like the Covid-19 selloff of February, March of 2020, the system can switch to a different set of offset and other settings that take into account the higher trading ranges and spreads. When the system detects high volatility, a new set of config settings can be loaded and applied to the grid to accommodate and provide additional safety for the more volatile trading ranges. After the system detects low volatility, the system can revert back to offset setting prior to the high volatility event. The user can also manually load settings whenever desired.

Volatility can be detected by the system in various ways. Some of them include an increase in VIX or specific VIX value, an increase in price velocity or Session Range, Weekly price Range or some explicit measure of Range, e.g., 60 pt move in a session, a brokerage, Exchange, or SEC designation for fast market conditions, etc.

When using the Offset settings, Click Order input, and users report of input errors happening because of some UI behavior during fast market or volatile conditions, a solution can be devised to solve or reduced errors by adjust the necessary Offset Config and other settings.

Users of the Offset, Click Order input might complain that some UI behaviour is causing user input errors. A solution can then be devised that include the necessary Offset Config, fast market inputs to solve or reduce such input errors in a fast market, under volatile conditions.

User can also be presented with an Alert message to perhaps consider using a Grid with a more visible price range and informed that a fast market exists for the symbol they are trading.

The default setting of the system to treat any clicks on or below the Bid Cell reference as Buy Action and any clicks on or above the Ask Cell reference and similar cell interaction—order action pairs can be customized by the user. For example, they can also set clicks on or below the Bid Cells as STP Buy order actions so all clicks on the Bid Side grid are treated as STP Buy order actions. Order Action does not change after the 1st click or right-click. Once the Order is created, clicking on it will cancel or remove it if that option is the user preference. The Order can also be drag and dropped to a new location and the Order type will not change as the default behavior. There can be an option to “[x] Change the Order Type on a drag & drop, using Smart Order Action rules”. The UI becomes flexible for some user's may like this Order, UI behavior when they drag & drop near the Bid, Ask spread cells area.

If an order action could result in an instant fill, user can enable a setting that will warn them of the possible instant fill event. Before the possible instant fill is submitted to the back-end, users can be presented a confirmation dialog that tells the user of the possible instant fill event. In the shown dialog, the user will have the ability to confirm or cancel the possible instant fill event. One of the Smart Order action dialogs can also be shown to the user instead of the simple confirm or cancel dialog boxes to give the user more information and control over the instant fill event.

A visual marker like a nib or color on the cell edges can be shown between one Order Action and another. This is pretty intuitive, to see where the dividing, separation is visually. Each Cell has 4 edges so one or more edges of each cell can be colored where click or right-click, Tap would mean a different Order Type would be submitted. E.g. Buy, STP Buy, or Buy, Sell, etc.

The visual marker on grid is conspicuous, easy to be aware of. The marker or visual indication can be where the two cells meet which serve as the demarcation line. i.e., Along the common edge of the two cells where the click, right-click, or Tap action result in different Order actions being submitted to the brokerage backend, to the Exchange.

The marker can also be placed on any side of the 4 sides of each cell. The width, height, color of the marker can be adjustable if desired. The marker can be one color, or 2 colors to indicate which Order Action occurs on each side of the click, right-click, or Tap, Swipe, etc. Typically, the marker is the same height of each cell and 2-3 pixel in width and colored in a visually distinct manner to the grid and grid background. A mouseover may result in a Tooltip of what the marker means and what each mouse or user action means for Order Action, Order submit.

Some Order Action Visual Markers that can be used are Cell Borders or Bold Edges, Nib to indicate dividing line between one Order Action and another. Cell Borders may be colored to show distinction between Buy & Sell Order Click Cells, or Buy & STP Buy click Cells.

On FIG. 1, since the Grid is a Single Column, the Nib would appear between two Cells near the Bid, Ask prices in each column. Technically, each Grid, column could have the Nib in a different location depending on the Offset scheme and Offset input value used.

The Order Action Visual Marker may always be displayed or only displayed on certain times. For example, the visual indicators are hidden until the Grid is Hot and interacting with the cells will result in an order being sent. The visual indicators may also be hidden by default and only be displayed once the cursor is over a cell. Aside from the mouse-over cell, the neighboring cells may also display the visual indicators to aid the user.

A feature like the Position Guide can also be used in tandem with the click inputs. The Position Guide determines whether a Drag & drop is a Buy or Sell Order by selecting which Position Guide with the desired Order Action is dragged. Now, with the Smart Order Action Offset scheme, on which Cell an Order or ‘PG’ Icon is dropped can determine whether the Order was a Buy or Sell Order. A Right-click could Toggle the PG Icon to a STP Buy or STP Sell Order Action. The “PG” Text on the Icon can change to “STP” on a right-click action on the PG Icon, so the user could Toggle from Buy, Sell side to STP Buy, STP Sell side Order Actions before a Drag and Drop of the Order & Quantity to the Grid. The Color of the PG Icon can also change to show the Default Order Action is not Standard. During the Actual Drag & Drop when user is in the Grid, the “PG” Text may even change to “Buy” or “Sell” with a Blue or Red color to indicate the Order Action depending on which cell the user's cursor, drag & drop location is.

One great feature of Drag & Drop on a Grid is that the Order Action is not completed until the Drop Action is completed. So, the Action can be discarded by dropping the Order away from the Grid itself. If the Drag & Drop action is on the Grid, user would see the Cell Dock border as is convention in some Grids.

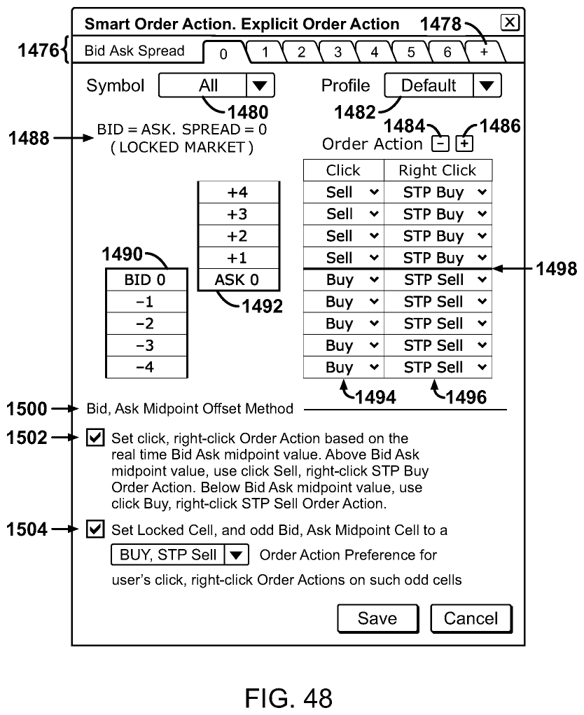

FIG. 48 show settings for the Smart Order Action, Explicit Order Action feature. The Explicit Order Action feature help the user to precisely define the order actions for each cell for a specific spread condition.

Tabset 1476 show spread settings as tabs. Each tab label corresponds to a spread. User can add a spread setting by pressing the add tab 1478.

The symbol of which the settings apply to is indicated by Symbol combo box 1480. The user can change which symbol to edit by selecting a Symbol combo box 1480. A special item in the Symbol combo box 1480 is the ‘All’ item which means that the settings found on the settings window will apply to All symbols instead of just applying to one symbol. Aside from the ‘All’ item, other targeted groupings can also be shown on the Symbol combo box such as ‘Options’ which would only apply to Options, ‘Stocks’ which would only apply to Stocks.

User can also use custom groups in which only the symbols indicated on the group would be affected by the settings. Profiles for the selected symbol can be loaded by selecting an option in the Profile combo box 1482. Profiles can be useful if the user wants to quickly able to save and load various settings on one symbol.

A short description or title is shown on setting description 1488. The purpose of the settings tab or a note from the user can be edited so the user can better understand the purpose of the settings page which can be especially useful when the user has multiple settings profiles for specific purposes. The user will be able to identify the purpose of each setting page just by looking at the setting description 1488 instead of the time consuming inspection of the settings especially when different settings profile only differs by a setting or two.

The Trim buttons move separator line 1498 up, down cell by cell so the user doesn't need to go into each Cell. Separator line 1498 can also be dragged and dropped for the same effect. Minus button 1484 moves the separator line 1498 down and plus button 1486 moves the separator line 1498 up.

On the bid cells 1490, the top most cell BID 0 is the best bid. The numbers inside the cell show the position of each cell with respect to the best bid. On the ask cells 1492, the bottom most cell ASK 0 is the best ask and the numbers shown the cells above the best ask indicate the position of the ask cell with respect to the best ask. BID 0 and ASK 0 in the row means they have the same price and that is typical of a locked market.

The resulting order of a click action on a cell can be found on the Click action column 1496 white the resulting order of a right click on a cell can be found on Right Click action column 1496.

Bid, Ask Midpoint offset Method section 1500 contain settings on how the grid interact with the feature. These settings include (1) Checkbox 1502 Set click, right-click Order Action based on the real time Bid Ask midpoint value. Above Bid Ask midpoint value, use click Sell, right-click STP Buy Order Action. Below Bid Ask midpoint value, use click Buy, right-click STP Sell Order Action; (2) Checkbox 1504 Set Locked Cell, and odd Bid, Ask Midpoint Cell to an <Buy, sell, STP, order action> Preference for user's click, right-click Order Actions on such odd cells.

Some mice have more buttons than just the basic Click and Right Click. The Click and Right Click can be changed and mapped to these other buttons.

Additional action columns can be used if the user want other explicit order actions to be mapped onto additional buttons. It is not required that each order action column map into a different type of order, a Click and Right Click can be mapped to send the same order action which can be a useful redundancy, for example in hardware malfunctions. Aside from Buy, Sell, STP Buy, and STP Sell orders, other order types and supported plug-in functions can be mapped as Order Action.

Bid, Ask Spread settings can be accessed via Tabs, buttons along a Row or in a left side, right side set of menu buttons.

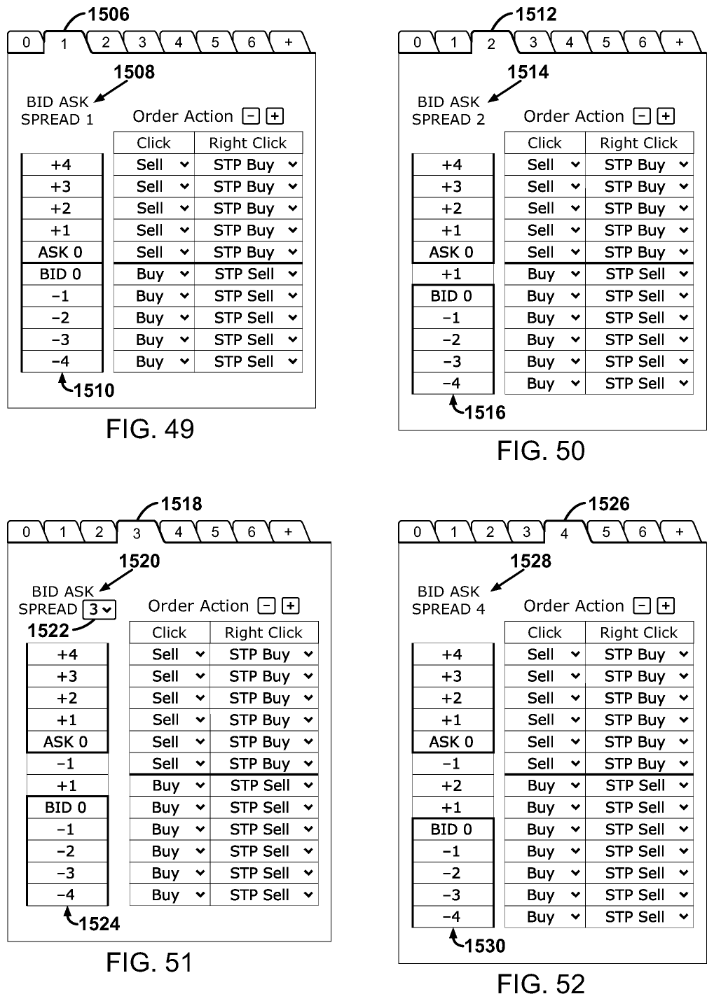

FIGS. 49 to 52 show the setting tab pages of spreads 1 to 4 of the Smart Order Action Explicit Order Action feature.

FIG. 49 shows Bid-Ask spread 1 tab 1506 selected and the description is shown on the tab description 1508. Bid-ask spread column 1510 shows the bid cells and ask cells in a single column since there's no overlap.

FIG. 50 shows Bid-Ask spread 2 tab 1512 selected and the description is shown on the tab description 1514. Bid-ask spread column 1516 shows 1 cell between ‘ASK 0’ cell and ‘BID 0’ cell. The ‘+1’ cell represents the bias too the Bid side. If there is a bias to the Ask side, the label would be ‘-1’ instead of ‘+1’.

FIG. 51 shows Bid-Ask spread 3 tab 1518 selected and the description is shown on the tab description 1520. FIG. 51 shows a variation where a spread value dropdown 1522 is present and which can allow the user to set the tab as a configuration for any custom spread. Bid-ask spread column 1524 shows 2 cells between ‘ASK 0’ cell and ‘BID 0’ cell.

FIG. 52 show Bid-Ask spread tab 1526—Bid-Ask spread 3 tab 1518 selected and the description is shown on the tab description 1528. Bid-ask spread column 1530 shows 3 cells between ‘ASK 0’ cell and ‘BID 0’ cell. The ‘+2’ is the label of the middle cell since the Order Action is biased on the Bid side. If there was bias on the Ask side, the label would be ‘−2’ instead of ‘+1’.

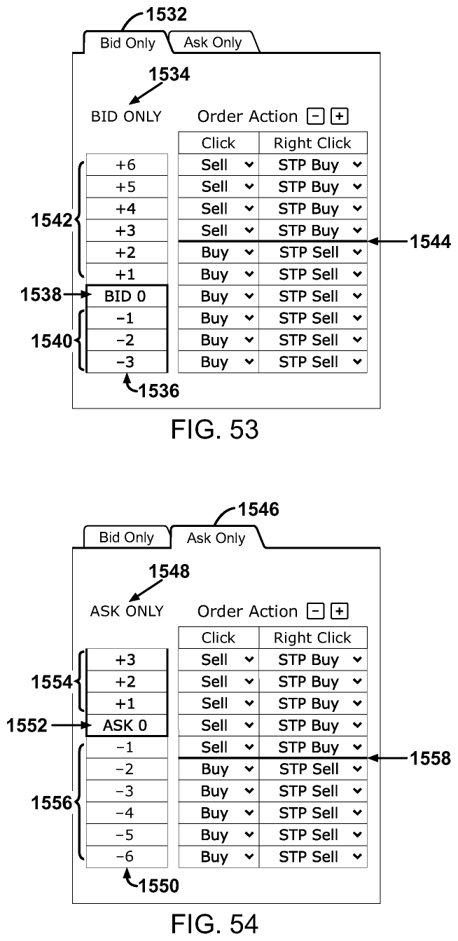

FIGS. 53-54 show the setting tab pages the Bid only, Ask only method of the Smart Order Action Explicit Order Action feature.

FIG. 53 show the Bid Only setting tab page. The reference for both Buy and Sell action only rely on the best bid.

Tab 1532 bid only is selected and the selection is echoed on tab description 1534. Bid-ask spread column 1536 only contains bid cell 1540 which is a ‘BID 0’ cell and no ‘ASK 0’ cell. One of the cells in the Cells above bid 1542 was set to be the reference point of Sell actions as can be seen where the separator line 1544 is.

Clicks on the bid cell 1540 are interpreted as Buy actions and right clicks are treated as Stop Sell actions. Clicks on the Cells above bid 1542 are interpreted as Sell actions while right clicks are interpreted as Stop Buy actions.

Other market data values can also be used like Last can also be used as a replacement for Bid and Ask values. In addition, computed values like Bid-Ask midpoint or value of an indicator can also be used as reference of the Explicit Order Action feature.

FIG. 54 show a settings tab page where only the Best Ask is used as the reference for both Buy and Sell order actions.

Ask only tab 1546 is selected and the tab description 1548 is updated.

In the bid-ask spread column 1550 only ask cells are present. The best ask can be found on ask cell 1552 and is the basis for both Buy and Sell click and right-click actions. There are only cells above ask 1554 and cells below ask 1556. One of the cells in the Cells above bid 1542 was set to be the reference point of Buy and Sell, Click and Right-click actions. Any click below the ‘−1’ cell becomes a Buy order and any click on or above the ‘−2’ cell becomes a Sell order action.

The input method of click and right-click shown on the settings of FIG. 48-54 can be customized with other input types. e.g., On touch screens, gestures like swipe left can replace click and swipe right can replace right-click.

It is not required that one output order or action is mapped strictly on one input. e.g., a click, tap, and swipe left can result in the same Buy order provided that they are done on the same target. Similarly, a right-click, double tap, and swipe right can result in the same STP Sell order provided the input is done on the same target.

Precision maybe hard to achieve on small screens, in which case the user may opt to enable a magnifier which provides a better visibility of the target cell by highlighting the cell just before an order is submitted. Alternatively, a toolbar which contain toggle buttons of the various order types or actions can be used to determine the output type, after selecting an output type, the user clicks on the cell to place the selected order.

The user can also display on the toolbar the frequent input methods they use and their resulting output. The common outputs can be displayed beside the input method so the user can then modify the output of an input method quickly. The output choices can be listed as toggle buttons, radio buttons, or as items in a combo box. For example, the user can have Click displayed on the toolbar and beside it is two toggle buttons ‘LMT’ and ‘STP’ which allow the user to quickly switch between the two. The user can enable one button to enable response to the input or have none enabled to prevent accidental orders. Hotkeys maybe assigned to the output options so the user can have the ability of changing orders while the cursor stays near the target cell. Multiple buttons and their outputs maybe displayed, e.g., both mappings for Click and Right-click can be shown to the user and their mapped outputs and output choices so the user can freely switch between output choices for the two input methods. Order Conflicts can be resolved by showing an Order Action dialog.

FIG. 55 shows settings for the Cell Price Intervals. These settings help the user to define how values are mapped into a cell.

The symbol of which the settings apply to is indicated by symbol dropdown 1560. If the symbol is a future, option, or any security with expiry dates then the most active contract is shown on the symbol contract echo text 1562 so the user can confirm if they have inputted the correct symbol. The profile dropdown 1564 allows the user to save, load, create, and delete profile settings.

Cell Interval Size section 1566 contain settings on how the interval size of a cell is determined. These settings are: (1) Checkbox 1568 allow the user to use Contract/Shares Minimum Tick and increments of it to define the Cell Interval Size. By default, the value shown in the spinner is the Contract Minimum Tick. The user can change this value by increments of the Minimum tick thru clicking the up-down buttons, gesture, or using the mouse scroll wheel on the spinner. The value can also be changed into other values by typing into the spinner; (2) Checkbox 1570 allow the user to define cell interval size by tick count. The default tick count is the Contract Minimum Tick but can be changed thru a setting.

Cell Price Interval. Custom Settings section 1572 contain settings on how the cell price interval can be configured. The settings are: (1) Checkbox 1574 enables the user to configure the Cell Price interval using a number and a unit like ticks, order ticks, dollar value, and points. The echo text 1576 show the resulting price interval of the settings on checkbox 1574; (2) Checkbox 1578 allow the user to configure a cell price interval using a Price Range and a number of cells. The cell price interval is calculated for the user and the resulting cell price interval is shown in echo text 1580.

Cell Price Interval. Mutually Exclusive price settings section 1582 contain settings on how the endpoints of cell price interval of cells are defined if applicable. The settings are: (1) Radio button 1584 Not applicable. Single Tick, value per cell can only be used since the cells only represent a single price point; (2) Radio button 1586 Cell price interval pattern Begin Inclusive, End Exclusive; (3) Radio button 1588 Cell price interval pattern Begin Exclusive, End Inclusive.

Cell Label. Display Formatting section 1590 contain options on how a label is displayed on a cell. The settings include (1) Radio button 1592 Single Tick value (based on Symbol's Minimum Tick Interval) can be used if there's only a single value associated with the cell; (2) Radio button 1594, 1596, 1598 can be chosen if the cell is associated with a price range. A preview of the resulting label is also shown on the right of each radio button.

Setting 1600 contain setting on how the label is presented to the user. Labels may be formatted using a format textbox where the user can control what part of the label is shown, whether there are commas, currency symbols, number of significant digits and whether to show or hide a decimal point. Tip text 1602 show instruction on how to use setting 1600.

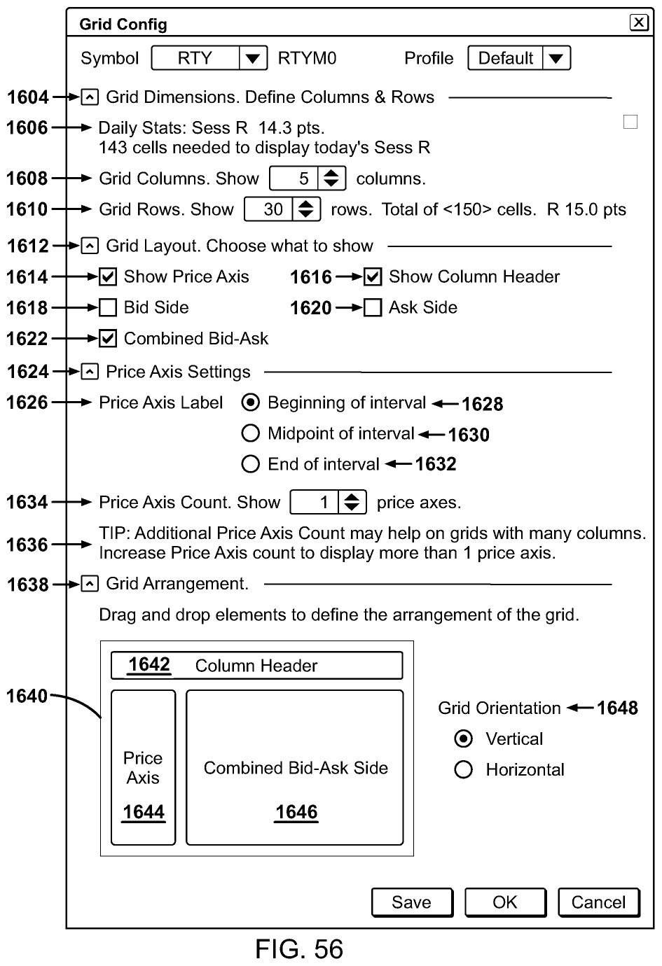

FIG. 56 show config settings that involve Grid rows and columns, price axis, and the general layout of the grid.

Grid Dimensions. Define Columns & Rows section 1604 contain settings on how to define the number of columns and rows on the Grid. The settings are: (1) Daily stats text 1606 shows Sess R and how many cells with a cell price interval of the Min Tick are needed to display the entire range. Such information is shown to the user to help decide the size of the Grid; (2) Setting 1608 allow the user to set the number of columns Grid; (3) Setting 1610 allow the user to set the number of rows of the Grid. The resulting number of cells is also shown which is a product of the values on setting 1608 and setting 1610.

Grid Layout section 1612 contain settings that allow the user to what elements can be seen on the grid. The settings are: (1) Checkbox 1614 Show Price Axis allows the user to show/hide the price axis column; (2) Checkbox 1616 Show Column Header allow the user to show/hide the column headers; (3) Checkbox 1618 and checkbox 1620 allow the user to show/hide the ask side and bide side grids. Both bid side and ask side can be enabled or only one can be enabled. Neither can be enabled checkbox 1622 is enabled; (4) Checkbox 1622 Combined Bid-Ask can be checked to display the combined bid-ask grid. If checkbox 1622 is enabled, checkbox 1618 and checkbox 1620 cannot be enabled. If the user wishes to only enable Bid side or only enable Ask side, checkbox 1622 will be disabled.

Price Axis Settings section 1624 contains settings that affect the Price Axis columns present on the grid. Price Axis Label settings 1626 contain settings that affect which label is shown to the user. The Price Axis label can also be configured to accept formats similar to FIG. 55 setting 1600. The Price Axis label can be any one of radio button 1628 Beginning of interval, radio button 1630 Midpoint of interval, or radio button 1632 End of interval.

Setting 1634 contain setting that allow the user to configure the number of price axes present on the Grid. More than one price axis can be placed on the grid. More than one price axis may be useful on a grid with a large count of columns and/or rows. Cells nearer a price axis can be referenced easier to a price axis so putting a price on both the left and right, top and bottom, and/or in between columns or rows would allow easier referencing of cells. Tip text 1636 contain a hint on how setting 1634 may be used.

Grid arrangement section 1638 contain settings that allow the user to arrange the elements of a Grid. Grid arrangement layout editor 1640 allow the user to arrange the elements of a grid. Column Header placeholder 1642, Price Axis placeholder 1644, and Combined Bid-Ask side placeholder 1646 may be moved around inside the Grid arrangement layout editor 1640 to a layout that the user prefers.

Grid orientation settings 1648 allow the user to set if the Grid is shown vertical or horizontal. In case of a horizontal grid, the price axis and column headers will be transposed. Column headers will instead become row headers and the price axis will be horizontal.

If the grid is very tall, multiple column headers may also be used for easier referencing of the cell's price. Column headers may be put on the sides of the grid or in between rows. A movable column header which can be positioned between rows can be used as a ruler if the user wants a header nearer to a particular row or rows.

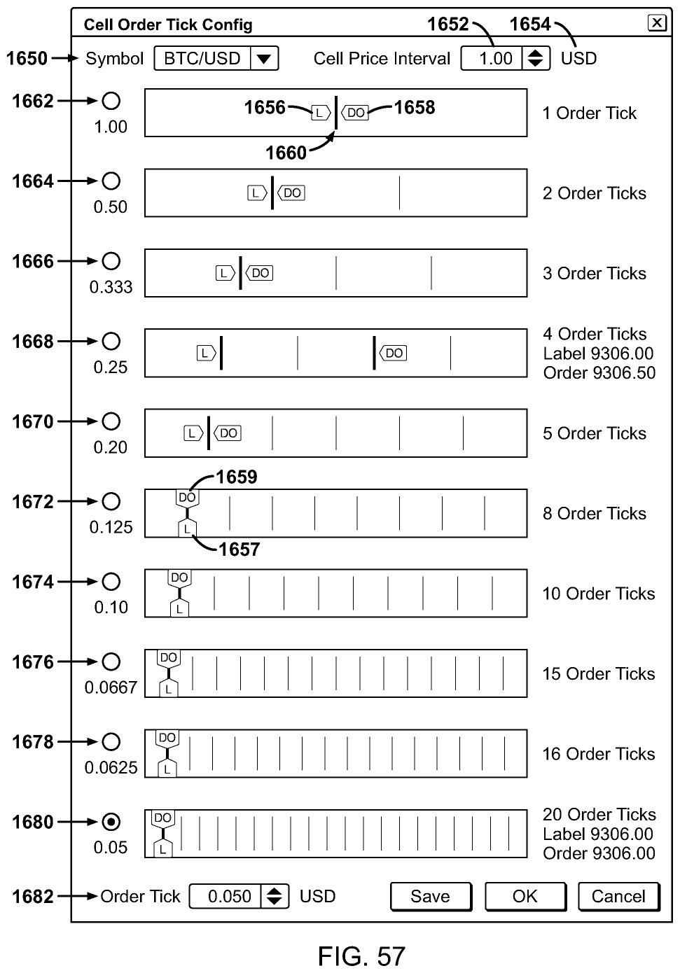

FIG. 57 show the Cell Order Tick config where the user can configure the Order Tick value.

Ordinarily, securities products such as stocks and futures, currencies that are traded on an exchange or stock market have a practical Tick increment. In recent years, with the introduction of crypto currencies and micro payments, the underlying asset such as Bitcoin or Ether can have a minimum Tick or precision which is so small that it is not practical to create a Grid or a cell which can represent a single Tick. So, a solution is needed to allow the daily price moves of such crypto currencies and related micro payment schemes, digital currencies to be traded in a practical default increment even when a higher precision is available. One solution is to have a Tick size or Cell interval that can roughly cover the Buy & Sell commissions of a Crypto Trade or thereabouts. E.g., RTY has 10 Ticks per Point and $50 per Point per Contract. So, 1 Tick is $5 and the Buy, Sell commission is $2.05 each or thereabouts. So, a single Tick of profit, a single Tick of Price move can cover the Buy, Sell Trade Pair commissions and give the Trader some $0.90 of Profit. Similarly, m2k has a Buy, Sell commission of $0.47 and each m2K contract is $5 per point or $0.50 cents per Tick. Thus, a trader needs a profit of 2 Ticks to cover their Buy, Sell commissions more or less with a Brokerage firm. Once the commissions for a Crypto Buy, Sell Pair are known, it can thus be used as a guide for how to select a practical crypto Tick for each Crypto Asset per Crypto Token being traded as the default Token size, e.g., BTC or ETH Tokens.

Symbol combo box 1650 contains the symbol of which the settings apply to. The user can switch to other symbols by typing or selecting an item on the combo box.

Cell price interval setting 1658 show the current Cell Price Interval. The setting can be changed by editing the value inside value or using the up-down buttons. The tick unit 1654 shows the unit of the Cell Price interval.

Label pointer 1656 indicates which tick is shown as a cell's label. Default Order pointer 1658 indicates which tick an order takes its price from when it is placed on a cell. Tick mark 1660 highlights which tick the pointers are on.

Each Tick mark 1660 represent a particular Order Tick value. The left most tick marks have the lowest Order Tick value while the right most have the highest Order Tick value.

Positions of the Label pointer 1656 and Default Order pointer 1658 can be changed by drag and dropping the pointers. It should be noted that the Cell has a value and this value is usually shown as a Text Label on the cell. The cell can also have an interval, but if the cell holds just 1 Tick at a single, precise, specific price value, then the tick increment can be determined by the price difference between 2 adjacent cells on the Grid. Thus, when choosing a Tick choice or recommendation, a Tick interval or minimum Tick can be chosen between Cells that will cover the Buy & Sell commission of a single, default quantity, trade easily, up to where we need 5 to 10 Cells to cover the Buy & Sell commission. The 5 to 10 Cells is roughly a Row on the Grid of 5 cells or 10 cells, so the user knows, after some experience, how to space their Buy & Sell Orders to cover the Commission of the Buy, Sell Trade Pair.

If the Tick or Price distance between 2 adjacent cells is too large, the Grid can still have value for longer duration trades. For example, if the total Buy & Sell commission of a Trade pair amounts to $5.00, a minimum Tick between cells of anywhere from $5 to $100 can still be used if the user wishes, and such Tick distances are supported or allowed by the user's brokerage firm. But clearly, this means the Last Trade price will not move quickly from cell to cell so the market will appear to not be very volatile. Ideally, in a typical Trading session, the price range of the security is 100 cells to 1,000 cells on a Grid of 5 cell or 10 cell Rows. So, Commission costs per trade or Trade pair constrain us when choosing the minimum Price difference between adjacent cells, or the minimum Tick to choose, on the Grid. Then for the maximum Price difference between adjacent Cells, having a look at covering the commission of a Trade Pair and also consider the Price Range or value Range of how the security Trades over a given session or given time period such as an hour or a week. The Grid of the present invention, with multiple price columns as shown can readily handle price moves per session involving 5-10 cells shown in a single column to 5,000-10,000 cells per session if the Grid is constructed of 5-10 price cells per Row of the Grid.

Radio buttons 1662 to 1680 show the various settings which the user can select to define the Order Label, number of ticks, and Default Order positions. Each radio button has their own Order Tick count, Label pointer, and Default Order pointer settings.

On radio button 1668, the Label pointer and the Default Order pointer are in different tick positions. A sample Label value and Order value can be seen on the right most side of the radio button 1668 row. On radio button 1672, Label pointer 1657 and Default Order pointer 1659 are on a vertical position to fit the space constraint. Radio button 1680 is the selected setting so the resulting order tick value is echoed on Order Tick setting 1682.

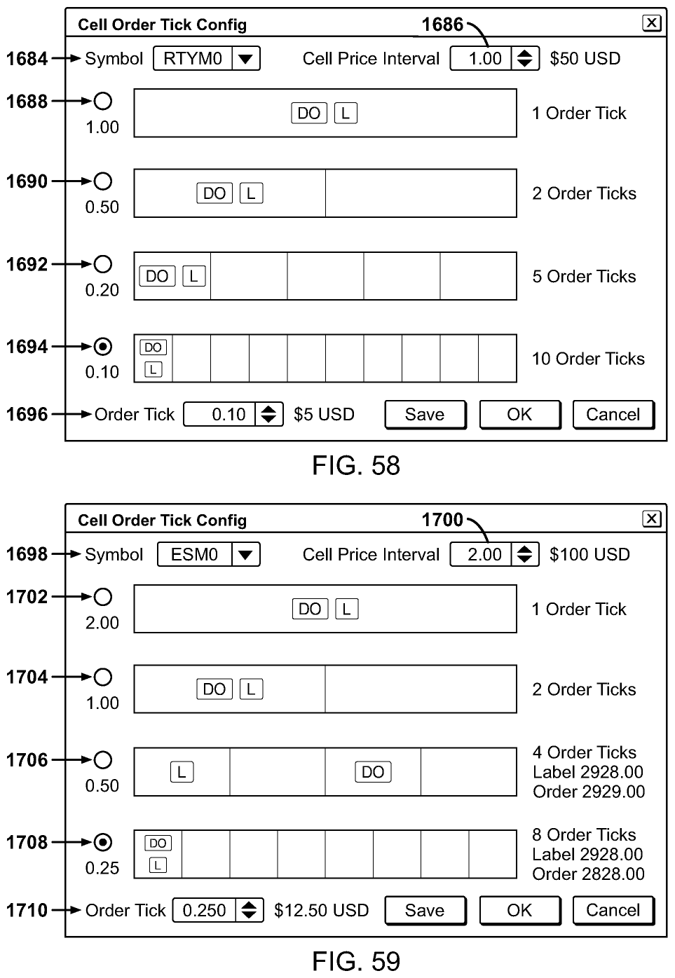

FIGS. 58 to 59 show a Cell Order Tick config where segments are used instead of a tick mark. The options Order tick value options shown are also filtered in such a way that only the practical values are presented to the user. In the case of FIGS. 58-59, only the Order Tick values that result in whole Order Tick counts, i.e., the resulting Order Tick counts are integers without fractional values.

FIG. 58 shows a Cell Order Tick config of ‘RTYM0’. Symbol combo box 1684 shows RTYM0 which has a Min Tick of 0.1. The Cell Price Interval setting 1686 value of 1.00 means there are 10 Min Ticks 0.1 in each cell. The cell price interval of 1.00 pts is translated into dollar value and echoed to the right of the setting.

Radio buttons 1688-1694 show the Order Tick settings that make most sense. The Order Tick values shown to the user are all divisible by the Min Tick. Radio buttons 1688-1694 also show segments instead of ticks and the Default Order and Label are shown as rectangular icons which can be moved independently on the segments. Order tick setting 1696 show the order tick value of the selected radio button radio button 1694. The dollar value of 0.10 pts is also shown as $5 USD since each 0.1 change in the price results in a $5 USD gain or loss.

FIG. 59 shows a Cell Order Tick config of ‘ESM0’.

Symbol combo box 1698 show ESM0 which has a Min Tick 0.25. Cell Price Interval setting 1700 have the value of 2.00 meaning there are eight 0.25 Min tick segment on each cell. The cell price interval of 1.00 pts is translated into dollar value and echoed to the right of the setting.

Similar to FIG. 58, Radio buttons button 1702-1708 only show the Order Tick settings which are practical. The Order Tick values shown to the user are all divisible by the Min Tick 0.25. Radio button 1706 show a Cell Order Tick config where the Label icon and Default order Icon are in different segments.

Order tick setting 1710 echo the size of the order tick of the selected radio button 1708.

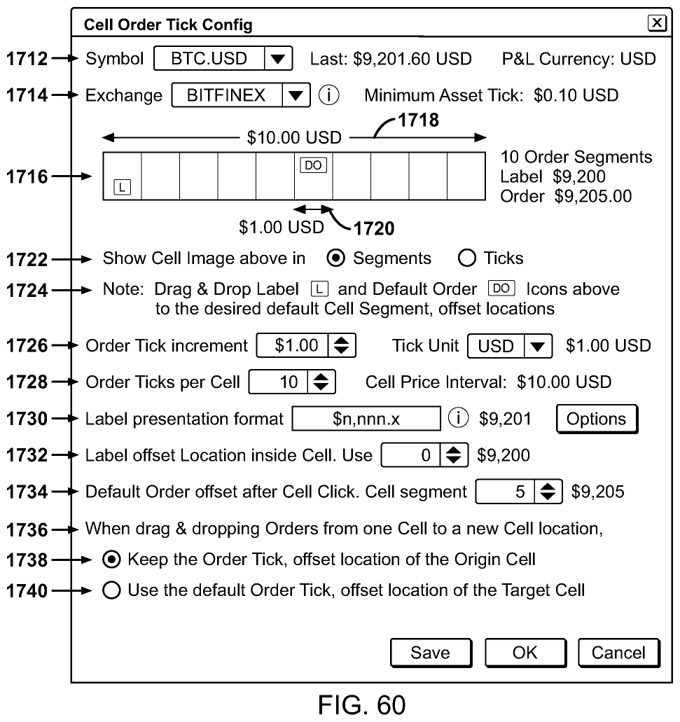

FIG. 60 show the Cell Order Tick config which is less graphical but with more detail.

Setting 1712 show the symbol, last price, and P&L currency. These setting help the user to identify and double check that they are doing configuration for the intended symbol.

Setting 1714 show the exchange and the minimum asset tick. Detailed information about the symbol can be seen by clicking the icon.

Cell tick configuration 1716 shows a cell price interval of $10.00 USD as shown by the double ended arrow 1718. Each segment size is $1.00 USD as shown by double ended arrow 1720. The value of double ended arrow 1718 and double ended arrow 1720 may be changed by drag and dropping the arrow heads.

The user can change the Default Order setting by moving the ‘DO’ icon to the desired segment. The Cell Label setting can be changed by moving the ‘L’ icon to the desired segment.

Radio buttons 1722 controls whether the cell tick configuration 1716 is shown as segments or ticks. Note text 1724 show hints on how to use the cell tick configuration 1716.

Setting 1726 contain options that define the order tick increment and the unit of tick increment. Setting 1728 contain options that define how many order ticks can be found on a cell and the resulting Cell Price Interval.

Setting 1730 allow the user to configure the Label presentation format. Formatting instructions can be found on the ‘i’ icon. More formatting options can be found on a dialog that can be shown by pressing the ‘Options’ button.

Setting 1732 can be used to change the Label of the cell. The setting is echoed on cell tick configuration 1716 by the rectangular ‘L’ icon.

Setting 1734 can be used to change the Default Order offset after a Cell Click. The setting is echoed on cell tick configuration 1716 by the rectangular ‘DO’ icon.

Setting 1736 contain options on which Order Tick to use when an order is dragged and drop. The two settings are (1) Radio button 1738 Keep the Order Tick, offset location of the Origin Cell; (2) Radio button 1740 Use the default Order Tick, offset location of the Target Cell.

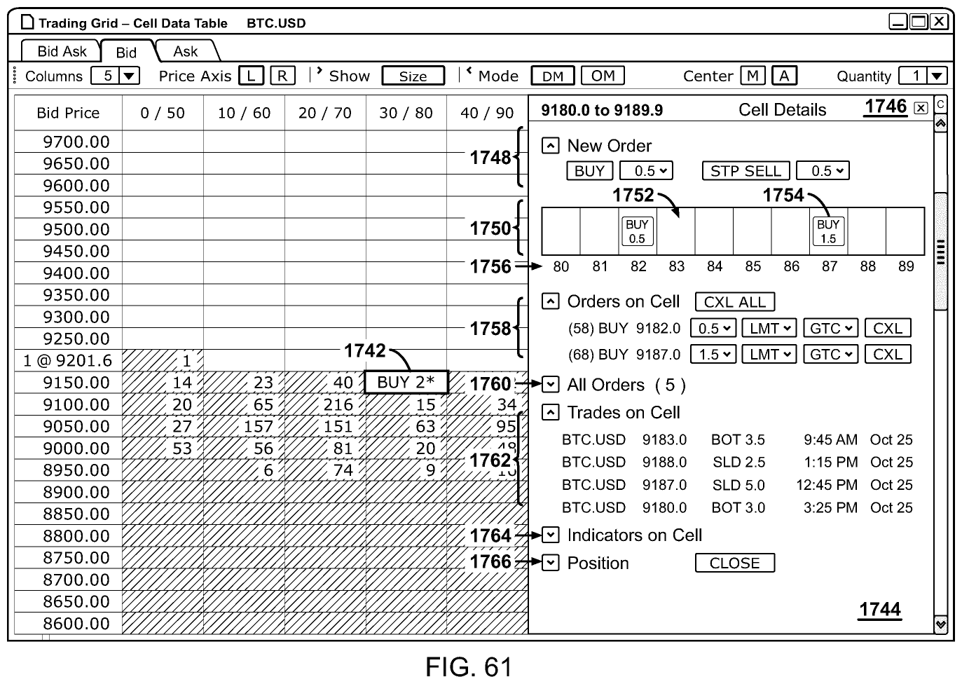

FIG. 61 shows a Cell Details panel with a sub-cell grid. The sub-cell grid allows the user to place or move orders more precisely. A feature which can he very useful on a grid with cells that represent a price range.

The details of selected cell 1742 are shown on Cell Details panel 1744. Header 1746 shows the price range associated with the selected cell 1742 and the title of the tool window. New Order section 1748 contains buttons which can be dragged and dropped on the grid or on the sub-cell GUI 1750 to create new orders.

Sub-cell GUI 1750 can be used to more accurately place orders in a cell which represents a price range. Sub-cell GUI 1750 is divided into sub-cell segments 1752. Segment label 1756 shows part of the price associated each sub-cell segment represents.

Order 1754 is an example of an order present on sub-cell segment. The order icon can be dragged and dropped to a sub-cell segment in the subs-cell GUI 1750 or to a cell on the grid to change the order's price. A right click on an order icon will show a pop-up menu that would show order related commands and information.

Total qty is displayed on selected cell 1742 and the break down is shown on the sub-cell GUI 1750 and Orders On Cell section 1758.

Order rows located in the Orders On Cell section can also be dragged and dropped on the grid or sub-cell GUI 1750 to change an order's price. All Orders section 1760 show all orders of the security. All Orders section 1760 can also be used to drag and drop orders out of view into the viewable area of the grid or sub-cell.

Trades on Cell section 1762 show the trades that occurred on the selected cell 1742. Trades on Cell section show how a trader might want order quantity in increments of certain chunks instead of just random quantities.

Indicators on Cell section 1764 shows indicators such as Moving Averages that may be present on the selected cell 1742.

Position section 1766 show the user's current position. The ‘CLOSE’ button may be pressed to close all orders at the selected cell's default order price. Each position can also be dragged and dropped to the grid if the trader to close the position. The system will automatically create either a Buy or Sell order to close the position and the cell where the position was dropped will determine the price of the closing order.

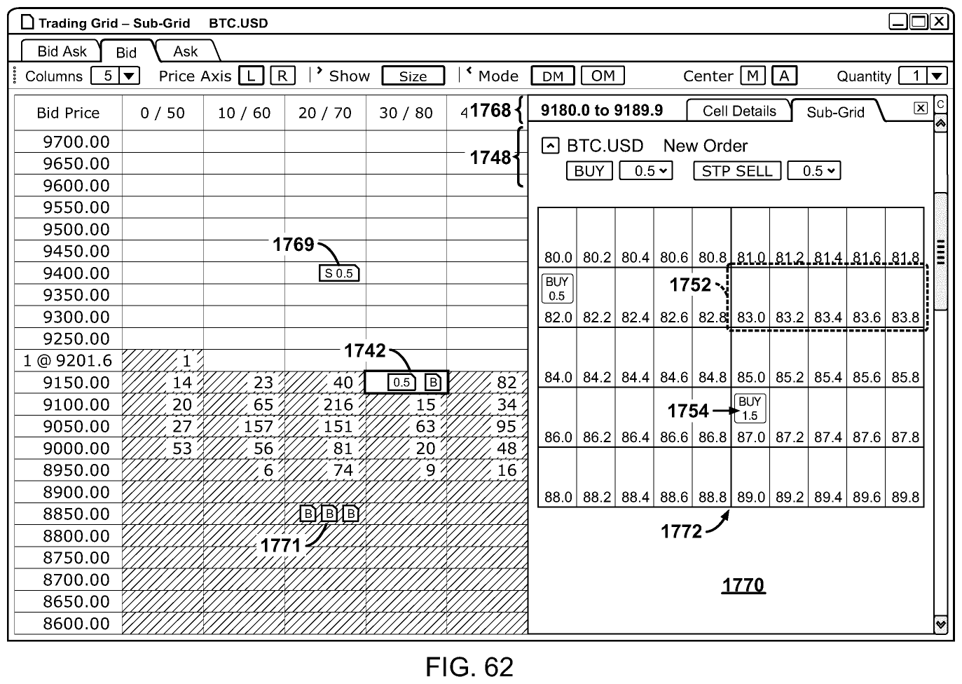

FIG. 62 show a Cell Detail panel with a dedicated Sub-Grid tab. This feature allows the user finer control on where to place or move orders.

Selected cell 1742 is shown on more detail in the Sub-Grid tab 1770.

Title and tab row 1768 show the price range associated with the selected cell 1742. It also shows the Cell details tab and Sub-Grid tabs.

Selected cell 1742 is displayed with more sub-cell segments and therefore orders can be placed or moved with more accuracy. Order 1754 is now shown on a different location to reflect the change in detail displayed by the Sub-Grid tab 1770.

The sub-cell segments 1752 is shown in more detail and orders can be placed more accurately as it now has 5 sub-cell segments. Divider 1772 may be added to show 1.0-point interval separations. The number of sub-cells and point interval divisions may be configured according to the users need. i.e., Each sub cell can represent as small as the minimum tick or as large such that the neighbouring cells can also be seen. These items can also use color logic and other visual elements to make Buy, Sell Cells, Orders more intuitive.

The price of the orders shown on Sub-Grid tab 1770 can be changed by drag and dropping the icon of an order like Order 1754 into a different cell on the sub-grid or on the cell on the Bid tab.

Orders can be shown on the Grid in multiple ways. Selected cell 1742 shows the orders as icons where one shows the buy order as an icon with a quantity and the other as an icon with a ‘B’ to represent a buy order. Background colors, border colors, and other graphical properties and their combinations can be used to differentiate between buy and sell orders, stops, market, and other types of orders. Order icon 1769 show an order icon with both quantity and order type ‘S’ to represent a sell order. One more order can be shown on a cell by using cells like in order icons 1771 where multiple buy orders is shown in a single cell. Each icon represents a different order and each icon can be drag and dropped to a different cell to change the order price. Other actions such as cancelling or deleting and making child orders can be done on the individual order icons. E.g., A click on the order icon be mapped as an input to cancel the order associated with the icon. The quantity can be changed by a right-click on the order icon or by accessing the same Order in the Cell Data Table or Cell Data Mode, etc.

When too many orders exist on a cell and order icons become too many and impractical to display on a single cell, a consolidated icon representing the total order quantity on a cell may be displayed. An alternative is to just display the topmost order icons and show an ellipsis or some symbol like a dot (similar to a combo box) to represent more order icons are present on the cell but can't be displayed. The user can then mouse over or click on the dot to view the hidden orders.

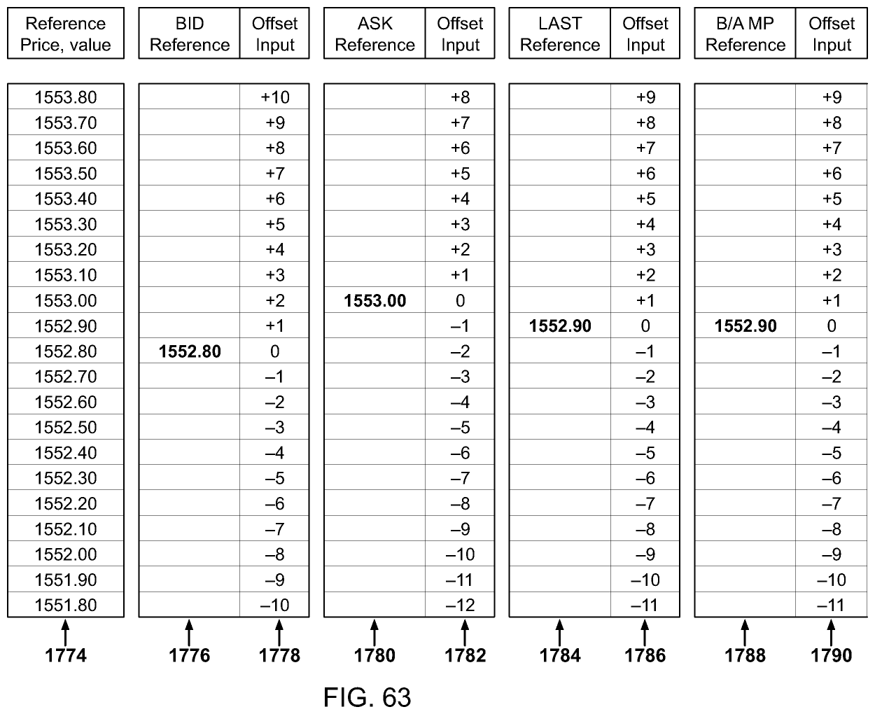

FIG. 63 shows a table of some of the common Offset references and how the Offset Input value affects the resolved price of an Order reference. b) A single Offset reference value is shown on each the columns 1176, 1780, 1784, and 1788. These values are a snapshot of the Bid price, Ask price, Last price, and Bid-Ask Midpoint at the same moment in time.

Column 1774 show the Reference price/value of the rows of columns 1776 to 1790. Each row represents a step of 0.10 pts which is the minimum tick.

Column 1776 show the Bid Reference value of 1552.80, this row is designated as row “0” on the Offset Input column 1778. Rows above Offset Input “0” gets a positive sign “+1, +2, +3 . . . ” to indicate increasing value from the Bid price reference and rows below gets a negative sign “−1, −2, −3 . . . ” to indicate decreasing value from the Bid price reference. This would mean that if a user entered an Offset input value of “+3”, the Resolved offset reference is +3×0.10 pts or +0.30 pts from the Bid Reference value 1552.80 which is 1553.10.

For Ask Reference column 1780, the value is 1553.00 which is typical for the Ask to be higher than the Bid. The Ask Reference price of 1553.00 will now be the “0” row on the Ask Offset Input column 1782 and like the Bid Offset column 1778, the positive and negative signs are assigned similarly with just the “0” row higher at the Ask reference price of 1553.00.

The value of the Last Reference column 1784 and Bid-Ask Midpoint Reference column 1788 just happens to be at the same price of 1552.90 and have the Offset Input columns 1786 and 1790.

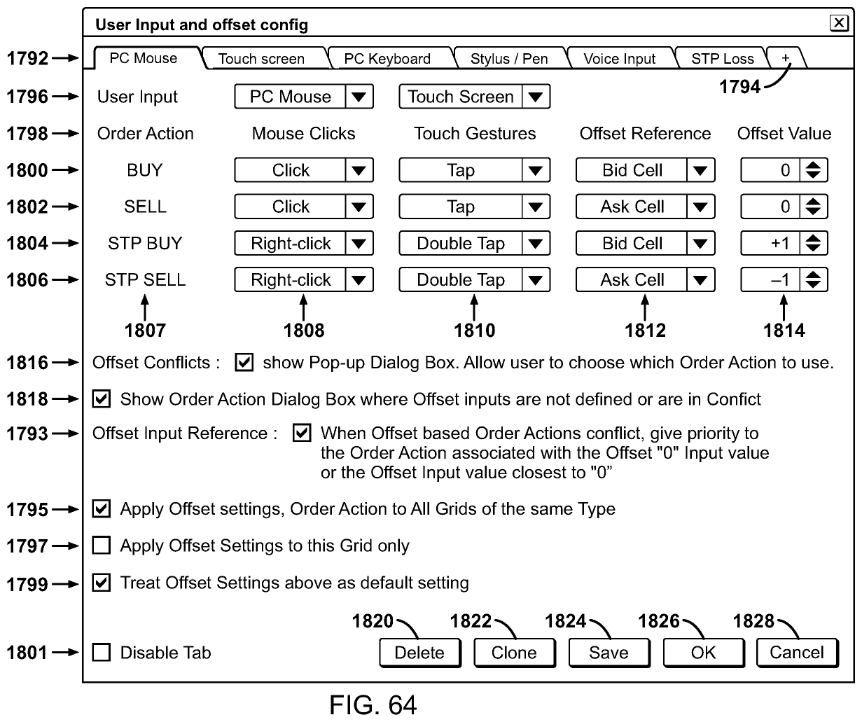

FIG. 64 show settings for the User Input and offset setting. Settings like the User input, offset reference, offset value, order action and other related settings can be defined in this window.

Tabset 1792 shows configuration tabs for various input sources and order action sets. The tabs are named by default using the User Input method selected on the first combo box of User input combo boxes 1796. The user can freely change the tab name like the “STP Loss” tab which may contain configuration specifically for STP order actions. Add tab 1794 allows the user to create new tabs where the user can configure additional user input and offset settings.

There are 4 basic settings and they can be rearranged in a different order according to user Pref. These are the (1) Offset Reference (Bid, Ask, Last Trade, B/A Midpoint value, etc.), (2) The Order Action (Buy, Sell, STP Buy, STP Sell Lmt Orders, etc.), (3) The user mouse or touch screen action associated with each cell, order action (click, right-click, Tap, Double Tap, other gestures, etc.) and (4) the Offset input value and offset Method used (0, +1, −−1 etc. and Explicit Offset Method, FIG. 64 config window, etc.) and Meaning of Ref Offset. The user could choose the Order Action from a drop-down list and add additional Orders. Similarly, the user can choose the Offset Reference from a drop-down list. The user can configure the default order properties (LMT, MKT, STP etc, quantity, TIF, and so on) for each Order Action. Some order types like MKT may not benefit much from the price of the cell since no price parameter is associated with MKT. In this case, the MKT order would benefit more if a child STP order (or any order type that needs a price) is attached to it by default and the STP price would be the cell price.

The user can interact with the Grid in a number of ways to place Orders and perform other types of Interactions on the Grid. The user can easily enable, disable the following types of interactions. For example, Grid Orders can have a check/uncheck a checkbox for (1) mouse click, right-click; (2) mouse Drag & Drop; (3) Tap, Gestures; d) Voice controls. In Cell Data mode the user can be shown checkboxes for Voice Commands, and voice interactions. This lets the user explicitly turn certain functionality on or off, easily enable or disable such interactions. The system can even include a checkbox “[x] Voice controls”.

A trader has a sense to put orders around the Bid, Ask spread. For example, if there are 3 cells between the Bid and Ask cells, then Cell+1 from Bid cell should be a Buy Order Action if clicked, Cell−1 from the Ask cell should be a Sell Order Action if clicked. The Order Actions of cells in between the Bid cell and Ask cell can sometimes cause conflict. A settings control can be introduced such as “[ ] Bid Ask spread middle cell if present: Click to [Buy Iv] if Holdings are [0|v] shares or contracts. Click to [Sell|v] if Holdings are [1|v] shares or contracts.” that can modify or resolve the Order Action based on the presence of a middle cell that causes conflict. The idea can be extended to an Order Action Type based on whether the user already has Quantity Holdings or no Holdings at all to all 3 cells between the Bid and Ask cells. For example, If the user has no Quantity Holdings, the user probably wants to Buy or Open Holdings. If the user already has a specified Quantity of Holdings, the user probably wants to sell, place a Sell Order in the ambiguous cell of the Bid & Ask spread area or near the Ask cell. The setting can be flexible in case the user wants to be net Short in Quantity and also wants to configure their right-click Order Action Type for the same 3 empty cells in the example above.

The user can inform the system if they wish to be Net Long or Net Short as a Preference. A similar Config setting can handle the right-click behaviour of the cells between the Bid and Ask spread. If the Bid & Ask spread only has 2 cells, or an even number of cells, then Bid+1 Offset would be a Buy Order on click, and Ask−1 Offset would be a Sell Order on click. There is no middle or odd cell to consider.

A User Intention Preference for each security or Grid can be introduced like “Position Preference [x] Long [x] Short [x]”. When both [x] checkboxes are checked, it would mean the user wants the flexibility to be either Long or Short at any given instance. A button in the toolbar can be introduced in a toolbar of the Grid, when clicked or right-clicked would show the Order Action Labels of “Buy” or “Sell” so the user can instantly see what the click or right-click Order action will be in each cell of the Grid, or near the Grid's Bid, Ask cell area. There can e a 1-3 second time delay also before the cell labels revert to each cells' Price label or Size label from Order Intention label.

User input combo boxes 1796 allow the user to define the input methods they want to use. There can be any number of user input methods but only two are shown for convenience. The user can freely add or remove input methods as needed. The available User input methods are available under the combo boxes. When the user changes a user input method, the corresponding setting column 1808 or 1810 will be changed to the chose input method's default.

Row 1798 shows the column labels for the user input and offset table. The labels are Order Action, Mouse Clicks, Touch Gestures, Offset Reference, and Offset Value.

There are four settings rows 1800 to 1806 which allow the user to define settings for the BUY, SELL, STP BUY, and STP SELL order actions. Each row defines the Order Action on the left most settings column 1807. The order types on each row can be freely changed by the user. There are only four settings row which show the preferred embodiment of the invention but the user can also add or remove settings rows if needed.

PC Mouse clicks buttons can be defined on settings column 1808. Buttons such as Click, Right-click, thumb buttons, and other mouse buttons can be assigned to each settings row 1800 to 1806 by using the appropriate combo box.

Touch Gestures can be configured on settings column 1810. Gestures such as tap, double tap, tap and hold, swipe, and other gestures can be assigned to each settings row 1800 to 1806 by using the appropriate combo box.

Offset Reference points can be configured on the combo boxes of settings column 1812. Some examples of offset references are Bid Cell, Ask Cell, Last Cell, and Bid-Ask Midpoint. Depending on the order type, the chosen cell may be the highest cell or lowest cell. E.g., for the BUY Order Action, the Bid Cell would be the highest priced cell that would result in a BUY Order Action, any click on cells below the price of the Bid Cell will result in a BUY Order action with the price of the clicked cell. Any clicks above the cell will NOT result in a BUY Order action and instead the other Order Action settings that also have a click input would be checked if they meet the Offset Reference and Offset value conditions.

Offset Values can be set in the settings column 1814. The offset value allows the user to move the Offset Reference of an Order Action up or down. The value “0” means the Offset Reference will be used without any change. A positive Offset Value will move the Offset Reference higher using the number of cells indicated by the Offset Reference value. While a negative value moves the Offset reference a number of cells lower indicated by the Offset Value.

The default Bid Offset value and Ask Offset value is both set to Offset Value “0” so the setting is easy to understand. Any click or right-click between the Bid or Ask Cells will result in a pop-up dialogue box asking the user to choose the Order Action explicitly. Then as the user gets more comfortable with the Trading UI based on Offsets, they can adjust the default input value of “0” to “+1”, “−−1”, etc.

The Bid side and Ask side text labels on a common grid or separate grids can be in different colors for ease of seeing the two sides of the market. E.g., Bid side cell labels can be dark blue and ask side cell labels can be dark red, dark green, etc. A visual indicator like an Order Action Bar can also be shown which separates the Grid into different Order Actions for the click, right-click mouse actions or Tap, double tap touch screen user gestures.

An extra column can be added for the 4 Order Actions to further maximize flexibility. The Column Header is “Meaning of Ref Offset” which allow the user to change the meaning of the Offset Reference Cell. The options of the user are “Defines Highest Cell”, “Defines Lowest Cell”, “Defines Lowest Cell”, and “Defines Highest Cell”. So, the Buy Lmt Order Offset value for a click defines the highest cell price that can place a Buy Order and we assume every cell below will place a Buy Order on a click.

Additional order actions can be assigned aside from the ones from the settings rows 1800, 1802, 1804, and 1806. For example, a BUY+STP LOSS Order Action attached to a Double Click, Bid Cell Offset Reference, and Offset Value 0. Such setting would create a BUY order with an attached STP SELL child order when a user double clicks on a Bid cell which can protect the trader from losses.

The Offset Config can be done in multiple ways, In FIG. 64 the config starts with the Order Action. Alternatively, the config can also start with choosing the Offset Reference first. The config can use a single Offset Ref with different Offset Values, or 2, 3, 4, Offset Reference, each mapped to a different Order action. i.e., A different Offset Reference (Bid, Ask, Last, bid ask Midpoint) for each Order Action (Buy, Sell, STP Buy, STP Sell).

Enabling checkbox 1816 allows the user to resolve Offset conflicts by choosing the appropriate Order Action on a dialog box. When the user clicks on a grid cell and the system cannot determine the Order Action because of the offset settings, a dialog box will be shown to the user which contain the Order Actions that have a conflict. The user would then choose from the Order Actions presented in the dialog box to resolve the conflicts. Aside from the Order Action, other data like the clicked cell price and order size may also be shown to the user. Other order attributes may also be shown and modified like TIF and order quantity. The user may customize the appearance of the dialog box.

A settings conflict may arise when the same combination of User Input, Offset Reference, and Offset Value is used more than once on this config tab page or other parts of the system also utilizing the same combination. For example, if the BUY settings row 1800 have “Click, Bid Cell, 0” and SELL settings row also use “Click, Bid Cell, 0” then this will result in a setting conflict. The user would be warned thru a dialog box or by visual indicators on the conflicting settings so the user may be notified to resolve the settings conflict prior to applying the config. If the user does not resolve the conflict, the chances of conflict increase when a user interacts with a cell. Checkbox 1818 allow the user to resolve the above type of conflict.

When a user has not defined a user input and uses it to interact with a cell, checkbox 1818 may be enabled to resolve the absence of Order Action configuration.

When 2 or more Offset References are used, e.g. A Bid Cell Reference & an Ask Cell Reference, each has cells under their jurisdiction or purview, and “0” default Order Action can take priority over “+1” Offset input by enabling checkbox 1793. i.e. The “0” in the Ask Reference which results in a Sell Order can take priority over a “+1” in the Bid Reference which results in a Buy Order. Since in cases where the Bid, Ask Spread is just 1 Tick, such settings would conflict as they resolve to the same cell. This would mean a pop-up dialogue, checkbox 1793 is a setting that give priority to the Order Action at or closest to “0” Offset input value. So, an Order Action conflict with Offset inputs at “+2”, “−3” would result in an Order Action of the Offset input “+2” value since it implies a Bid-Ask spread of 5 Ticks. i.e., If bid is at 1552.6, “+2” offset is 1552.8. Similarly, if Ask is at 53.1, “−3” offset also resolves to 1552.8. Since Buy Offset “+2” is closer to “0” than Sell Offset “−3”, the Order Action would be associated with a Buy Lmt Order.

If the user doesn't like the default choice, they can click on the Order cell to cancel the Order, and then click on the cell above it, which would result in a Sell Lmt Order, and then drag & drop the Order 1 cell lower to the 52.8 cell.

The unintended Buy Order Action may be filled immediately, before the change could be made, but generally, between the Bid and Ask spread, 1-2 seconds of time is available to make changes, the user can also configure an optional delay before an order is sent when an order action is close to the border where the Buy and Sell order actions meet.

If the user doesn't like the order action of the cell, the user can find a cell with the proper order action, hold down the click or right-click, drag the cursor to the target cell, and release the mouse button to place an order. The resulting order would retain the attributes of the source cell except for the price which would be the price of the target cell.

With the new FIG. 64 Offset Config, a single BookTrader Column can be configured to submit both Buy and Sell Orders, or Buy and STP Buy Orders in the same column with the same mouse click (single click). The Bid, Ask, or Last Reference separates the column into 2 sections or the Grid into two sets of cells. The Offset Reference allows the group of cells to be divided into two sections. Thus, the same click input can be used for 2 Order Actions (a Buy action and Sell Action), and when right-click is included, an additional two Order actions (STP Sell, STP Buy) total of 4 Order Actions. Any additional User Input method (button, key, gesture, click, combination with a modifier) can be mapped into two order actions because the Offset Reference allow a grid, column, or row into two parts.

What the Offset Reference and Offset Inputs do is divide the Column or Grid from a single cluster of cells to 2, 3 areas depending on what the Offset inputs were. E.g. Bid cell and lower, Ask Cell and higher, and the section or cells between the Bid & Ask cells. This 3rd section near the spread may cause a dialogue box to pop-up and request an explicit Order Action intention from the user, for the click, or right-click user action that was used.

Aside from the BUY or SELL order action, other parameters like an attached STP order and/or profit take order, exchange, TIF, etc can be configured by the user. So, a click can be the LMT order, ctrl click comes with a STP order, alt click is a bracket order, etc. These additional configurations can be organized into another tab like the STP Loss tab in tabset 1792. Auto Attaching a STP Order or Profit Take Order, or Bracket Order, like the Quantity of each Order, can be done in another window or Tab.

The user can also attach a default Child order with a Profit or Loss parameter relative to the parent price as a result of an order action or fill. E.g., The user can attach a default —$100 STP Loss to a BUY order, and/or the user can attach a default +5.00 pts Profit taking child order.

Keyboard shortcuts and/or modifiers like Ctrl+click and ALT can be organized in a tab like the “PC Keyboard” tab in tabset 1792. For example, user can instantly add a STP Loss, Profit Take, and Bracket Orders anytime they choose to click. The right-click action could even be configured to do a Bracket Order, not a STP Order, etc.

Aside from the Add tab 1794, other tab related functionalities are found in checkbox 1801 and buttons 1820, 1822, 1824, 1826, and 1828.

Checkbox 1801 allow the user to quickly disable the settings on the entire tab page which can be useful as a temporary solution to remove settings conflict. Another use of checkbox 1801 is to allow the user make copies of a tabpage with only a few settings changed that so the user can quickly change settings to adapt with the market situation. For example, the user can have the two PC Mouse settings with to different sets Offset Values on the settings column 1814, one for low volatility and one for high volatility. The user may choose to use the checkbox 1801 to quickly enable and disable a settings tab.

Button 1820 allows the user to delete the currently shown settings tabpage. Button 1822 allows the user to copy the shown settings tabpage and the system might attach a suffix ‘(2), (3), (4) . . . . ’ and so on to differentiate the cloned tabpages.

Button 1824 saves the settings without closing the settings window while button 1826 saves the settings and closes the settings window.

Button 1828 discards the changes on the settings window and then closes it.

The reason the Bid, Ask, Last, and Bid-Ask Midpoint values are used as Reference Offset Values is because they are easy to identify on the Grid or Price Axis and Bid, Ask, and Last values usually have a distinct color or other visual indicator on the associated cell to help identify their location. Bid and Ask cells also have size labels to identify their location. Bid has the top most size value on the Bid side of the Grid or Column, and Ask has the bottom most size value on the Ask side of the Grid or Column.

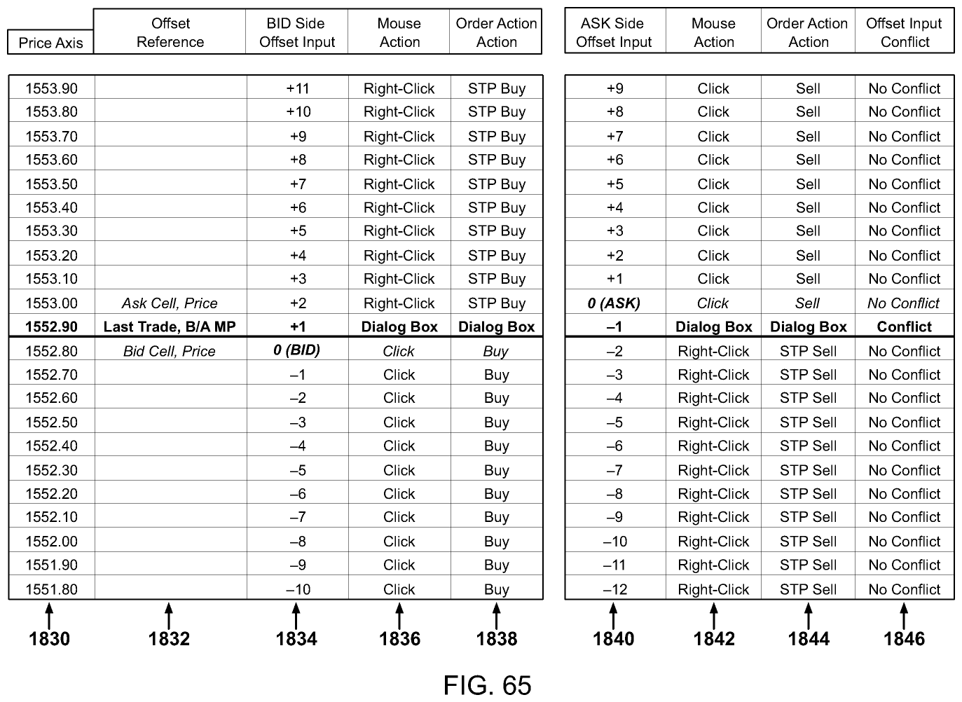

FIG. 65 is showing how the Offset Config settings of FIG. 64 look like in terms of user mouse actions and resulting Order Actions submitted. FIG. 65 show a mapping of the Offset Input, Mouse Action, Order Action, and if the setting result in an Offset input conflict. As the Bid price and Ask price change, the Conflict, No conflict indication ill also change on the column.

The Price Axis is shown on Column 1830 which the price associated with each row. Of particular interest are row “1553.00” which is the Ask Cell Price; “1552.90” which is the Last Trade and Bid-Ask Midpoint; and “1552.8” which is the Bid Cell Price. These values are a snapshot and are assumed to have been taken at the same moment in time.

The Offset references are shown on column 1832 where the labels of the Ask Cell, Bid Cell, Last Cell, and Bid-Ask Midpoint are shown.

The BID side offset inputs are shown on column 1834. The “0” input is on row “1552.80” because the offset reference used by the Buy side is the Bid Cell price.

The BID side Mouse Action are shown on column 1836. Row “1552.90” show “Dialog Box” since this row's settings are in conflict and a dialog box is chosen to be shown to resolve the conflict. The same “Dialog Box” is also shown on columns 1838, 1842, and 1844.

The resulting order as a result of performing the Mouse Action is shown on Order Action column 1838. In cases where there is conflict, the row is shown with “Dialog Box”.

The ASK side offset inputs are shown on column 1834. The “0” input is on row “1553.00” because the offset reference used by the Sell side is the Ask Cell price.

The ASK side Mouse Action are shown on column 1842. The cell with “Dialog Box” is row “1553.00” because if this row's setting is used, it will result in conflict.

The resulting order as a result of doing the ASK side mouse action is shown on the Ask side Order Action column 1844.

Column 1846 shows the status of “Conflict” or “No Conflict” as a result of using the setting of “BID Cell price” with offset of “+1” (BID +1) on the BID side and “ASK cell price” with offset input of “−1” (ASK −1) on the ASK side.

Suppose the BID offset reference and ASK offset reference don't move, the user can choose settings that will not result in conflict by selecting Offset Input values that don't overlap. For example, the user can use “BID+1” and “ASK 0” and it will not result in conflict for this snapshot. As long as the BID reference+offset is lower than the ASK reference+offset, no Conflict will occur.

Suppose the same “BID +1” and “ASK −1” setting is used, the conflicts will disappear should the Ask Cell price reference move up one or more cell. The conflicts also disappear should the Bid Cell price reference move down one or more cell.

The default settings are usually “BID 0” for the BID side and “ASK 0” for the ASK side. With the default offset settings at “BID 0” and “ASK 0”, a user will only see a Dialog box if they try to place an order at the “BID 0” cell or the “ASK 0” cell on situations where there is a crossed market where the Bid Price is higher than or equal to the Ask Price.’

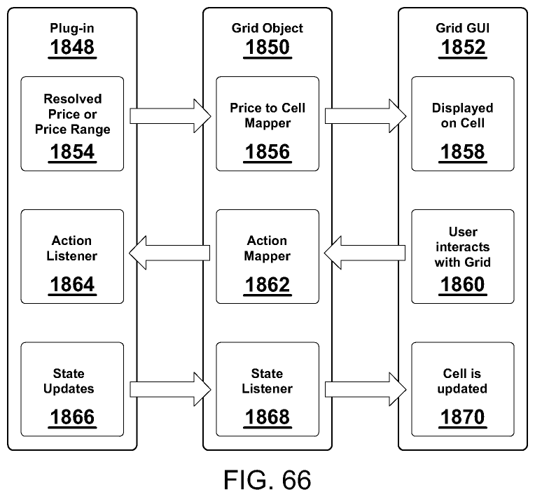

FIG. 66 shows a schematic of the plug-in system that allow the present invention to display almost any type of data on a cell as long as the plug-in provides a price or a range of prices to the grid.

The plug-in system allows the grid to display almost any type of data on individual cells or a range of cells. Illustrated on FIG. 66 is a schematic view of the plug-in system of the present invention which consist of Plug-in 1848, Grid Object 1850, and Grid GUI.

The Plug-in 1848 represents a plug-in that is incorporated on the system. The plug-in maybe a stand-alone 3rd party plug-in or a component hard coded into the system. A plug-in typically is added to the system and conforms to interfaces understood the system so the plug-in can provide data and communicate with the system. Plug-ins can be in the form of services that run independently and are run remotely outside of the user's system. Plug-in 1848 may have its own data feed or work with data that comes directly from the system. The Plug-in may be coded in a variety of programming languages as long as the communication protocols and interfaces are implemented that conforms with the system.

The Grid Object 1850 is primarily responsible for interpreting the data provided by the plug-in and updating the plug-in related objects in the Grid GUI 1852. The Grid Object 1850 need not be in direct communication with the Plug-in 1848. Other subsystems such as a communication layer maybe in between the plug-in 1848 and Grid Object 1850 to maintain a clean and maintainable code.

The Grid GUI 1852 the displays plug-in data and monitors the user interactions with the grid. The Grid GUI 1852 is responsible for displaying cells, grids, rows, columns, headers, orders, trades, and other grid objects.

At the most basic, a Plug-in 1848 would contain a function that sends a price or a range of prices to the system. The Grid Object 1850 manages data related to Grid GUI 1852 and is responsible for translating the received data from Plug-in 1848. The Resolved Price or Price range on step 1854 is sent by the Plug-in 1848 to the Grid 1850. The Price to Cell Mapper of step 1856 then processes the data and determines which cell or cells the price data received from the Plug-in 1848. An example of this basic plug-in are indicator plug-ins such as DMA that only has a single value. The Plug-in 1848 would calculate the DMA and send it to the system to be processed by the Price to Cell Mapper of step 1856. Then the received data is processed by the Price to Cell Mapper 1856 to be displayed in the appropriate cells. If the cell is visible on the Grid GUI 1852, the cell is updated and the data is Displayed on cell on step 1858. Formatting and appearance of plug-in data is primarily configured on the system although such display methods be included in the plug-in in a usable form by the system. The advantage of having the display method on the system is that the priority can be decided by the system and when multiple Resolved prices, within the same or from multiple plug-ins, need to be displayed on a single cell. For example, the system can be configured such that DMA data takes top priority to be displayed on a cell over other plug-in data and then other data may just be shown on other parts of a system or on things like a mouse-over pop-up. Otherwise, other data such as quote size or other plug-in data can be displayed in the absence of the DMA data.

A plug-in can be made to just feed the grid it's price data and other supplementary data and do nothing else. The Grid Object 1850 and Grid GUI 1852 then can be delegated to handle which and how data from one or multiple Plug-in 1848 is displayed into the grid or cells such as what colour or text formatting is used, how many decimal places, background colors to relate to the data provided by the plug-in and the type of plug-in.

Aside from the resolved price, other data and 3rd party may also be provided by the Plug-in 1848. These include data like order type and quantity, TIF, fill data, brokerage, etc. These data can be used to develop plug-ins that can display and manage orders and trades from different brokerages of the trader. Plug-ins or APIs can be developed to display data from other brokerages and security types. The ability to consolidate data coming from multiple brokerages allows the user to manage redundancy in a single grid.

The flexibility provided by the plug-in 1848 makes it possible for the present invention to trade not only stocks and futures, but also options, algo trades using options, currency, crypto currency, and any tradable goods from different markets and providers as long as a suitable plug-in is developed.

Paper trades can also be done on the same grid as Active Real trades. The paper trades are just accounted for differently. P&L, trades, orders are logged to the Paper trades account, not the Real Account P&L. This can be thru a plug-in that routes the paper trades to a paper trading service on the user's computer or on a cloud. Paper trades may be also integrated into the grid by a paper trading mode in addition to the order mode and data modes.

Social trading functions can be seamlessly integrated to the grid by using an implementation of plug-in 1848. For example, a user can follow a trader, news feed, or any source and use ML or AI to read the feeds of the source and when a trade recommendation, news, or other trading related info is detected and the price is visible on the Grid GUI 1852, the user can be notified in that cell by a cell background, border, or a popup balloon text or tooltip about the detected data. Notifications can also be done on a dedicated social media area if the resolved price is not visible on the viewport of Grid GUI 1852.

In addition to standard Algos developed by Grid developers such as grid algos, more complex 3rd party algos can be supported by the grid thru the implementation and use of a plug-in.

For the Plug-in 1848 to support user inputs, it must contain an Action Listener implementation that listen to the user-inputs and respond accordingly to the user actions. The plug-in 1848 then lets the system know what kinds of functions it supports and those functions will usually appear in place like the settings column 1807 on FIG. 64 so the user can configure a button or keystroke to a plug-in command.

When a user interacts with the grid on step 1860, the user input is interpreted by an Action Mapper on step 1862 and if the input method is configured for a function in the plug-in, the Grid Object 1850 will then send the function triggered by the user interaction and the relevant data on the cell such as price or price range, size, order type, quantity, and other plug-in objects on the cell that may be required the Action Listener of step 1864. The Plug-in 1848 then processes the data received by the Action Lister and either does another Resolve priced or Price Range update on step 1854 or does State update on step 1866 to update, create, or delete the other parameters of the plug-in objects displayed on the grid.

State updates on step 1866 involve tasks such as updating if an order is sent or filled and deleting cancelled orders on the grid. The plug-in determines if any of its objects needs to be updated and sends state updates to the State Listener on step 1868. The State Listener on 1868 then determines if the target or targets of the received data form step 1866 is visible on the Grid GUI 1852 and updates the visible plug-in object. An example of a state update is a when a DMA value is crossed and the plug-in is designed to send an order once a DMA value is touched. The plug-in sends a state update and the Grid Object 1850 determines that the DMA plug-in object currently visible on the Grid GUI 1852 and updates the cell. The Grid GUI 1852 then flashes the cell to notify the user of the event.

Plug-ins or Add-ons would typically be checked for security issues before being allowed to the system to maintain its integrity and avoid conflicts with existing systems.

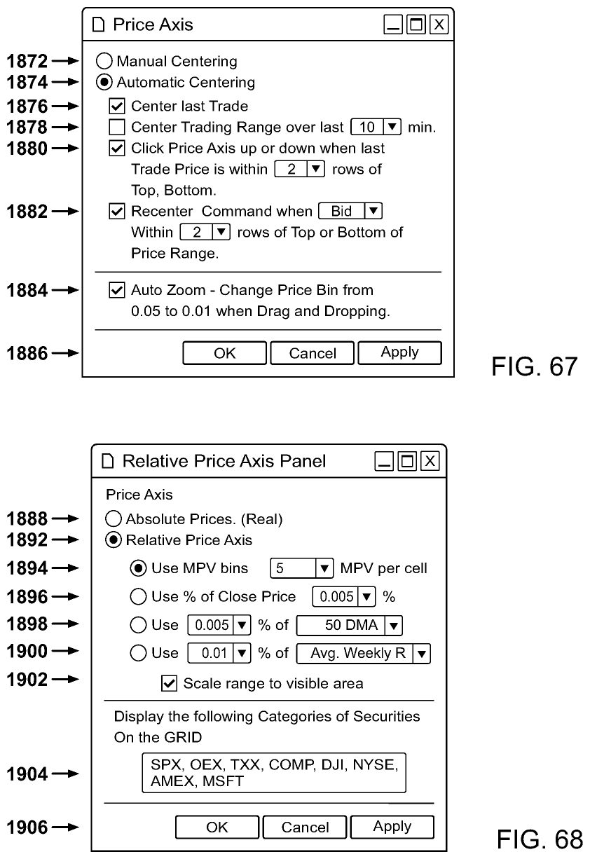

FIG. 67 shows a Price axis settings dialog which relate to price axis centering. The two primary choices are radio button 1872 Manual Centering and radio button 1874 Automatic Centering. Other sub-settings are also present under radio button 1874 which are concerned with Automatic Centering. An auto-zoom feature is also shown on checkbox 1884. The buttons 1886 allow the user to Save, Apply, and Cancel the settings done on the Price Axis settings dialog.

When radio button 1872 is chosen, the price axis will not center automatically and the trader would have to manually adjust the grid so the trading activity can be made visible if ever the trading activity goes out of the viewable area of the grid. When trading activity goes out of the visible area of the grid or column, an indicator nearest the edge of or on the cell may be shown to the trader to aid them in whether the trading activity went down, up, or sideways. A number based on the number of cells or price may also be shown with said indicator to help the trader know how far away the trading activity is from the visible area.

When radio button 1874 is chosen, the price axis, and consequently the trading activity, will be centered automatically based on the settings under radio button 1874. Automatically Centering the price axis is the process where the price axis is adjusted automatically to keep the trading activity visible or centered in the viewable area of the grid or column. The Automatic Centering functionality takes effect immediately or with some delay to smooth out the transition and prevent the trader from being disoriented.

Radio button 1874 have several sub-settings related to Automatic Centering.

Checkbox 1876 can be enabled to allow the price axis to keep the last trade centered on the price axis when the Automatic centering function takes effect.

Enabling Checkbox 1878 allows the trading range over a period of time indicated in the combo box to be used as the basis of the center of the Automatic centering feature. Additional setting can be added to automatically adjust the period of time setting such that the price axis will be able to display the trading range.

Checkbox 1880 can be enabled to trigger the Automatic Centering feature in advance before the Last Trade is within the top most or bottom most number of rows as indicated in the combo box. Triggering the Automatic Centering in advanced may be advantageous so trading activity remains in the visible area if there's some hysteresis or delay before the Automatic centering takes effect or if there's a lot of volatility.

Similarly, checkbox 1882 can be enabled to allow an additional trigger aside from the Last Trade Price for the automatic centering feature. Additional trigger/s such as the Best Bid or Best Ask can be configured in the combo box on the setting of checkbox 1882.

Checkbox 1884 can be enabled to change the price bin of the price axis and cells to the Minimum Price Variance to allow more precise placing of orders. For example, if a cell has a price bin of 0.05 and has enough area, the cell can be subdivided into 5 to provide drop targets of 0.01 where the user can drag and drop objects into which will affect the object's price.

FIG. 68 show a Relative Price Axis settings panel. The panel contain settings to enable the Relative Price Axis and other sub-settings that influence how the Relative Price Axis behave. The Relative price axis allows multiple securities to be displayed on one grid while sharing the same Price Axis. The Relative Price Axis can be enabled by selecting the radio button 1892. Selecting the radio button 1888 disables the Relative Price Axis and the Absolute Price or Real Price axis will be used instead.

Radio button 1894 to 1900 show settings that can be selected to define the method on how price bins on the Relative Price Axis are performed. Radio button 1894 uses the multiples of the MPV to define the price bin while the rest use a percentage of some value. The other price bin methods are radio button 1896 which use the percentage a close price, radio button 1898 is a percentage of a DMA or some other calculated value, and radio button 1900 which use the percentage of the average weekly Range or some other range value. Checkbox 1902 can be enabled so the price bins are calculated on each security such that the range selected on radio button 1900 fits on the visible area of the grid.

The user can input the securities that are would be displayed on the grid with the text box 1904. The user can then save, cancel, or apply the changes made on the Relative Price Axis panel by using the buttons 1906.

The relative price axis is typically labelled as integers or by multiples of the chosen price bin method. The ‘0’ cell on the Relative Price Axis corresponds to the Last Trade or some other value that can be found across the securities that share the price axis like bid price, ask price, and bid-ask midpoint. Cells above the ‘0’ cell are typically labelled by positive numbers (+1, +2, +3, . . . ) and cells below the ‘0’ cell are typically labelled by negative numbers (−1, −2, −3, . . . ). These numbers represent how many price bins away from the ‘0’ cell is a particular row. Price bins can be defined by a multiple of the Minimum Price Variance (MPV), a percentage of the security's price, a percentage of range, or some other value that can be used to represent price points or range across the securities that share the relative Price Axis.

Trade markers or other visual indicators such as icons, background, borders, that fade over time to aid the trader in visualizing the movement of the security. Another visual aid that can be used to track movement of the security are timestamp markers which can be a fixed interval within each other. E.g., The age of on a cell can be shown as an icon with a number indicating the number of seconds or a color gradient that represent the time that have elapsed since a trade occurred on the cell. So, if a security's price has moved up, there will be more icons under the ‘0’ cell and if the price falls there will be more icons above the ‘0’ cell. To avoid clutter, instead of showing the trade markers on every cell, the user can define a set of defined elapsed times (e.g., mark only the cells where there is a 1 second, 5 second, 30 second, 1 minute, 5 minute, or 15 minute old trade) so the icons or any other visual indicator is kept a minimum while still aiding the trader to know the movement of a security.

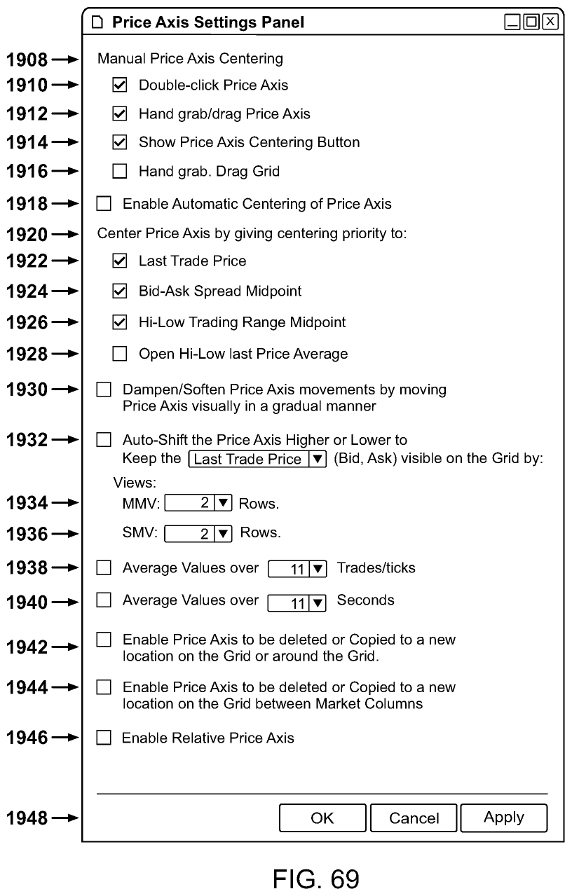

FIG. 69 show a Price Axis Settings Panel that show settings for manual and automatic centering. Checkboxes under setting 1908 are concerned with the manual centering of the Price Axis where several methods are offered to the trader on how they can center the Price Axis. Checkbox 1910 can be enabled to allow centering of the Price Axis when a double click is performed on the price axis. Enabling checkbox 1912 allows the user to manually adjust the Price Axis by hand grab or dragging to adjust the viewable area. When checkbox 1914 is enabled, a button is shown to the trader to allow them to center the Price Axis by clicking on said button. Checkbox 1916 can be enabled to allow hand grab or dragging of the grid where it does not interfere with other drag and drop functions to adjust the viewable area so the trading activity can made visible anytime the trader desires to.

Checkbox 1918 enables the Automatic Centering of Price Axis and contain several sub-settings that affect the behaviour of the said feature.

Setting 1920 contains sub-settings that allow the trader to select which values the Price Axis Centering feature can base where the center of the trading activities are. A ranking system may be implemented such that one value is given more priority over the others if multiple values are present in a viewable area. The user can enable at least one of the checkboxes 1922 to 1928 which correspond to Last Trade Price, Bid-Ask Mid Spread Midpoint, Hi-Low Trading Range Midpoint, and Open Hi-Low Last Price Average.

Checkbox 1930 can be checked to enabled Dampening/softening of the Price Axis Movements by moving the price axis in a gradual manner. Some examples of the dampening transitions are by applying a time delay to postpone the effect of the centering, and by smoothly scrolling the price axis.

Checkbox 1932 can be enabled to allow the Price Axis to Auto-Shift higher or lower to keep a certain value defined in the combo box visible on the Grid. For MMV and SMV views, combo box 1934 and combo box 1936 defines the number of rows on the edges of the price axis when the value selected on checkbox 1932 will trigger an Auto-shift event. Checkboxes 1938 and 1940 takes the average values of a number of trades or the average values of trades over a number of seconds to detect if a Price axis Automatic Centering is triggered. For example, an Automatic Centering could be triggered once the average value goes outside the visible area. Another example where the averages can be used is to trigger an Automatic Centering Event once the Last trade price goes outside the Average values.

Checkbox 1942 can be enabled to allow the price axis to be copied or deleted around the grid. Similarly, checkbox 1944 can be enabled to allow the price axis to be deleted or copied between market columns. The idea can be extended to allow the grid to be copied or deleted in between price columns Choosing Checkbox 1946 makes the Relative Price Axis visible. Buttons 1948 allow the user to Save, Cancel, or Apply the change done the Price Axis Settings Panel.

The term “common grid” can be used when both buy and sell orders can exist on the same grid. Alternatively, for example, in the case of FIG. 6, two separate Grids can be seen, one for the Bid side or Buy side Orders, and one for the Ask side or Sell side Orders. The Price Axis and Column Header cells can be considered part of the Grid Proper but do not have the Order placement and Drag & Drop of Orders functionality of the Order Grid. The Price Axis and Column Header Cells, Header Row are docked to the Order Grid on the Left, Right, or roughly middle, Top, Bottom, or roughly center areas of the Trading Tool or Trading interface's Order Grid or Grid Proper. The Grid Proper is defined as the Order Grid including the Price Axis and Column Header cells if configured to be shown or present, visible to the user. Similarly, the Order Grid is defined as the part of a Grid with Order Placement, Drag & Drop of Orders, and Algo control functionality. The general term “Grid” itself may refer to either the “Grid Proper” or the “Order Grid” parts of the trading window, trading interface, or trading tool depending on context. The Common Grid can have a Common Order Grid component for Orders. Values, prices, quantities, labels, and other objects displayed on a cell may represent a value of one single market or an average or aggregate of multiple markets. A broker can offer the user on best routing when an order is placed on an aggregate cell so the order is filled at the best price possible.

The “Common Grid” term is not restricted to just Buy or Sell order placement or Order click, drag & drop functionality. The common Grid has value for showing security price moves, the price or value trading range of a security or index, including non-trading symbols such as an Index or derivative measures of a trading symbol or index. A common Grid could be used to show Price movements and Last on business news such as CNBC, Bloomberg during an IPO or direct listing, after Earnings news, a key Econ event, such as a Fed rate decision, etc. So, the Common Grid shows the Bid side, Buy Order side and Ask side, Sell Order side prices of the Grid cells in a merged cell arrangement or common cluster of cells presentation.

These terms have to be used in context. Just because a Grid may have Order functionality, doesn't it must be called an Order Grid, it can be still referred to as a Grid because the Order functionality is implied or shown on the Grid. Similarly, just because Buy & Sell Orders is shown on the same Grid, doesn't mean it is needed to call it a common Grid, it is implied. What is more important is that it is not referred to a Buy side and a Sell side Grid having distinct clusters of cells as a common Grid. Similarly, it is not necessary use a presentation Grid and call it an Order Grid. So, context is important and at times, some terms may be used interchangeably without arousing confusion.

A grid-based graphical trading system and the method at which quotes, orders, and other trading related objects are efficiently and intuitively mapped into a grid of cells has been described. In addition, the intuitive, precise, and customizable “Smart Order Action” method of placing and managing orders on the said grid of cells have been described.

The software, and particulars of the software, have been described to the extent necessary, it being understood that any person skilled in the art of writing software for the appropriate platform such as ActiveX, Windows, Android, GUI-based systems, and so on, may write specific software, and may provide specific functional and logical architecture, without departing from the spirit and the scope of the appended claims. Other modifications and alterations may be used in the design and manufacture of the apparatus of the present invention without departing from the spirit and scope of the accompanying claims.

What is claimed is:

1. An interactive grid-based graphical trading system for use by any person or user who engages in trading securities through established security trading markets, in essentially real time, where the system comprises a grid-based graphical interface, said graphical interface being adapted to establish a connection with any backend system used by any market participant through suitable communication channels;
wherein said interactive grid-based graphical trading system is available through a computer or device;
wherein said interactive grid-based graphical trading system is adapted to receive and display data received from a plurality of market participants, data providers, trading algos, third-party plugins, in essentially real time; and wherein a user may select any particular security for which data are electively required, at any instant in time;
wherein said interactive grid-based graphical trading system includes first process means that function to send transaction instructions through said communication channels to the backend system used by any market participant, and to receive messages from said backend system through said communication channels; and wherein said grid-based graphical interface includes second process means that function to receive, process, and display said data, and said messages;
wherein said data includes market trading data consisting of: order data as to buy, sell, or other trading orders existing at that instant in time for any selected security or group of securities, quote data as to bid and ask prices, volume, market participant identifiers, and other parameters, existing at that instant in time for any selected security or group of securities; wherein said data include other data that can be associated to a price: Moving average, OHLC, other technical indicators, historical data, third-party plug-in values, and other data mappable to the grid; wherein said market trading data is transmitted to said grid-based graphical interface of the user from said backend system of a market participant in computer-readable electronic format;
wherein said interactive grid-based graphical trading system includes third process means that function to transform said market trading data received from a back-end system, at any instant in time, into a graphical representation for display on a device; wherein said graphical representation includes at least one grid having a plurality of cells arranged in an array of at least one row or at least one column;
wherein a row is an arrangement of horizontally adjacent cells with at least one common property, and a column is an arrangement of vertically adjacent cells with at least one common property, and wherein each cell within the said plurality of cells belongs to one row and one column wherein said plurality of cells is arranged in a matrix either in a plurality of rows and at least one column, or in a plurality of columns and at least one row, and wherein said plurality of rows or said plurality of columns are associated with an axis representing price;
wherein said cell is associated with said market trading data, and contains a graphical representation of said market trading data, and is associated with a specific price or range of prices; wherein each cell along said price axis indicates a price or price range, and the said at least one column or at least one row indicates an attribute which said market trading data is categorized as to price or a range of prices;
wherein a user can place, or modify, an order for a selected security or group of securities, over which that user has discretion, by interacting with said grid-based graphical interface; wherein said interaction can be accomplished by a drag and drop operation; and wherein said order or said quote is represented graphically in a cell;
wherein said interaction includes a method that allows the user's intent to place a buy order or sell order to be determined by identifying whether the user interacted with buy side cell or sell side cell, and what button or input was used to interact with said cell;
wherein said buy side and sell side cells are determined by using offsets from a reference value;
wherein said reference value defines a division between the buy cells and sell cells;
wherein a method is provided to resolve buy or sell conflicts that may arise when offsets are used by showing the user choices, actions, or modifications.

2. The interactive grid-based graphical trading system of claim 1, wherein a method is provided where other users may electively share their trading activity to other users partially or in full; wherein said trading activity that may be share in partial or in full may include orders, order quantity, long or short position, position quantity; wherein said shared trading activity may be displayed on other user's interactive grid-based graphical trading system if other users electively chose to do so;

3. The interactive grid-based graphical trading system of claim 1, wherein a method is provided where said user may electively display trades, positions, orders, and other trading activity, or any combination thereof, of other users in their own interactive grid-based graphical trading system; wherein the trading activity of other users displayed on the user's own interactive grid-based graphical trading system may be differentiated from other users by using avatars, colors, icons, and other graphical methods that can be displayed on a cell.

4. The method of claim 3, wherein a method is provided so the user can choose to replicate the trading activity of a user displayed on the grid; wherein said replication may replication of shared actions consisting of orders, position, stops, cancellation of orders, change of other order properties; wherein said replication may be replicated in full or partially; wherein said replication may be constrained to only a limited number of buys, sells, or pair/s of buys and sells; wherein replicated orders, positions, and other trading replicated trading activity that the user own, may be changed by the user anytime they choose to do so.

5. The interactive grid-based graphical trading system of claim 1, wherein a method is provided where the security, index, technical indicator, or a measure displayed on the grid can be used to trade a different security; wherein an order can be placed interacting with the cells on the grid; wherein a buy or sell order generated from said method can be determined by analysing whether the interaction occurred above or below a reference point; wherein other parameters of said generated order may be provided on a prompt, dialog box, or form; wherein some parameters of said generated order may be pre-selected to aid in trading a different security seamlessly by possibly avoiding additional prompts, dialog boxes or forms; wherein said parameters of said generated orders include the symbol and quantity.
